(19) United States
(12) Patent Application Publication
(10) Pub. No.: US 2008/0015879 A1
(43) Pub. Date: Jan. 17, 2008

(54) Automated Techniques for Fund Raising Via Real Estate Referral Fees

(75) Inventors: Mark Sennott, Sherborn, MA (US); Stephen Kane, Irvine, CA (US); Cathy Jager, Pasadena, CA (US)

Correspondence Address: PROSKAUER ROSE LLP, ONE INTERNATIONAL PLACE, BOSTON, MA, 02110, US

(73) Assignee: HomeGift Realty, Sherborn, MA (US)

(21) Appl. No.: 11/690,394

(22) Filed: Mar. 23, 2007

Related U.S. Application Data
(60) Provisional application No. 60/785,241, filed on Mar. 23, 2006.

(51) Int. Cl. G06Q 99/00

(52) U.S. Cl. 705/1

(57) ABSTRACT

A method, system, or computer program product for non-profit organization fund raising via real estate referral fees. Information associated with a participant interested in participating in a real estate transaction in which finds can be provided to a non-profit organization (NPO) is received. An agreement is generated to be signed by an agent associated with the transaction. An electronic document of the agreement signed by the agent is received. The transaction with which the signed agreement is associated is automatically determined and the received electronic document is stored and associated with the participant.

### CROSS-REFERENCE TO RELATED APPLICATIONS

This application claims priority to and the benefit of, and incorporates herein by reference in its entirety, U.S. Provisional Patent Application No. 60/785,241, filed on Mar. 23, 2006, entitled “Non-profit Organization Fund Raising.” This application relates to and is assigned to the same entity as a co-pending application identified by Attorney Docket No. HGT-001A, U.S. patent application Ser. No. 11/690,386, filed on Mar. 23, 2007, entitled “Fund Raising Via Real Estate Referral Fees.”

### TECHNICAL FIELD

The present invention relates generally to automated techniques for non-profit organization (NPO) fund raising via real estate referral fees.

### BACKGROUND

When buying or selling property, consumers typically pay a real estate commission. The real estate commission represents a portion of the sale price of the property that is paid by a home buyer or seller to a state-licensed real estate broker who assisted that home buyer or seller in the purchase or sale of property. Where one real estate broker refers another real estate broker to a home buyer or seller, the referring broker is paid a real estate referral fee by the referred real estate broker upon completion of the purchase or sale of property. Referral fees are a common practice in the real estate community. The referral fee represents a portion of the commission on a real estate deal that is paid to the real estate broker who referred the buyer or seller to another real estate broker.

A system and method that enables payment of at least a portion of a broker referral fee to a charity chosen by a real estate buyer or seller is known, for example, from U.S. Patent Appl. No. 2002/0072930. Other art teaches charitable giving or the allocation of funds to charitable organizations without the use of real estate referral fees as the source of these charitable funds, e.g., U.S. Pat. No. 6,581,041. While other art teaches the calculation and payment of real estate referral fees without any form of charitable giving, e.g., U.S. Pat. No. 6,314,404, and U.S. Pat. No. 6,457,005.

Internet websites such as www.donationsforreferrals.com teach contribution of half of a referral fee to the charity of a consumer's choice; without any form of rebate to that consumer. www.donationchannel.org provides a means for real estate agents to make a charitable pledge without any form of rebate to a consumer. Other Internet websites such as www.lendingtree.com enable rebates to consumers, but do not provide any means for charitable giving.

### SUMMARY

The HomeGift (HG) technology enables financial support for NPOs in forms such as: charitable giving from rebates from real estate referral fees and HomeGift royalties to NPOs. The HomeGift technology allows a person who is buying or selling a home or property to direct a portion of the rebate that HomeGift pays the buyer or seller from HomeGift's referral fees to a non-profit organization. HomeGift refers a home buyer or seller who has requested HomeGift's services (“participant”) to a real estate broker. HomeGift, as the referring real estate broker, receives a referral fee from the referred real estate broker. In states where it is permissible, the home buyer or seller receives a portion of the referral fee in the form of a rebate from the completed real estate transaction. HomeGift also has agreements with NPOs in which HomeGift pays the NPO a royalty from HomeGift's income for the use of the NPO's name and logo on a HomeGift website that is custom-designed for the NPO supporters (“NPO website”).

The HomeGift technology enables alternative business models for supporting NPOs from referral fees. These philanthropic business models include a royalty model, a royalty-only model, a donation model, and a sharing (royalty plus donation) model. With the royalty model, HomeGift pays a non-profit organization a royalty on the income HomeGift derives from the use of the NPO's name and logos. The income consists primarily of the referral fees HomeGift earns from the referral of participants who request services through an NPO website. The technology enables HomeGift to deduct the royalty and an administration fee retained by HomeGift (the “Administration Fee”) from the total referral fee and, in states where permitted, to return the balance of the referral fee to the participant as a rebate. With the donation model, a participant receives a rebate of the referral fee minus the Administration Fee in the form of a check, a gift certificate, etc., and may contribute an amount the participant chooses to a non-profit organization. Donation models can include: a model in which a participant signs up through an NPO website and may donate to that NPO, and a model in which a participant engages HomeGift's services through a HomeGift website that permits the participant to make a donation to any non-profit organization the participant chooses. The sharing model combines the royalty and the donation models. The participant requests services through an NPO website, HomeGift pays a royalty to the NPO from income including the resulting referral fees, and the consumer may make a donation to the NPO or to an NPO or NPOs named on the website from the rebate to which the participant is entitled. In some embodiments, the consumer can select more than one NPO to share the proceeds of the referral fee.

An advantage of the HomeGift technology is that the technology may be implemented in states that allow for consumer rebates, e.g., the royalty model, the donation model, and the sharing model, and in states that prohibit rebates to consumers, e.g., a royalty-only model. Another advantage of the HomeGift technology is that the technology encourages charitable giving among home buyers, home sellers, and real estate agents or brokers. Charitable donations to qualified organizations are eligible for tax deduction. Home buyers and sellers who receive a rebate benefit from a reduction in the real estate commission that is paid when their property is purchased and/or sold. Though real estate agents who participate in the HomeGift program will typically receive less than the full commission on a single real estate transaction, they benefit from the referral of serious, prescreened clients without incurring marketing expense. Real estate agents benefit from, for example, public relations programs that HomeGift executes in the local markets of cooperating agents. Real estate agents signed on with the HomeGift program have the advantages of access to a market of millions of potential home buyers and/or sellers that are part of HomeGift programs, and association with giving back to a worthy cause.

Further advantages of the HomeGift technology can include: substantial involvement of participating NPOs in generating awareness and use of HomeGift by NPO supporters and members; a network of high quality real estate agents; a web-based system that enables matching participants and supporters of participating NPOs with appropriate real estate agents; and customer support to ensure that participants and supporters have a high-quality consumer experience.

A further advantage of the HomeGift system is that the system discloses to potential home buyers, home sellers, NPOs, real estate agents, and/or brokers financial information associated with each real estate transaction. Such financial transparency is critical to promoting confidence among these market participants and among regulators.

The HomeGift referral process system (RPS) can be associated with the purchase and/or sale of residential and/or commercial property. The HomeGift technology can support buy-side transactions, where a buyer purchases property, sell-side transactions, where a seller sells property, and/or combination buy-sell real estate transactions, involving both the purchase and sale of property.

To participate, a home buyer or seller may register with HomeGift before contracting with a real estate agent or broker. The HomeGift technology supports online registration of consumers or registration via a call center. HomeGift screens and matches real estate agents with home buyers or sellers based on, for example, the needs of the home buyer or seller and the qualifications of the real estate agent. By signing on with HomeGift, real estate agents and brokers are able to accept real estate referrals from HomeGift and assist consumers with the purchase or sale of property.

In some embodiments, HomeGift may partner with a university and offer, where permissible, consumer rebates in the form of tuition assistance, which can include a contribution to a 529 educational program. In some embodiments, where HomeGift partners with a non-profit organization involved with the homeless and/or affordable housing, HomeGift may offer, where permissible, a consumer rebate related to housing, e.g., a gift card. The gift card and/or debit card rebate can be a flat amount, e.g., $1,500, or a percentage of the real estate referral fee. Where the rebate is a flat amount, the remainder can go to the NPO, after HomeGift receives a specified percentage. In some embodiments, HomeGift may partner with a for-profit corporation in the form of an employee benefit program that provides for donations to a selected charity, with or without additional contributions from the employer.

The HomeGift technology can include backend integrated databases and features such as third-party products to support accounting functionality and facsimile transmission and/or receipt. The backend of the HomeGift technology enables streamlined processing of real estate referrals through a number of automated features; thereby supporting aspects of a paperless environment. The HomeGift technology can include a number of databases and related functions, including, for example, non-profit organization and consumer information management, real estate agent and broker database management, real estate agent locator functions, transaction and workflow status reporting, document and property information storage, compliance documentation storage, call center integration, accounting, customer or home buyer or seller satisfaction surveys, administrative and non-profit organization reporting, and non-profit organization, participant, and real estate agent Web pages.

In one aspect, the present invention teaches a method for non-profit organization find raising via real estate referral fees. The method can include receiving a requested URL associated with a first hyperlink in a first Web page corresponding to a URL of a first entity. In response to the requested URL, transmitting a second Web page corresponding to a second entity different from the first entity and capable of receiving a referral fee from a real estate transaction. The second Web page can include information about providing funds to a non-profit organization in response to a real estate transaction. The second Web page can include, for example, a color scheme substantially identical to the first Web page, a logo associated with the first entity, a second hyperlink associated with the first Web page, a page format substantially identical to the first Web page, or any combination thereof.

In one aspect, the present invention teaches a system for non-profit organization fund raising via real estate referral fees. The system can include a server configured to receive a requested URL associated with a first hyperlink in a first Web page corresponding to a URL of a first entity. In response to the requested URL, transmitting a second Web page corresponding to a second entity different from the first entity and capable of receiving a referral fee from a real estate transaction. The second Web page can include information about providing finds to a non-profit organization in response to a real estate transaction. The second Web page can include, for example, a color scheme substantially identical to the first Web page, a logo associated with the first entity, a second hyperlink associated with the first Web page, a page format substantially identical to the first Web page, or any combination thereof.

In another aspect, the technology relates to a computer program product, tangibly embodied in an information carrier, for non-profit organization fund raising via real estate referral fees. The computer program product can include instructions being operable to cause a data processing apparatus to receive a requested URL associated with a first hyperlink in a first Web page corresponding to a URL of a first entity. The computer program product can include instructions being operable to cause a data processing apparatus to transmit a second Web page corresponding to a second entity different from the first entity. The second Web page can be transmitted in response to the requested URL, and the second entity is capable of receiving a referral fee from a real estate transaction. The second Web page can include information about providing finds to a non-profit organization in response to the real estate transaction and a color scheme substantially identical to the first Web page, a logo associated with the first entity, a second hyperlink associated with the first Web page, a page format substantially identical to the first Web page, and/or any combination thereof.

In some embodiments, the technology involves calculating an estimated amount of funds to be provided to a consumer, an NPO or both. The calculating is based on the home value and is accomplished by a rebate calculator associated with the second Web page. In some embodiments, calculating can involve calculating based on buying a home and selling a home. Calculating can involve deducting an amount for a fee provided to the second entity.

In some embodiments, the rebate calculator can receive an input associated with a state, and an identification message can be displayed when the input is associated with a state that prohibits real estate rebates to consumers. The technology can involve calculating without accessing a server. In some embodiments, the technology can involve providing funds to the NPO in response to the real estate transaction being completed. Providing funds can involve providing royalties to the NPO based on the second Web page including the color scheme substantially identical to the first Web page, the logo associated with the first entity, the second hyperlink associated with the first Web page, the page format substantially identical to the first Web page, and/or any combination thereof.

The technology can relate to providing funds including providing a portion of a rebate to a consumer to the NPO in response to the real estate transaction being completed. The technology can enable the consumer to determine the portion of the rebate that is provided to the NPO. Enabling can involve enabling the consumer to determine the portion of the rebate that is provided to the NPO such that the funds to the NPO qualify for a charitable deduction for tax purposes. The technology can relate to transmitting a form associated with the second Web page using a plurality of Web pages and enabling a consumer, prior to a final submission of the form, to enter data in the form, to revise the data, and to freely navigate between the plurality of Web pages.

In some embodiments, a plurality of error messages for use with incorrect data entry on the form are defined. A first format of a first error message associated with a first one of the plurality of Web pages can be substantially identical to a second format of a second error message associated with a second one of the plurality of Web pages. The technology can involve prohibiting the submission of a form associated with the second Web page multiple times by mistake. Prohibiting can involve prohibiting a subsequent submission of the form for a predefined period after an initial submission of the form. In some embodiments, the second hyperlink is identical to a hyperlink on the first Web page.

The technology can relate to displaying an amount for a fee provided to the second entity in response to the real estate transaction. The first entity can be a business partner of the second entity. The second entity can be associated with a licensed broker. In some embodiments, the first entity is associated with the NPO, a university, or a cause-related organization. The first entity can be a corporation, and the first Web page can be associated with employee charitable giving. In some embodiments, the first entity is a corporation associated with financing the real estate transaction, and the first Web page is associated with charitable giving in association with a consumer rebate. One implementation of the technology may provide all of the above features and advantages.

In another aspect, the technology relates to a system for non-profit organization fund raising via real estate referral fees. The system can include a computing device and a storage device. The computing device can be configured to receive information associated with a participant interested in participating in a real estate transaction in which funds can be provided to a non-profit organization, to generate an agreement to be signed by an agent associated with the transaction, to receive an electronic document of the agreement signed by the agent, and to automatically determine the transaction with which the signed agreement is associated. The storage device can be configured to store the received electronic document and to associate the stored electronic document with the participant.

In another aspect, the technology relates to a method for non-profit organization fund raising via real estate referral fees. The method can include receiving information associated with a participant interested in participating in a real estate transaction in which funds can be provided to a non-profit organization (NPO), generating an agreement to be signed by an agent associated with the transaction, receiving an electronic document of the agreement signed by the agent, automatically determining the transaction with which the signed agreement is associated, storing the received electronic document, and associating the stored electronic document with the participant.

In other examples, these aspects can include one or more of the following features. The computing device can include a server and/or the storage device can include a database. The electronic document can include a facsimile. The electronic document can include an email. The electronic document can include an electronic signature. The agreement can be associated with a bar code. In such examples, the bar code included in the received electronic document can be detected and the transaction with which the bar code is associated can be determined. A transaction identifier associated with the transaction can be defined and participant information and the received electronic document can be associated with the transaction identifier. An email to the associated participant can be generated in response to the received electronic document. This can be done automatically. The email can be associated with a transaction identifier. This can be done automatically.

An agent associated with the transaction can be identified. This can be done automatically. The participant can be interviewed to determine an agent to use for the transaction. The interviewing can include calling the participant and asking the participant a predefined question associated with determining the agent.

An alert can be transmitted to the participant in response to a predefined event. This can be done automatically. The alert can include an email, a text message, an instant message, a pre-recorded voice message, a computer generated voice message, and/or any combination thereof. A reminder to contact the participant prior to an expiration date of the agreement can be defined. This can be generated automatically. A status of the transaction can be indicated, for example, on a display. This can be done automatically. The status of the transaction can be updated in response to a predefined event. This can be done automatically. The electronic document can be a first electronic document, where a second electronic document is received that can include a date of a closing of the transaction and a final sales price. Based on the second electronic document, an amount of funds to provide to the participant, the NPO or both can be calculated. This can be done automatically. In response to the second electronic document, a notice to the participant, the agent, the NPO, or any combination thereof can be generated. The notice can include at least a portion of the information included in the second electronic document. This can be done automatically.

Other aspects and advantages of the technology will become apparent from the following detailed description, illustrating the principles of the technology by way of example only.

### BRIEF DESCRIPTION OF THE DRAWINGS

The advantages of the technology described above, together with further advantages, may be better understood by referring to the following detailed description taken in conjunction with the accompanying drawings. The details of one or more examples are set forth in the accompanying drawings and the description below. Further features, aspects, and advantages of the technology will become apparent from the description, the drawings, and the claims. The drawings are not necessarily to scale, emphasis, instead, generally being placed upon illustrating the principles of the technology. Illustrative drawings include:

FIG. 1 is a schematic depicting the HomeGift program;

FIGS. 2A-2T depict process flow diagrams associated with a real estate transaction in which property is purchased and a buyer donates to an NPO;

FIGS. 3A-3T depict process flow diagrams associated with a real estate transaction in which property is sold and a seller donates to an NPO;

FIG. 4 illustrates a representative home page associated with HomeGift's public Internet website;

FIG. 5 illustrates an exemplary dynamic private label Internet website;

FIG. 6 is a plan diagram of an exemplary system that embodies the technology;

FIG. 7 depicts a first Web page associated with a first entity and a hyperlink to a second set of Web pages associated with a second entity;

FIGS. 8A-8B depict a representative introductory Web page associated with a second entity;

FIG. 9 depicts a representative Web page associated with a second entity depicting frequently asked questions of home buyers and sellers;

FIG. 10 depicts a representative Web page for home buyers and sellers associated with a second entity where the home buyer intends to purchase property in a non-rebate state;

FIG. 11 depicts a representative Web page for home buyers and sellers associated with a second entity depicting the prohibition on consumer rebates on real estate commissions in non-rebate states;

FIGS. 12A-12B illustrate representative Web pages for home buyers and sellers associated with a second entity depicting Web forms associated with the purchase of property in a non-rebate state;

FIG. 13 illustrates a representative Web page for home buyers and sellers associated with a second entity depicting a Web form associated with estimating an NPO royalty in a non-rebate state;

FIG. 14 depicts a representative Web page for home buyers and sellers associated with a second entity depicting a summary of the home buyer's intended purchase;

FIG. 15 depicts a representative Web page for home buyers and sellers associated with a second entity depicting a recap of the home buyer's intended purchase;

FIG. 16 depicts a representative Web page for home buyers and sellers associated with a second entity where the consumer intends to purchase and sell property;

FIGS. 17A-17B illustrate representative Web pages for home buyers and sellers associated with a second entity depicting Web forms associated with the purchase and sale of property in a rebate state;

FIG. 18 illustrate a representative Web page for home buyers and sellers associated with a second entity depicting Web forms associated with estimating an NPO royalty and consumer rebate;

FIG. 19 depicts a representative Web page for home buyers and sellers associated with a second entity depicting a summary of the consumer's intended purchase and sale;

FIG. 20 depicts a representative Web page for home buyers and sellers associated with a second entity depicting a recap of the consumer's intended purchase and sale;

FIG. 21 depicts a representative Web page for home buyers and sellers associated with a second entity depicting HomeGift's tell-a-friend functionality;

FIG. 22 is a representative flow chart illustrating steps associated with electronic document generation and storage;

FIGS. 23A-23B depict representative introductory Web pages for real estate agents and brokers associated with a second entity;

FIGS. 24A-24F depict representative HomeGift sign-up Web pages for real estate agents and brokers associated with a second entity;

FIG. 25 illustrates an exemplary administrative worksheet for tracking NPO orders;

FIGS. 26A-26E illustrate an exemplary automatically-generated transaction report;

FIG. 27 illustrates an exemplary introductory Web page of the backend of the HomeGift referral process system;

FIG. 28 depicts an exemplary new & pre-referral work queue;

FIG. 29 illustrates HomeGift's real estate agent/agency search function;

FIG. 30 illustrates HomeGift's RPS Add Agent record Web page;

FIGS. 31A-31E illustrate exemplary Web pages depicting transaction, participant interview, real estate agent, financial, and participant data; and

FIG. 32 represents an exemplary customer satisfaction survey of the HomeGift system.

### DETAILED DESCRIPTION

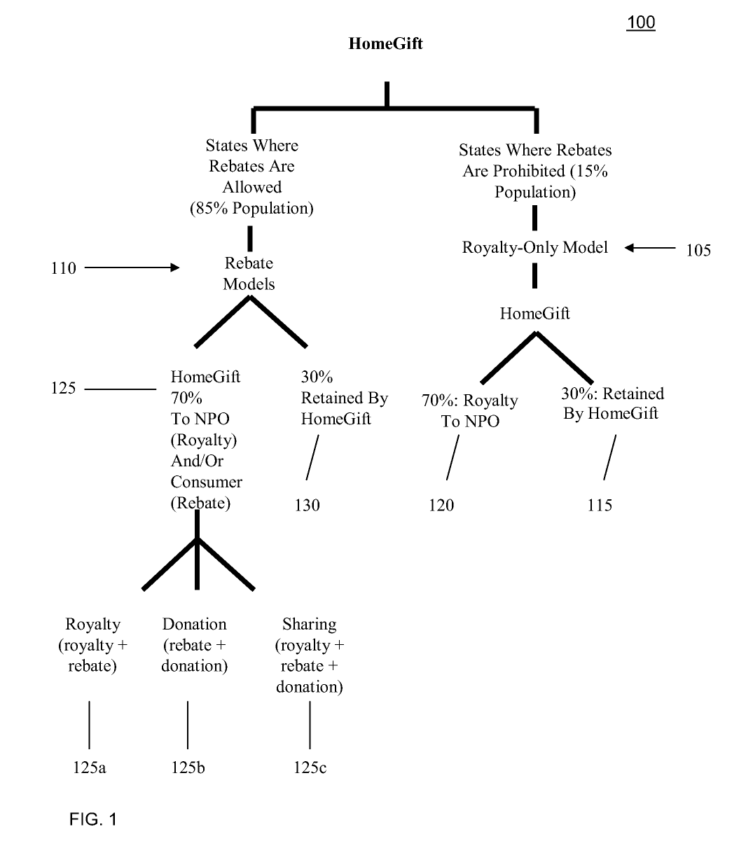

FIG. 1 is a schematic depicting the HomeGift program 100. HomeGift's services are available to non-profit organizations in all fifty U.S. states. To comply with applicable laws in each state, the HomeGift technology can provide for multiple philanthropic models. As illustrated in FIG. 1, HomeGift enables a “royalty-only model” 105 which can accommodate supporting non-profit organizations in states where rebates to consumers are prohibited (“non-rebate states”). HomeGift further enables at least three “rebate models” 110 in states that allow for consumer rebates.

Under the royalty-only model 105, consumers or supporters can participate in the HomeGift program and the NPO typically receives more because there is no rebate to the consumer. Under the royalty-only model 105, element 120 illustrates that the NPO can receive 70% of HomeGift's income from operations in non-rebate states. Element 115 illustrates that HomeGift can retain 30% under the royalty-only model 105.

HomeGift employs “rebate models” 110 depicted in FIG. 1. In the exemplary rebate models depicted in FIG. 1, HomeGift retains 30% of its referral fees 130 and pays 70% in royalties and rebates 125. An embodiment of the rebate model includes a “royalty model” 125a in which HomeGift can pay the NPO a set royalty and share the real estate referral fee with a consumer, in the form of a rebate. With the royalty model 125a, a fixed amount or percentage is shared, shown in element 125. Element 130 illustrates that HomeGift can retain 30% of the real estate referral fee before any rebate to the consumer occurs. Any of the percentages described throughout this specification, however, are exemplary only and not meant to represent a mandatory value. In the sharing model 125c, the consumer or supporter can determine the amount of the rebate he/she will donate to the NPO.

Consumers can include NPO donors, participants, supporters, customers, home buyers, and/or home sellers. NPOs can include charities and cause-related or professional, educational, health and other nonprofit organizations, such as colleges/universities, public television broadcasting entities, environmental groups, human rights organizations, homeless/shelter-related organizations, museums and artist organizations, and/or hospital and specific disease-related organizations, e.g., American Cancer Society.

Table 1 provides an example of the HomeGift royalty-only model, applicable in states that do not allow rebates to consumers. The value of a 70%-30% split is illustrated in Table 1 with figures based on estimated parameters. In Table 1, the chart shows the sale of a home or property whose value is $400,000, a real estate commission of 5%, a 50%-50% split of the real estate commission between the selling agent and the buyer's agent, and an exemplary referral fee of 30% of the listing agent's commission. In this example, HomeGift receives 30% of the referral fee or $900 as an administrative fee and the non-profit organization receives 70% of the income or $2,100. HomeGift typically pays for program and administration costs and the NPO typically pays for promotional and informational costs. Program and administration costs can include HomeGift's overhead, including facility and technology expenses, as well as salaries for professional and administrative staff. Promotional and informational costs can include the cost of flyers and inserts in publications, and television, radio and newspaper announcements.

Royalty-Only Model Example

TABLE 1

| | |
|---|---|
| Donor/seller home value | $400,000 |
| Total real estate commission (5% of $400K) | $20,000 |
| Seller “side” (50%) | $10,000 |
| Buyer “side” (50%) | $10,000 |
| Referral fee = 30% of list side | $3,000 |
| 30% HomeGift administration costs | $900 |
| 70% NPO royalty | $2,100 |

Table 2 illustrates an example of the HomeGift royalty model, applicable in states that allow for consumer rebates. In Table 2, the chart shows the sale of a home or property whose value is $400,000, a real estate commission of 5%, a 50%-50% split of the real estate commission between the selling agent and the buyer's agent, and an exemplary referral fee of 30% of the buyer's agent's commission. In this example, HomeGift retains 30% of the referral fee or $900 as an administrative fee and pays a royalty equal to 35% of the referral fee income to the non-profit organization and rebates 35% of the referral fee to the consumer. In this example, the royalty to the NPO and the rebate to the consumer are equal. The example shown in Table 2 illustrates that the consumer or NPO supporter and the NPO each receive $1,050. In general, the royalty model typically provides a lower dollar amount to the NPO on a per-transaction basis, which tends to increase participation rates and thus total yield to the NPO. HomeGift typically pays for program and administration costs. The NPO is typically responsible for announcements, Web linking, and informing its members of the HomeGift program.

Royalty Model Example

TABLE 2

| | |
|---|---|
| Donor/seller home value | $400,000 |
| Total real estate commission (5% of $400K) | $20,000 |
| Seller “side” (50%) | $10,000 |
| Buyer “side” (50%) | $10,000 |
| Referral fee = 30% of buyer side | $3,000 |
| HomeGift Administration costs (30%) | −$900 |
| Remaining 70% of referral fee | $2,100 |
| NPO supporter rebate (50%) | $1,050 |
| NPO royalty (50%) | $1,050 |

The HomeGift technology enables another rebate model, known as the donation model 125b depicted in FIG. 1. This model does not involve a royalty, and up to 70% of HomeGift's referral fee can be rebated to the consumer. The donation can allow the consumer to determine the amount of the rebate he/she will keep and thereby determine the portion of the rebate that he/she will be donate to the NPO. Under current IRS tax law, if a consumer is awarded a rebate and chooses to give some of the rebate back to a bona fide 501(c)3, then that free choice makes the chosen amount a charitable contribution. One of the advantages of the donation model is, therefore, that the donation model allows a consumer or supporter to take a tax deduction associated with a charitable contribution. In some embodiments of the donation model, users can select NPOs that are currently in a HomeGift database or the user can add or nominate a particular NPO for inclusion in a HomeGift database. Data associated with an NPO in a HomeGift database can be mapped to a document summarizing the transaction request from the user, for example, by exporting the data via an export service.

The HomeGift technology enables a rebate model known as the sharing model 125c depicted in FIG. 1, which combines the royalty with the donation model. With the sharing model, HomeGift pays a non-profit organization a set royalty on its income from a customized website, pays the participant a rebate, and enables the participant to donate some or all of his/her rebate to a non-profit organization. The participant's donation is tax deductible. In some embodiments, the sharing model can include a royalty that is a set percentage of HomeGift's income (e.g., a configurable percentage, a fixed percentage of the referral fee retained by HomeGift), and the remainder to the participant, e.g., participant or supporter. In some embodiments, the royalty may consist of a fixed dollar amount per number of completed transactions, and a fixed percentage of the referral fee is retained by HomeGift with the remainder of the referral fee rebated to the participant, e.g., in the form of a check.

In some embodiments, the NPO can be changed or modified after transaction processing has begun. For example, for a fixed amount of time after a participant signs up with HomeGift, the participant is allowed to select a different NPO as the recipient of a portion of the referral fee.

By offering alternative philanthropic models, e.g., royalty, royalty-only, donation, and sharing, the HomeGift technology offers its non-profit clients a full-service solution in all fifty U.S. states.

A number of user types may be involved with the buy-side, sell-side, or combination buy-sell transactions of the HomeGift technology. Such users can include, for example, Real Estate Administrators (RE Admins), HomeGift Account Representatives (HG ARs), NPO Administrators, participants, agents, and/or any combination thereof. A Real Estate Administrator can include a licensed real estate agent who is employed by HomeGift that is responsible for activities such as initial participant interviews and maintaining participant, property, and other transaction data. A HomeGift Account Representative can be a HomeGift employee that is responsible for managing HomeGift's relationships with NPOs and preparing various reports for NPOs. An NPO Administrator can be an employee of an NPO that has signed on with HomeGift. A participant can include a person who is buying or selling property. An agent can include a real estate agent or broker that has signed on with HomeGift to accept referrals and assist participants in buying and/or selling their property. A broker is a real estate agent who has taken an additional test, is authorized to operate a private real estate firm or agency, and is authorized to accept referrals for the agents he/she employs. Real estate agencies may be affiliated with a chain, e.g., Century 21®, RE/MAX®, Coldwell Banker®. In some embodiments, HomeGift is also a registered real estate broker, particularly when required by law in order to receive the referral fee.

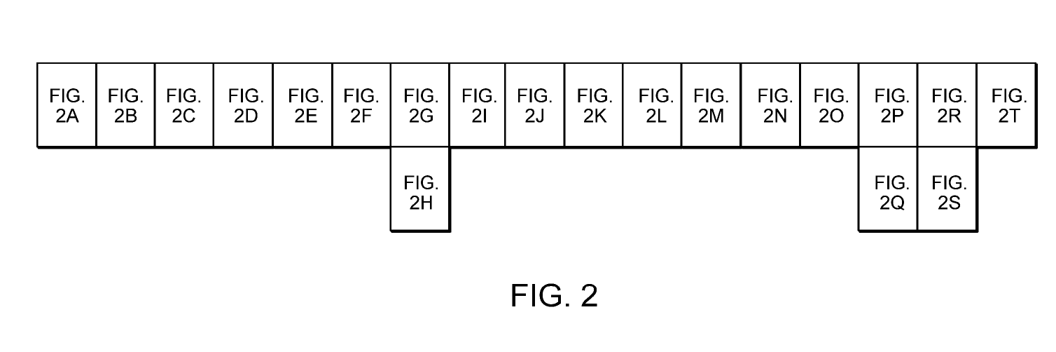

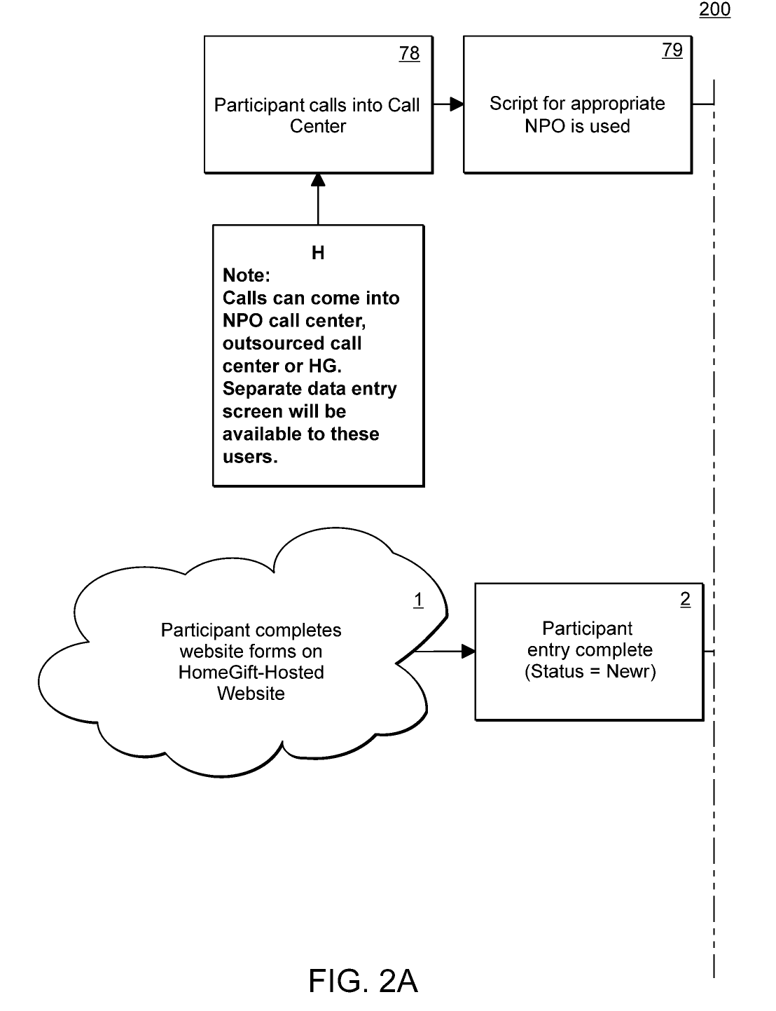

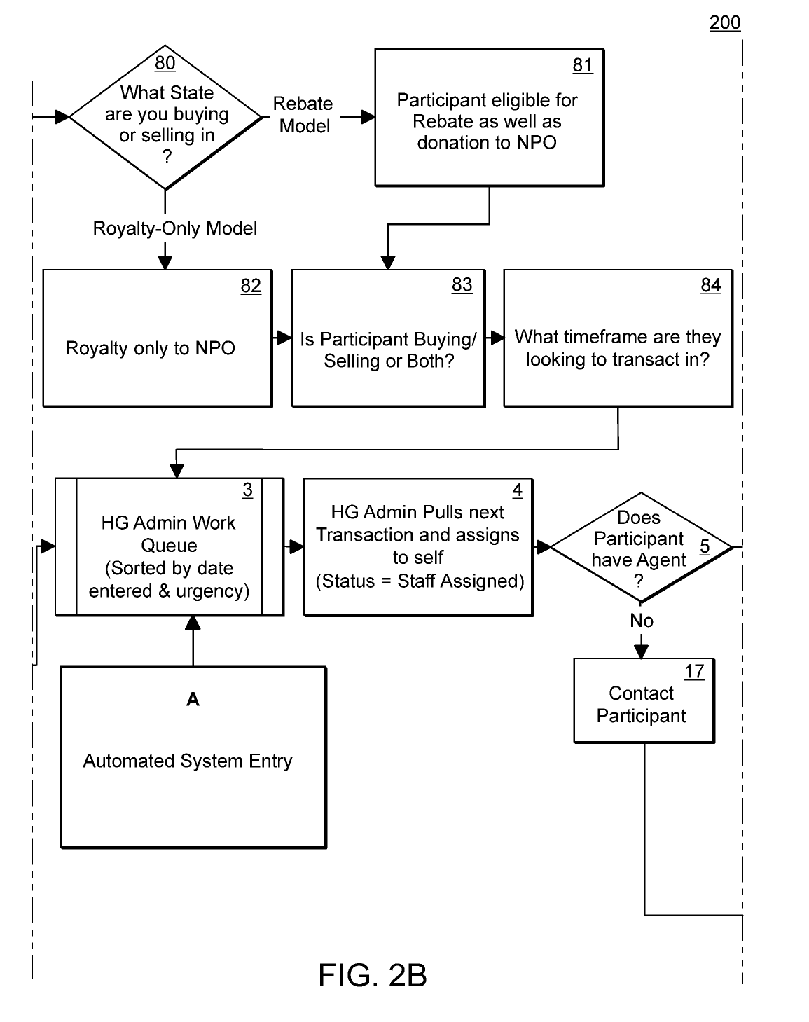

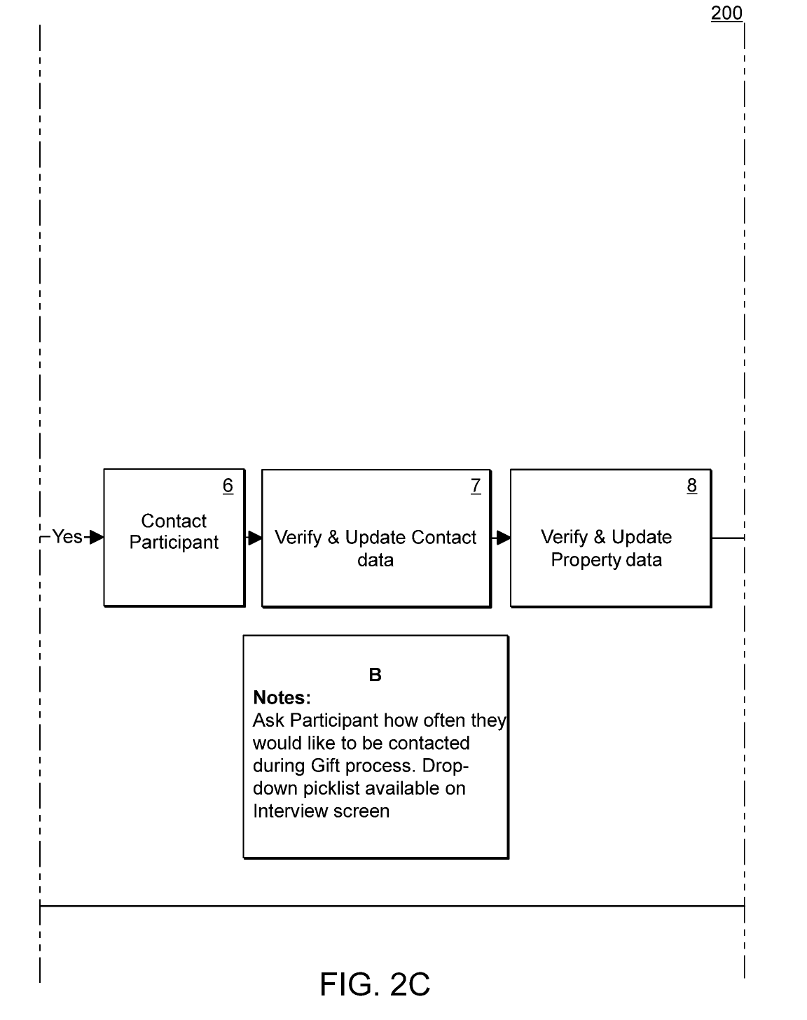

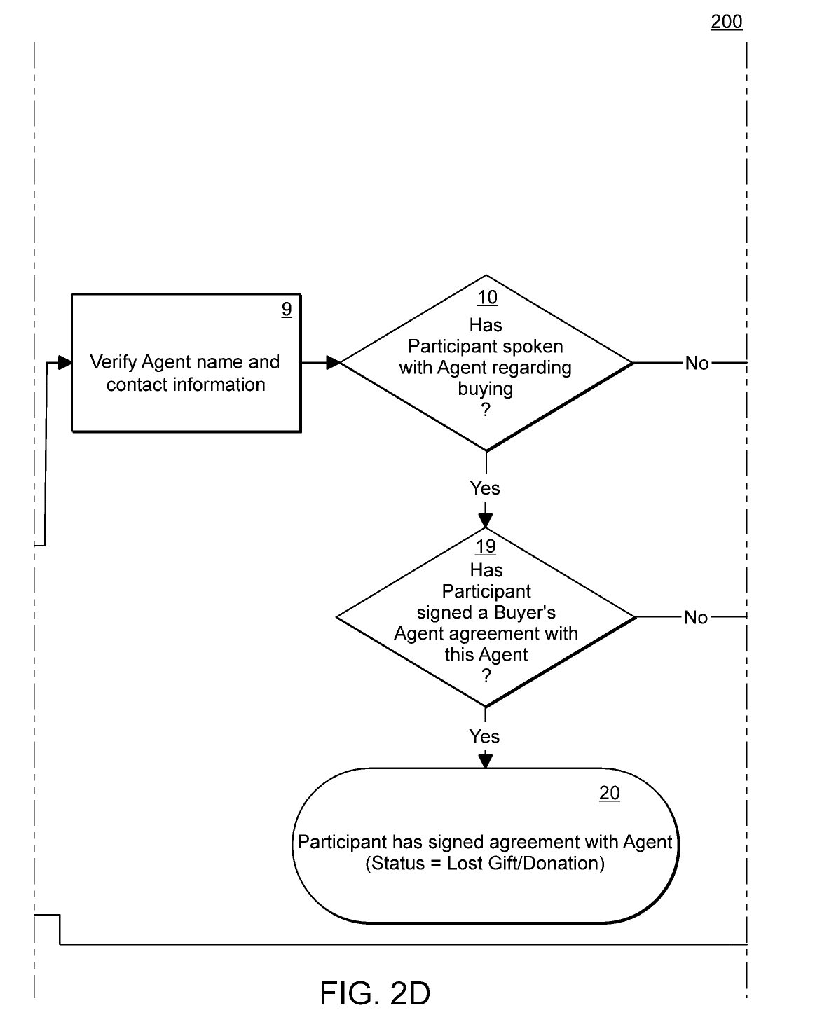

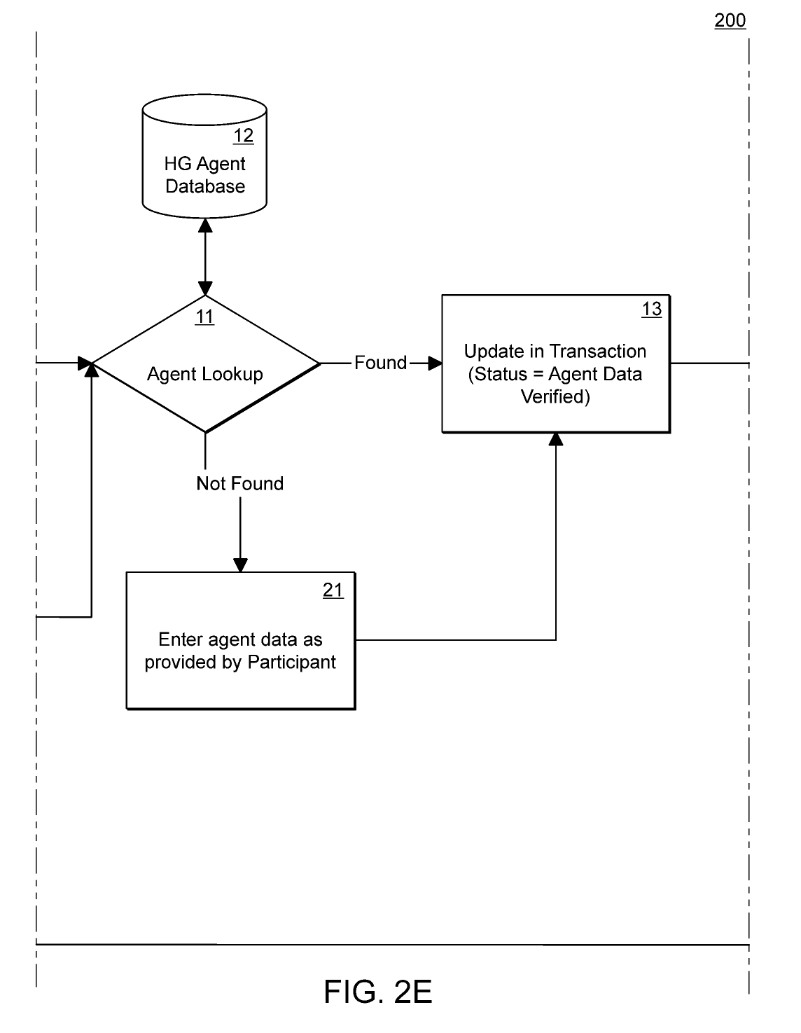

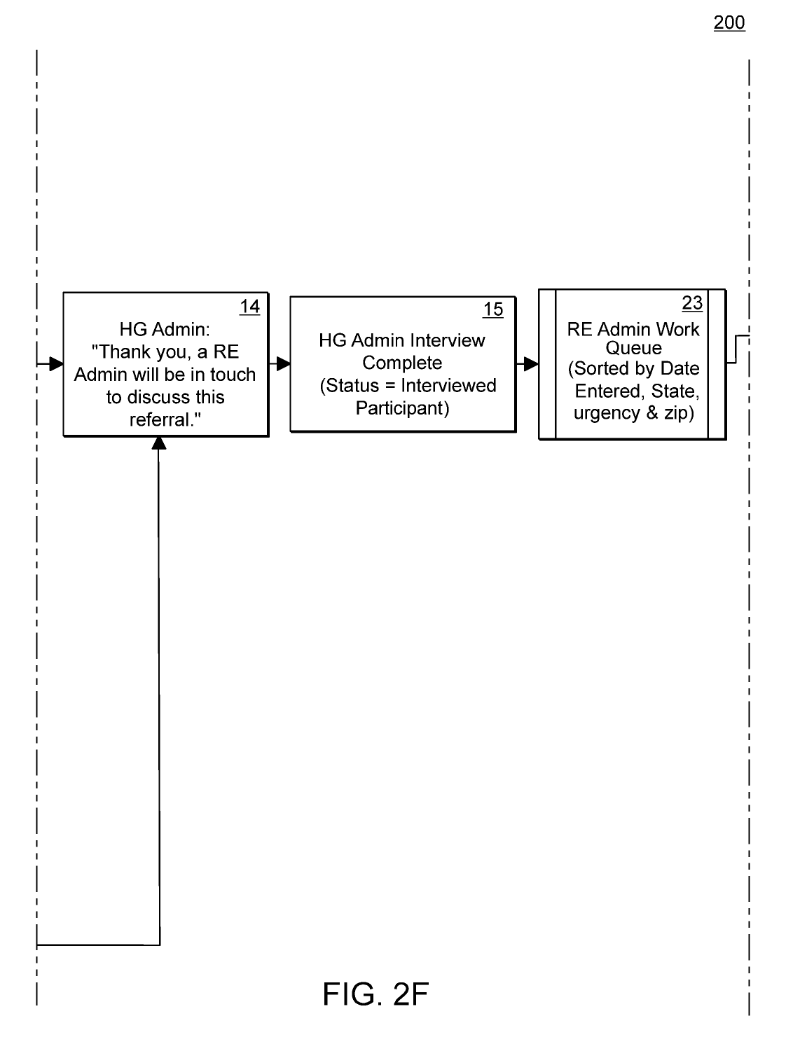

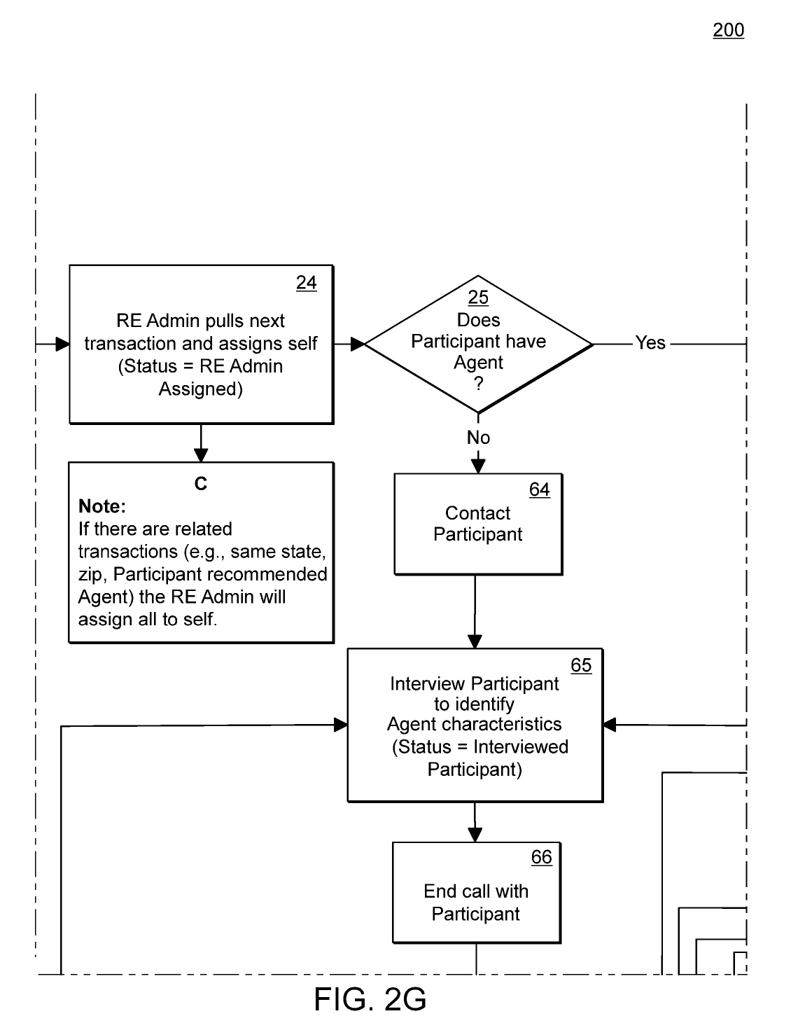

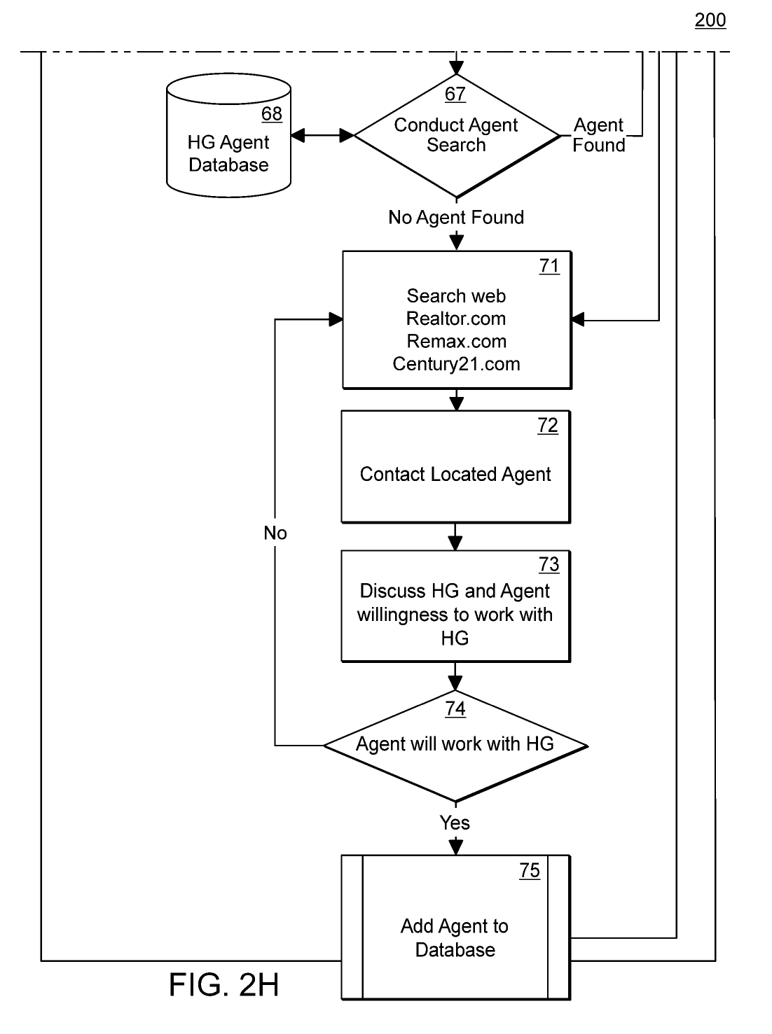

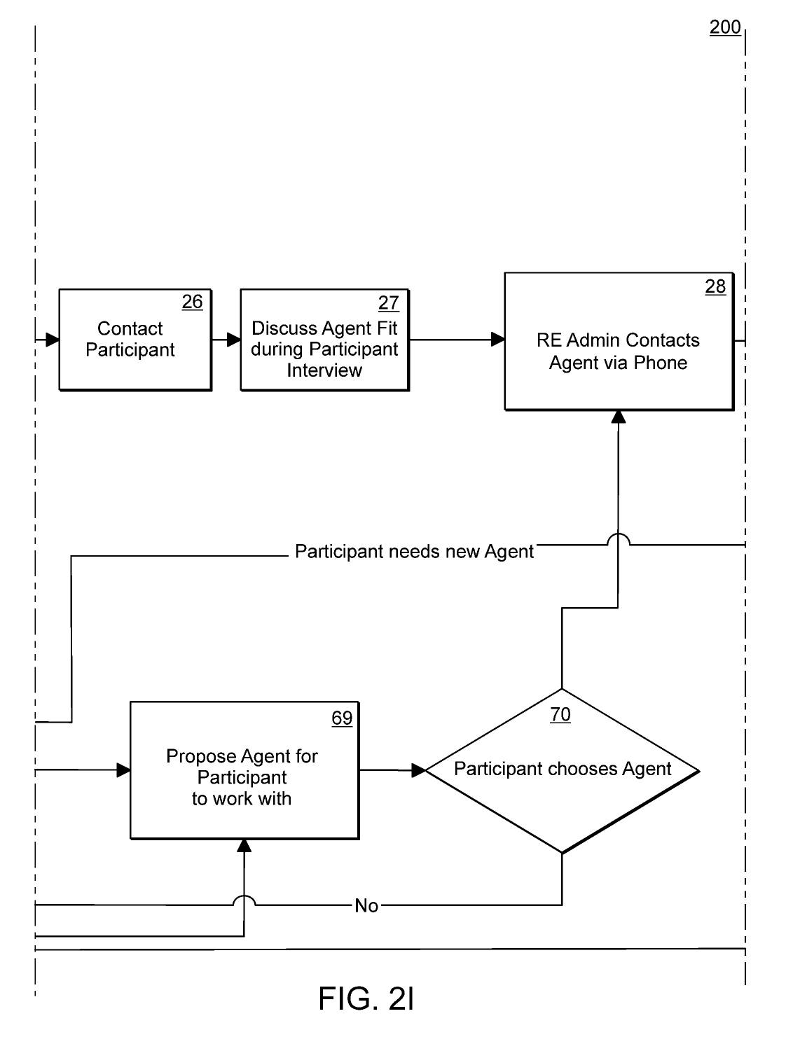

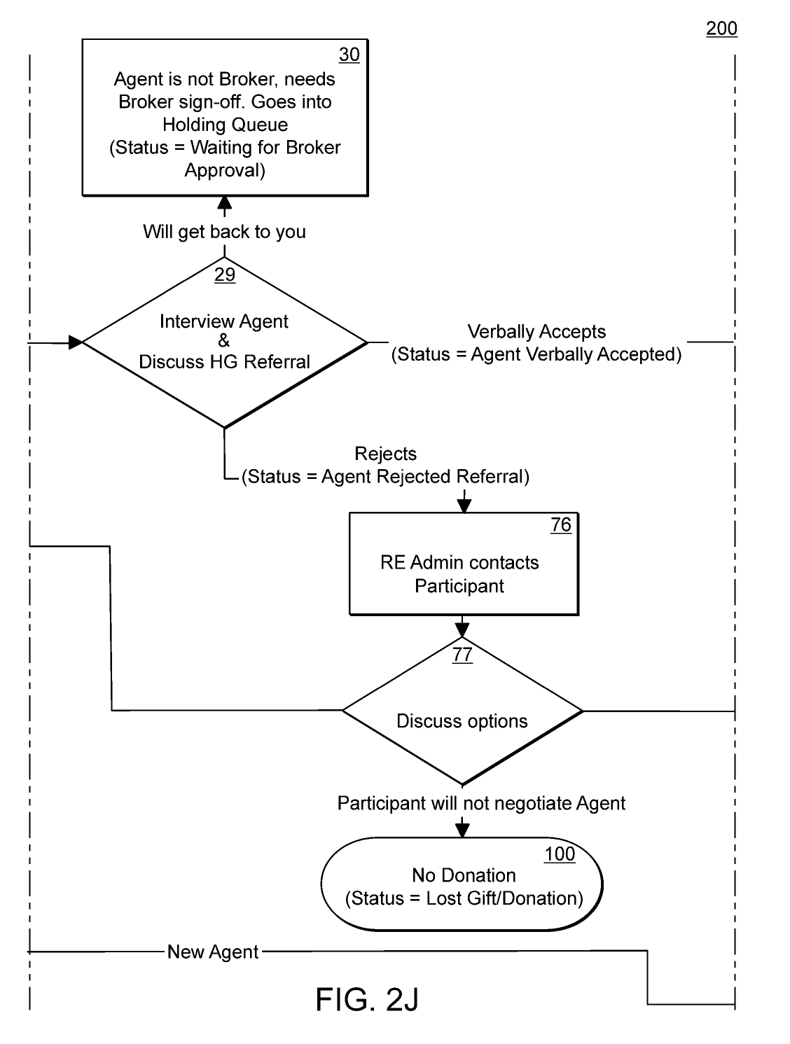

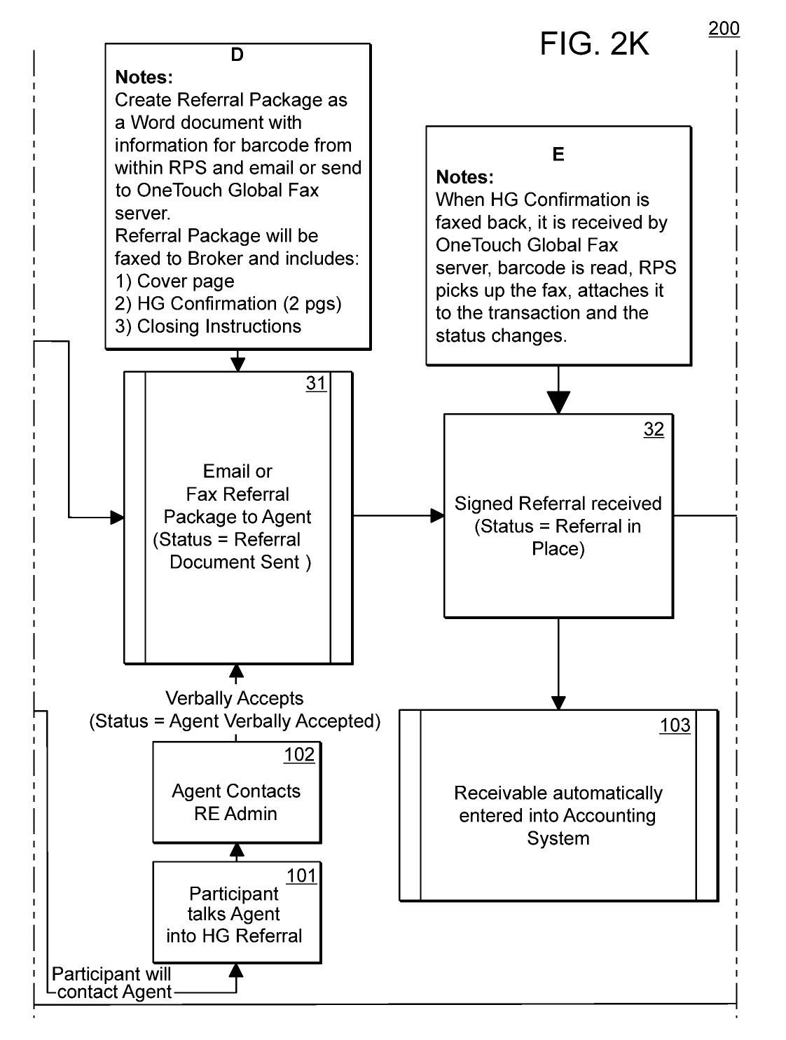

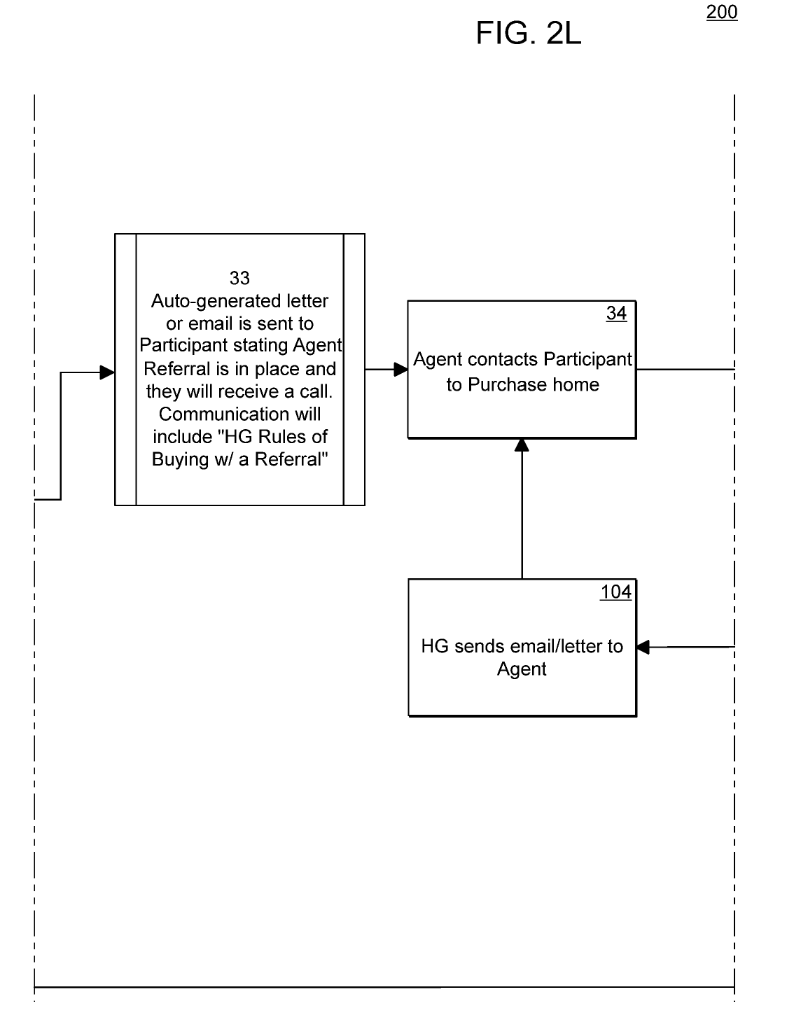

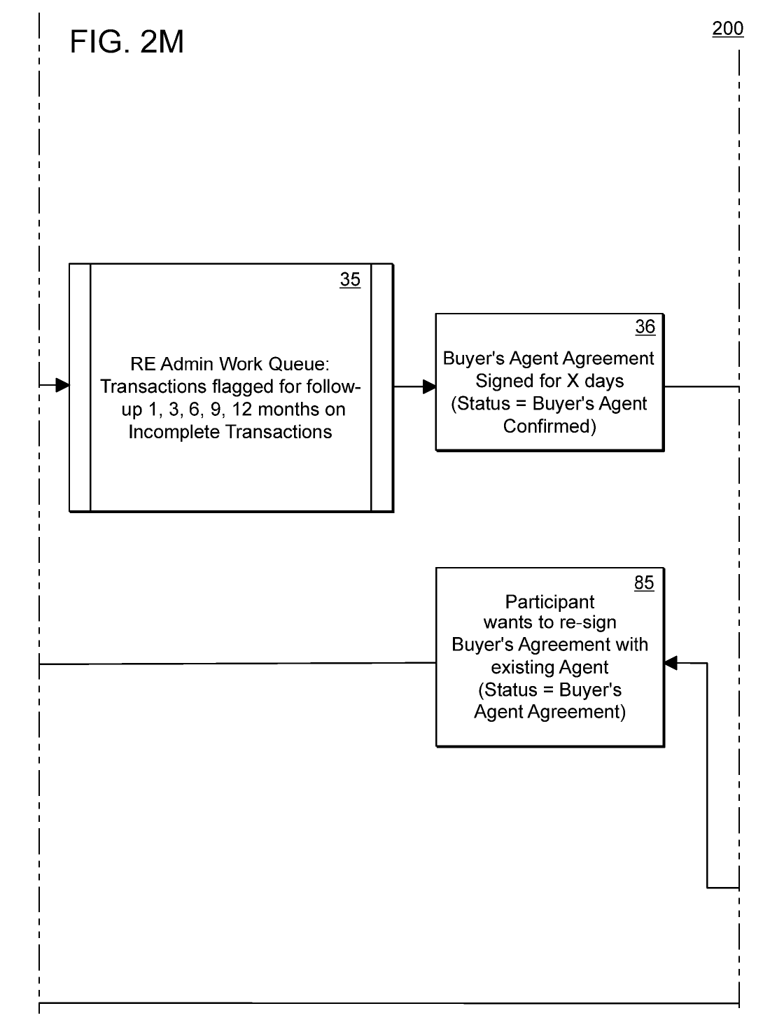

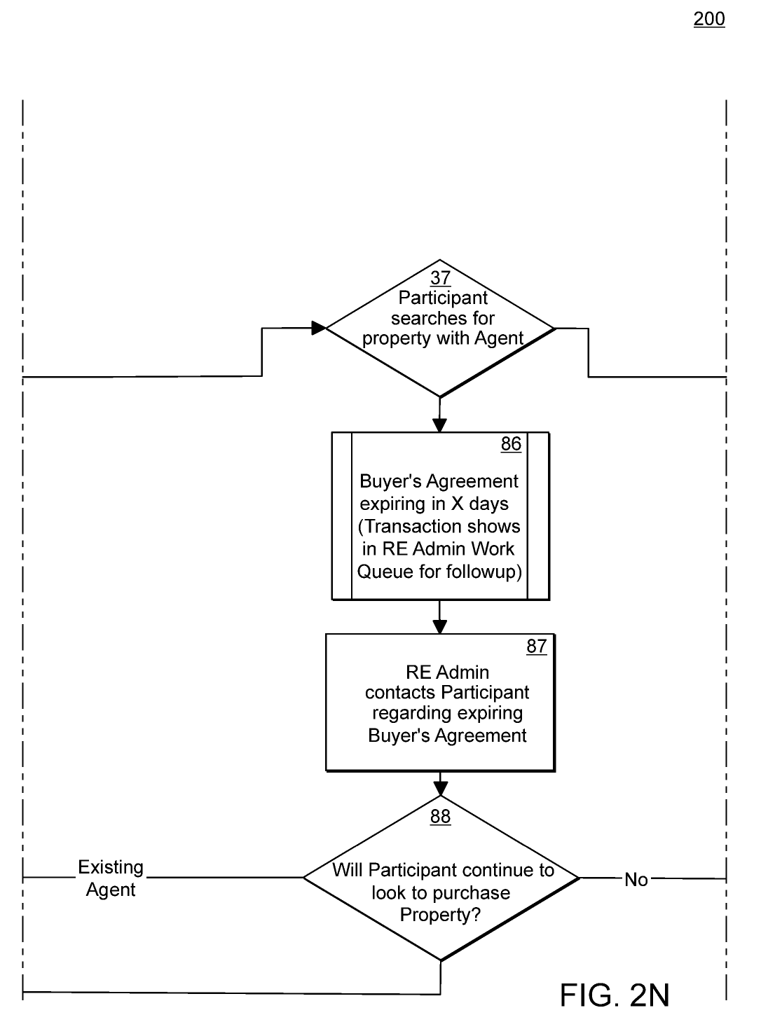

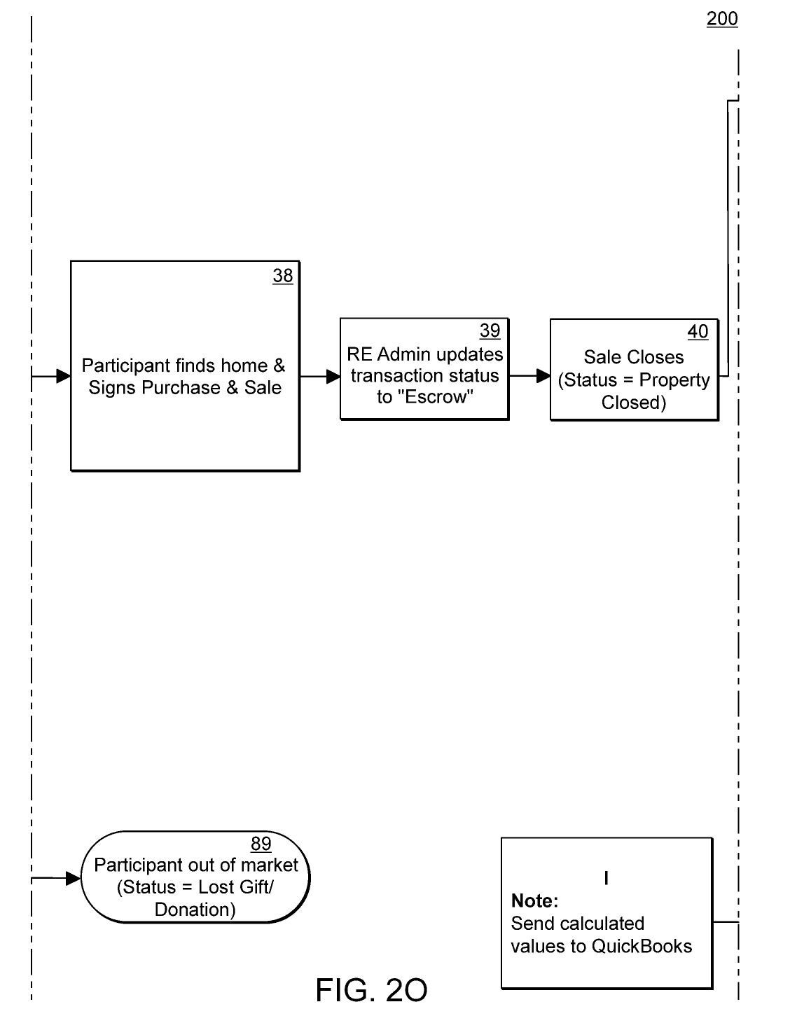

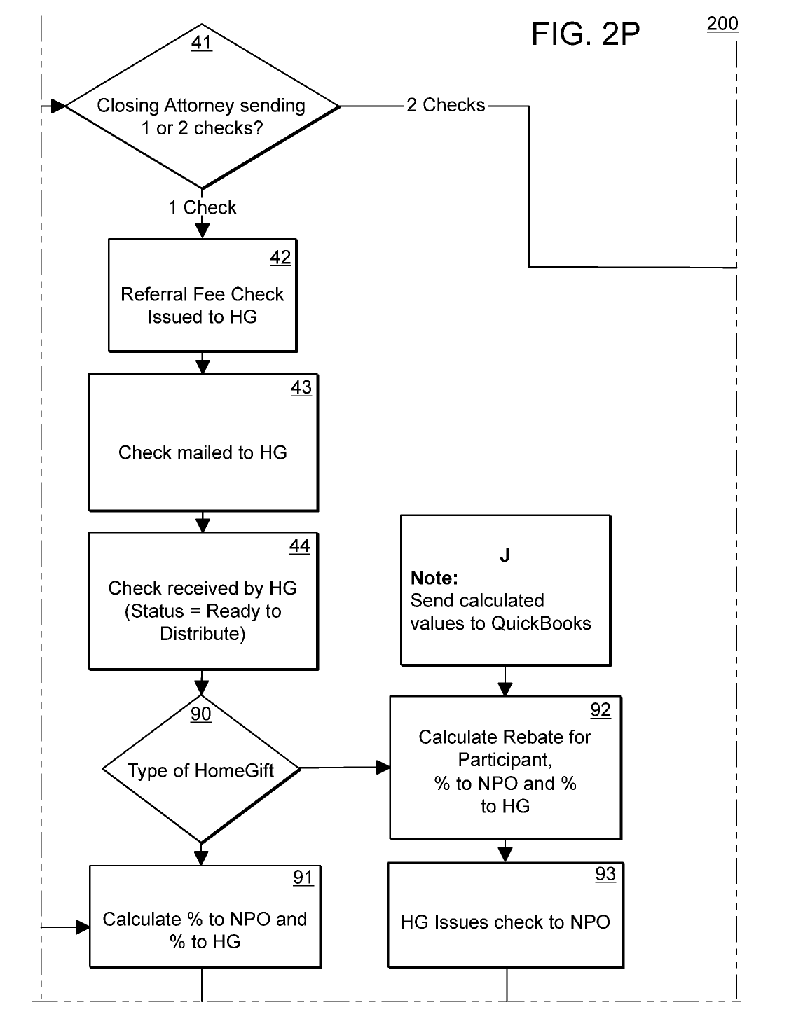

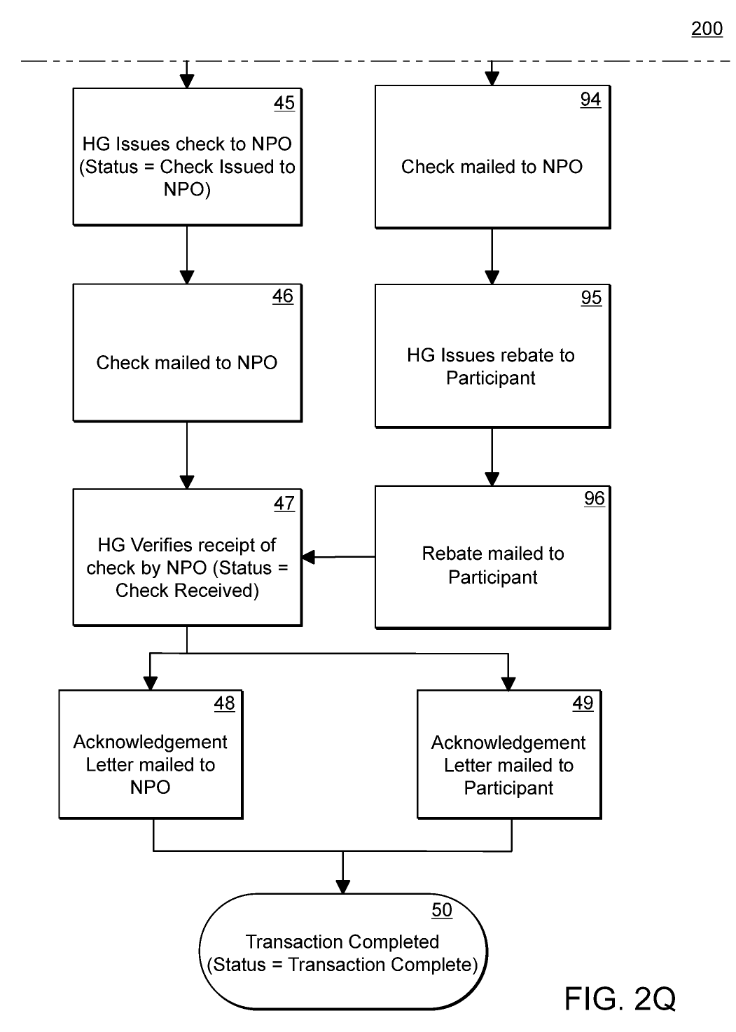

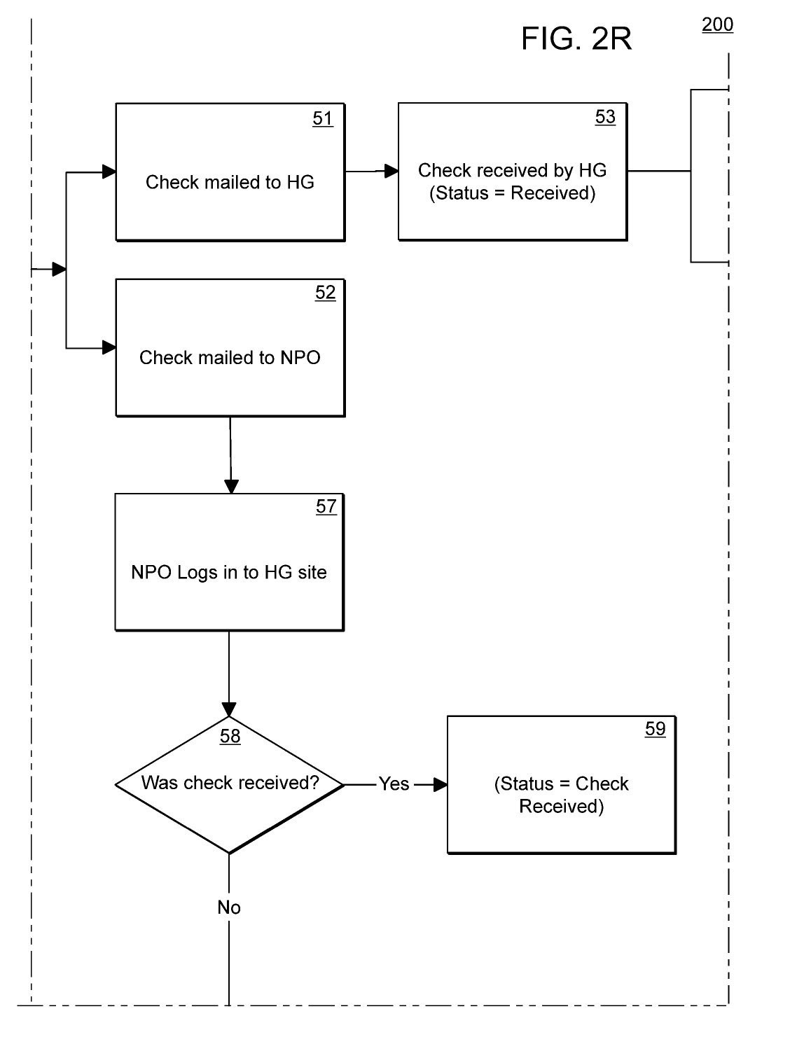

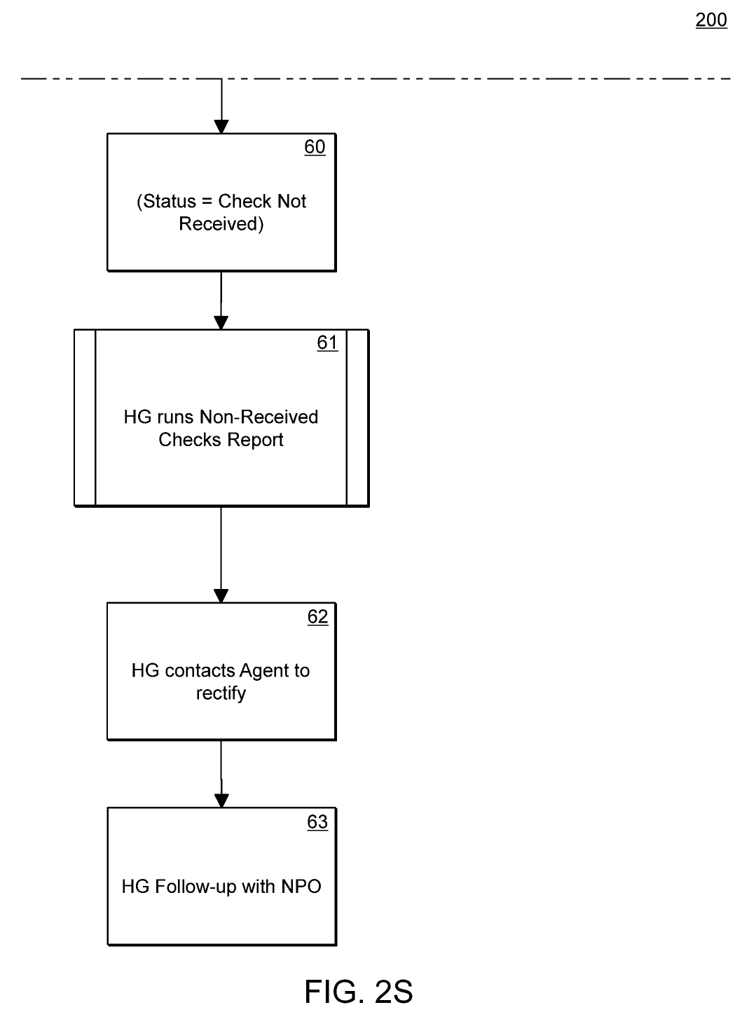

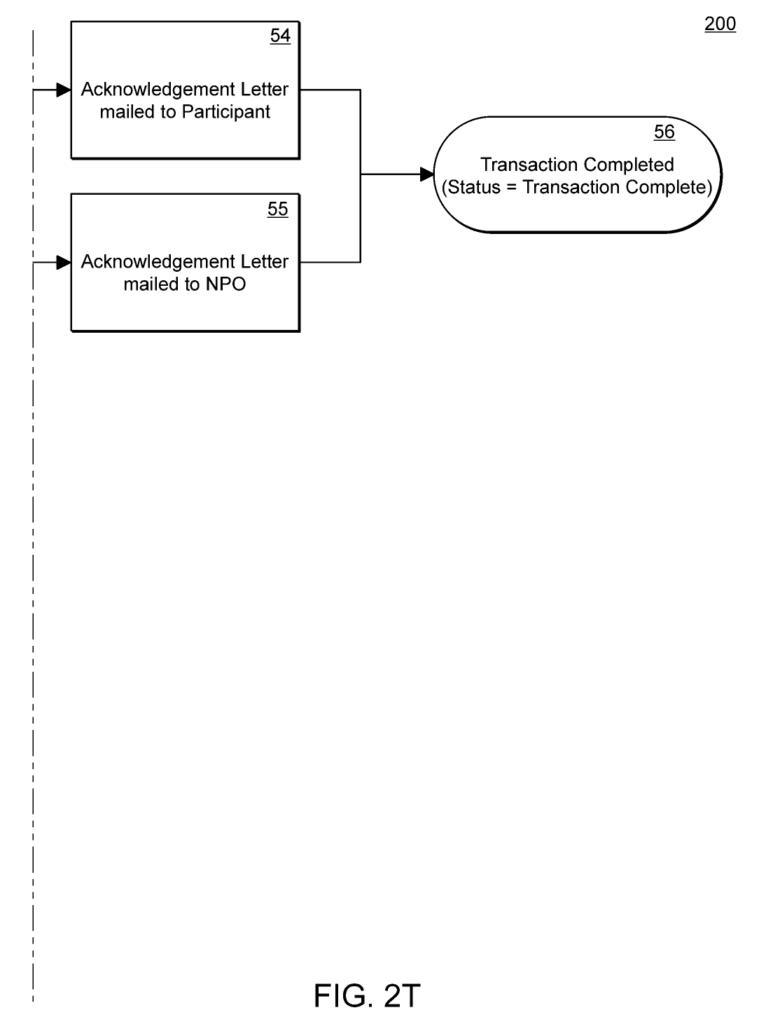

FIGS. 2A-2T depict process flow diagrams associated with a real estate transaction in which property is purchased and a buyer donates to an NPO. For such exemplary buy-side transactions, the techniques described herein can apply to each of at least two different real estate scenarios. Such scenarios can include, for example, when a home buyer is looking for a real estate agent to help him/her find a home, does not know one, and would find one by getting a referral through some source; and when a home buyer knows an agent who can help him/her find a house, but still wishes to support or donate to an NPO. The system 200 depicts an exemplary workflow associated with a buy-side transaction depicted in FIGS. 2A-2T. Such a transaction can, for example, begin with a participant calling into a call center to register with HomeGift and initiate their referral (78) as shown in FIG. 2A. Calls can come into a variety of call centers, including, for example, an NPO call center, an outsourced call center, a HomeGift call center, and/or any combination thereof. In some embodiments, call center functionality software supports inbound call center processing of supporter data called in over toll-free numbers.

When a participant calls into the call center, he/she will need to be identified as to which NPO or other HomeGift program he/she is calling about. Identification can, for example, be accomplished by using different telephone numbers and/or a phone system that can support notifying the call center representative of the caller's NPO prior to answering the call. When the call is answered, the appropriate NPO call center script can be made available on a screen (79) as shown in FIG. 2A. The call center representative asks questions of the participant, e.g., state selling/buying in, buying/selling timeframe of transaction, etc. Depending upon the state in which the home buyer is purchasing or selling (80), the HomeGift technology employs either the royalty-only model or the rebate model, e.g., the royalty model, the donation model, or the sharing model, as shown in FIG. 2B. Under one of the rebate models, a participant is eligible for a rebate and a donation can be made to an NPO (81) as shown in FIG. 2B. Under the royalty-only model, no rebate can be paid and no donation can be made to an NPO. The NPO can receive a royalty (82) as shown in FIG. 2B. A determination is made as to whether the transaction involves either the purchase or sale of property only or a combination buy-sell transaction (83) as shown in FIG. 2B. A determination is also made as to the timeframe within which the home buyer wishes to transact (84) as shown in FIG. 2B. The HomeGift Real Estate Admin determines whether the participant has a real estate agent (5) as shown in FIG. 2B.

Other embodiments of the HomeGift technology support online registration of consumers, In such embodiments, the buy-side transaction of system 200 can begin with a participant completing a website form on a HomeGift-hosted website (1) as shown in FIG. 2A. When the participant has completed entry of data on the website form(s), the RPS automatically sends a confirmation email to the participant (14), a transaction status is set to “Newr” (2), and the transaction is numbered and entered into a HomeGift administrative work queue (3) as shown in FIGS. 2A, 2B, and 2F. Once a participant has completed website form(s), a HomeGift Real Estate Administrator can, for example, access a HomeGift administrative work queue (3), to determine which transaction(s) to work on next as shown in FIG. 2B. The transactions in this queue can, for example, be sorted by date entered, time entered, the timing of the purchase, e.g., urgency of the transaction, and/or any combination thereof. The HG Real Estate Administrator pulls the next transaction and assigns the next transaction to himself/herself or to another Real Estate Administrator or real estate professional, and the transaction status is set to “staff assigned” (4). The HG Real Estate Administrator determines whether the participant has a real estate agent (5) as shown in FIG. 2B.

If the participant does not have a real estate agent in mind, the Real Estate Admin contacts the participant to arrange for an interview (17), and the transaction status is set to “contacted participant.” During the initial interview with the participant, the HG Real Estate Admin verifies and updates participant contact data (7), property data (8), and/or real estate agent data (9) as shown in FIG. 2C and FIG. 2D. Participant contact data can include, for example, the participant's address, email address and telephone number, and the participant's preferred method of contact, e.g., telephone, email, or mail. Property data can include, for example, the type of property the buyer is looking to buy, e.g., multi-family home, single-family home, condominium, townhouse, land, and/or any combination thereof, the address of the property that the participant wishes to buy if the participant already has one in mind, including the country, state or province, city, and/or zip code where the property is located.

If the participant knows of an agent he/she would like to use, the HomeGift Real Estate Admin contacts the participant (6), verifies and updates participant contact data (7), property data (8), and/or real estate agent data (9) as shown in FIG. 2C and FIG. 2D.

If the participant does not have a real estate agent in mind or would like to interview other agents even if he/she has an agent in mind, the HG Real Estate Admin contacts the participant (64), and interviews the participant to determine the characteristics that the participant is looking for in an agent (65) as shown in FIG. 2G. During the interview, the HG Real Estate Admin asks the participant whether he/she has communicated with a real estate agent regarding the purchase of property (10) as shown in FIG. 2D. If the participant has spoken with an agent, the HG Real Estate Admin asks the participant whether he/she has signed a buyer's agent agreement with this agent (19) as shown in FIG. 2D. If the participant has signed a buyer's agent agreement (20), the transaction status is set to “lost gift/donation,” and HomeGift cannot seek a referral fee as shown in FIG. 2D. If the participant has not already signed a buyer's agent agreement with the agent or the participant has not spoken with or otherwise committed to an agent regarding the purchase of property, the HG Real Estate Admin conducts an agent lookup (11) by searching a HomeGift real estate agent database 12 as shown in FIG. 2E. If the participant's real estate agent is not found, then the HG Real Estate Admin enters agent data as provided by the participant (21) as shown in FIG. 2E. If the participant's real estate agent is found, then the HG Real Estate Agent verifies the agent data and the transaction status is updated to “agent data verified” (13) as shown in FIG. 2E. The HG Real Estate Admin discusses next steps in the process and thanks the participant (14), and the transaction status is set to “interviewed participant” (15) as shown in FIG. 2F.

Regardless of whether the participant has a real estate agent, the HG Real Estate Admin may, as part of the participant interview, inquire as to how often the participant would like to be contacted throughout the process. The Real Estate Admin may select the desired frequency of participant contact from, for example, a drop-down menu associated with the HomeGift technology.

With respect to sell-side registration, the process begins in a manner similar to that of the buy-side registration process. The HomeGift RE Admin accesses an RE Admin work queue, e.g., a new & pre referral work queue, to determine which transaction(s) to work on next (23) as shown in FIG. 2F. The transactions in this queue can be sorted by, for example, date entered, state, urgency/timing of sale, zip code, and/or any combination thereof. The RE Admin pulls the next transaction and assigns the next transaction to himself/herself (24) as shown in FIG. 2G or assigns the next transaction to another HomeGift Real Estate Admin or real estate professional. If there are related transactions, e.g., transactions in the same geographical location and/or transactions with the same participant-requested real estate agent, the RE Admin can group the transactions together and assign them to himself/herself or to another HomeGift Real Estate Admin or real estate professional prior to contacting the agent. The grouping of transactions, can, for example, cut down on repeat calls to one agent with different referrals. The RE Admin determines whether the participant has a real estate agent (25) as shown in FIG. 2G.

If the participant does not have a real estate agent, the RE Admin contacts the participant (64) to arrange and/or conduct an interview with the participant as shown in FIG. 2G. The RE Admin interviews the participant to identify characteristics or preferences that the participant desires in a real estate agent (65), and the transaction status is set to “interviewed participant” as shown in FIG. 2G. The RE Admin ends the call with the participant (66) as shown in FIG. 2G. The RE Admin conducts an agent search (67) of the HomeGift real estate agent database 68 as shown in FIG. 2H. If a suitable real estate agent is found from within the HomeGift agent database, the RE Admin proposes the real estate agent to the participant (69) as shown in FIG. 2I. The participant chooses an agent (70) as shown in FIG. 2I. If a suitable real estate agent is not found from within the HomeGift real estate agent database, then the RE Admin searches external websites (71), such as www.realtor.com, www.remax.com, and/or www.century21.com as shown in FIG. 2H. The RE Admin contacts a located real estate agent (72) as shown in FIG. 2H. The RE Admin discusses with the located real estate agent the HomeGift program (73) and inquires as to the agent's qualifications and willingness to work with HomeGift (74) as shown in FIG. 2H. If the located agent is not qualified or not willing to work with HomeGift, then the RE Admin resumes his/her search (71) as shown in FIG. 2H. If the agent is willing to work with HomeGift, then the RE Admin adds the real estate agent (75) to the HomeGift agent database 68 as shown in FIG. 2H. The RE Admin proposes the real estate agent to the participant (69) as shown in FIG. 2I. The participant chooses a real estate agent (70) as shown in FIG. 2I. Once the participant chooses the real estate agent, the RE Admin contacts the real estate agent on the telephone (28) as shown in FIG. 2I. The RE Admin interviews the real estate agent and discusses the HomeGift referral program with him/her (29) as shown in FIG. 2J.

If the participant knows of an agent he/she would like to use, the HomeGift Real Estate Admin contacts the participant (26) and interviews the participant to discuss agent fit (27) as shown in FIG. 2I. During the interview, the Real Estate Admin obtains and/or confirms the name and contact information of the agent, discusses agent fit with the participant, and answers any questions that the participant may have about the HomeGift program. The transaction status is set to “interviewed participant.” The RE Admin contacts the real estate agent on the telephone (28) as shown in FIG. 2I. The RE Admin interviews the real estate agent and discusses the HomeGift referral program with him/her (29) as shown in FIG. 2J.

RE Admin Interviews Real Estate Agent (29)

During the interview, the RE Admin inquires as to the real estate agent's willingness to work with HomeGift. If the real estate agent is a broker or has broker approval and verbally accepts the referral during the telephone interview, then a fax referral package is sent to the real estate agent, and the transaction status is set to “referral document sent” (31) as shown in FIG. 2K. The RE Admin can send a confirmation letter to the participant letting him/her know which real estate agent(s) have been referred to the transaction.

If the real estate agent is not a broker, then broker sign-off on the potential referral is required, the transaction goes into a holding queue, and the transaction status is set to “waiting for broker approval” (30) as shown in FIG. 2J. If the real estate agent is not willing to work with HomeGift, then the transaction status is set to “agent rejected referral” and the RE Admin contacts the participant (76) and discusses options with him/her (77) as shown in FIG. 2J. If the participant is not willing to negotiate with the real estate agent, then no donation is feasible and the transaction status is set to “lost gift/donation” (100) as shown in FIG. 2J. If the participant is amenable to negotiating with the agent, the participant contacts the agent to discuss with him/her the HomeGift referral program (101) as shown in FIG. 2K. If the potential participant-agent relationship is not feasible, the participant needs a new agent, and the RE Admin interviews the participant again (65) as shown in FIG. 2G.

If the participant is able to persuade the real estate agent into participating in the HomeGift referral program, the real estate agent contacts the RE Admin to verbally accept the referral and the transaction status is set to “agent verbally accepted” (102) as shown in FIG. 2K. A fax referral package is sent, e.g., mailed and/or emailed, to the real estate agent for signature, and the transaction status is set to “referral document sent” (31) as shown in FIG. 2K.

The referral package can be, for example, a Microsoft® Word document. The referral package can contain barcode information from the HomeGift referral process system. The referral package can be sent to the real estate agent via numerous means, including, for example, via One Touch Global Technologies, Inc.'s Fax Server solution. In one form, the referral package can include a cover page, HomeGift referral agreement confirmation pages, and closing instructions.

Once HomeGift receives the signed referral package, the transaction status is set to “referral in place” (32), a receivable is automatically entered into an accounting system (103), and a letter or electronic mail is automatically generated and sent to the participant (33) as shown in FIG. 2K and FIG. 2L. The letter or electronic mail states, for example, that the agent referral is in place and that the participant will receive a telephone call from the real estate agent. The letter or electronic mail can include, for example, HomeGift rules for buying property through a referral. Once the HomeGift confirmation is faxed back, the confirmation can be received, for example, by a OneTouch Global Fax server. Upon receipt, the HomeGift referral process system reads a barcode, picks up the facsimile, and associates the facsimile with the transaction. In some embodiments, association of the barcode with a transaction includes reading and/or picking up the barcode from a received electronic document, e.g., facsimile, translating the barcode to an appropriate identifier, e.g., a number, and accessing a HomeGift database to determine the transaction that is associated with the identifier read from the barcode. The status of the transaction is updated to kickoff a job to notify the participant via electronic mail or mail that the real estate agent will be contacting him/her to discuss possibly assisting the participant with the purchase of property. The real estate agent contacts the participant regarding the home purchase (34) as shown in FIG. 2L. Incomplete transactions can be flagged in the RE Admin work queue for one, three, six, nine and/or twelve month follow-up (35) as shown in FIG. 2M.

The buyer's agent agreement between the participant and the real estate agent is signed for a specific term, e.g., a specified number of days or months, and the transaction status is set to “buyer's agent confirmed” (36) as shown in FIG. 2M. The transaction moves into the post-referral work queue for further monitoring. A job can, for example, run nightly that will identify open items for the RE Admin. The participant searches for property with the real estate agent (37) as shown in FIG. 2N.

Participant does not Find Property to Purchase

If the participant has not found property to purchase and the buyer's agent agreement is set to expire, as reflected in the transaction status of the RE Admin work queue (86), the RE Admin contacts the participant regarding the expiring buyer's agent agreement (87) as shown in FIG. 2N. If the participant does not wish to continue looking for property to purchase, the participant is deemed to be out of the market (88) and the transaction status is set to “lost gift/donation” (89) as shown in FIG. 2N and FIG. 2O. If the participant wishes to continue looking for property to purchase, but does not want to continue with the same real estate agent, then the RE Admin repeats the process of interviewing the participant to identify characteristics or preferences that the participant desires in a real estate agent (65) as shown in FIG. 2G.

If the participant wishes to continue looking for property to purchase and wants to continue with the same real estate agent, then the participant re-signs the buyer's agent agreement with the existing agent, and the transaction status is set to “buyer's agent agreement” (85) as shown in FIG. 2M. HomeGift sends a letter or electronic mail to the real estate agent informing him/her that the participant has re-signed the buyer's agent agreement (104) as shown in FIG. 2L. The real estate agent contacts the participant regarding the home purchase (34), and the process of the participant searching for property with the real estate agent is repeated (37) as shown in FIG. 2L and FIG. 2N.

Participant Finds Property to Purchase

If the participant finds property to purchase and signs a purchase and sale agreement (38), the RE Admin updates the transaction status to “escrow” (39) as shown in FIG. 2O. Once the sale closes, the transaction status is set to “property closed” (40) as shown in FIG. 2O.

As shown in FIG. 2P, depending upon whether the closing attorney or escrow agent is sending one or two checks to HomeGift (41), process steps (42) through (50) and (90) through (96) can be executed (where one check is sent) or, if the closing attorney or escrow agent is sending two checks, then process steps (51) through (63) can be executed.

Closing Attorney or Escrow Agent Sends One Check to HomeGift

Where the closing attorney or escrow agent sends one check to HomeGift, that check can be in the form of a referral fee that is issued (42) and mailed (43) to HomeGift as shown in FIG. 2P. Once the check is received by HomeGift, the transaction status is set to “ready to distribute” (44) as shown in FIG. 2P. Subsequent distribution of funds will depend upon the type of HomeGift model employed (90), e.g., royalty-only model, or one of the rebate models, associated with the transaction as shown in FIG. 2P. If the royalty-only model is being employed, then the percentages of finds to be distributed to the NPO and to HomeGift are calculated (91) as shown in FIG. 2P. Such calculation can be accomplished by, for example, a rebate calculator. The calculated values can be sent to an accounting software application such as QuickBooks®. HomeGift issues a check to the NPO and the transaction status is set to “check issued to NPO” (45) as shown in FIG. 2Q. The check is mailed to the NPO (46). HomeGift verifies receipt of the check by the NPO, and the transaction status is set to “check received” (47) as shown in FIG. 2Q. Acknowledgment letters are mailed to the NPO (48) and to the participant (49) as shown in FIG. 2Q. The transaction is complete and the transaction status is set to “transaction complete” (50) as shown in FIG. 2Q.

If one of the rebate models, e.g., royalty, donation, sharing, is being employed, then the percentages of funds to be distributed to the NPO and to HomeGift are calculated and the rebate to the participant is calculated (92) as shown in FIG. 2P. Such calculation can be accomplished by, for example, a rebate calculator. The calculated values can be sent to an accounting software application such as QuickBooks®. HomeGift issues (93) and mails (94) a check to the NPO as shown in FIG. 2P and FIG. 2Q. HomeGift issues (95) and mails (96) a rebate to the participant as shown in FIG. 2Q. HomeGift verifies receipt of the check by the NPO, and the transaction status is set to “check received” (47) as shown in FIG. 2Q. Acknowledgment letters are mailed to the NPO (48) and to the participant (49) as shown in FIG. 2Q. The transaction is complete and the transaction status is set to “transaction complete” (50) as shown in FIG. 2Q.

Closing Attorney or Escrow Agent Sends Two Checks to HomeGift

Where the closing attorney or escrow agent sends two checks to HomeGift, one check is mailed to HomeGift (51) and the other check is mailed to the NPO (52) as shown in FIG. 2R. Once the check is received by HomeGift, the transaction status is set to “received” (53) as shown in FIG. 2R. An acknowledgement letter is mailed to the participant (54) and to the NPO (55) as shown in FIG. 2T. The transaction is complete and the transaction status is set to “transaction complete” (56) as shown in FIG. 2T. Once the check is mailed to the NPO, an NPO administrator logs on to the HomeGift system (57) as shown in FIG. 2R. The NPO administrator determines whether the check was received (58). If the check was received by the NPO, then the transaction status is set to “check received” (59) as shown in FIG. 2R. If the NPO has not yet received the check, then the transaction status is set to “check not received” (60) as shown in FIG. 2S. HomeGift runs a non-received checks report (61) as shown in FIG. 2S. HomeGift contacts the real estate agent associated with the real estate transaction for which a check has yet to be received to rectify the situation (62) as shown in FIG. 2S. HomeGift follows-up with the NPO (63) to inform the NPO of the delay as shown in FIG. 2S.

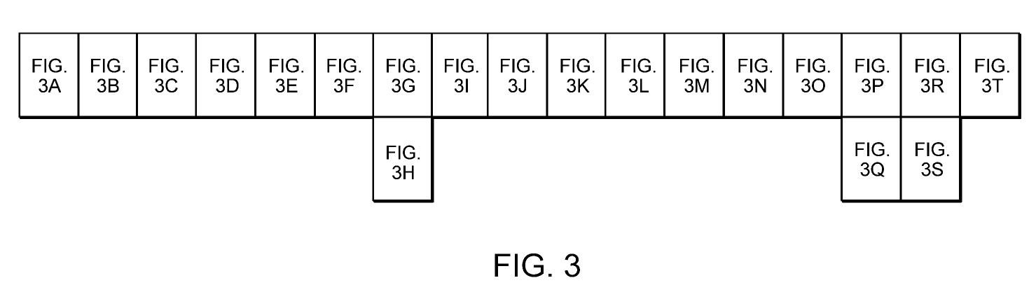

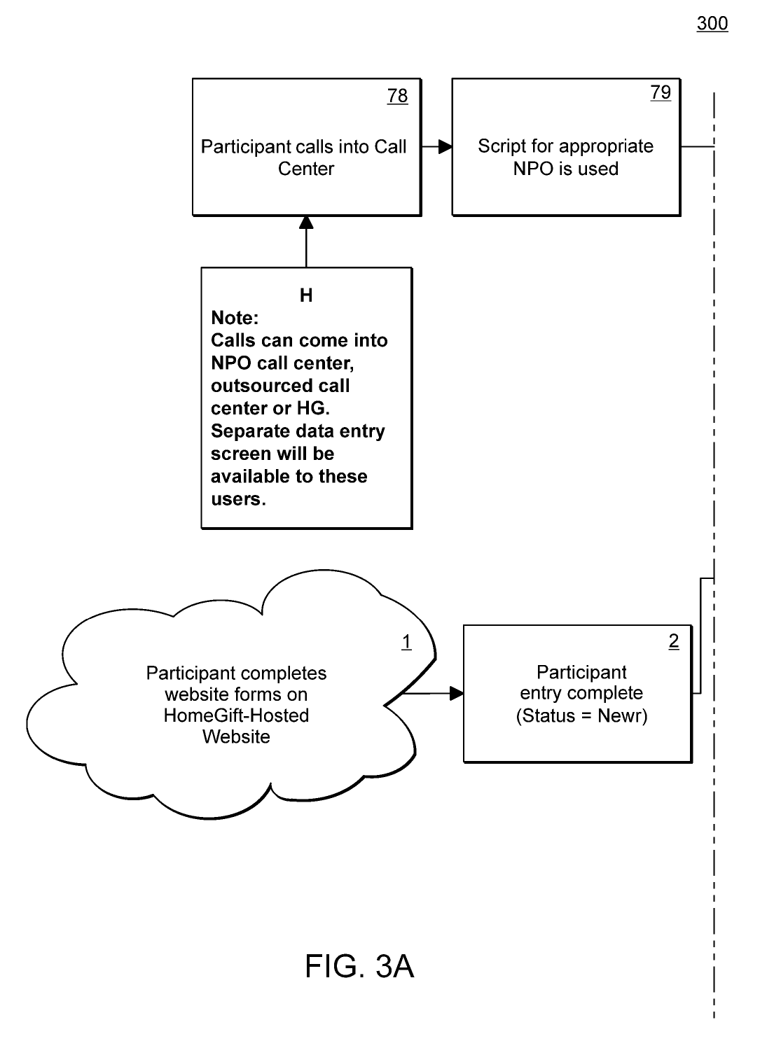

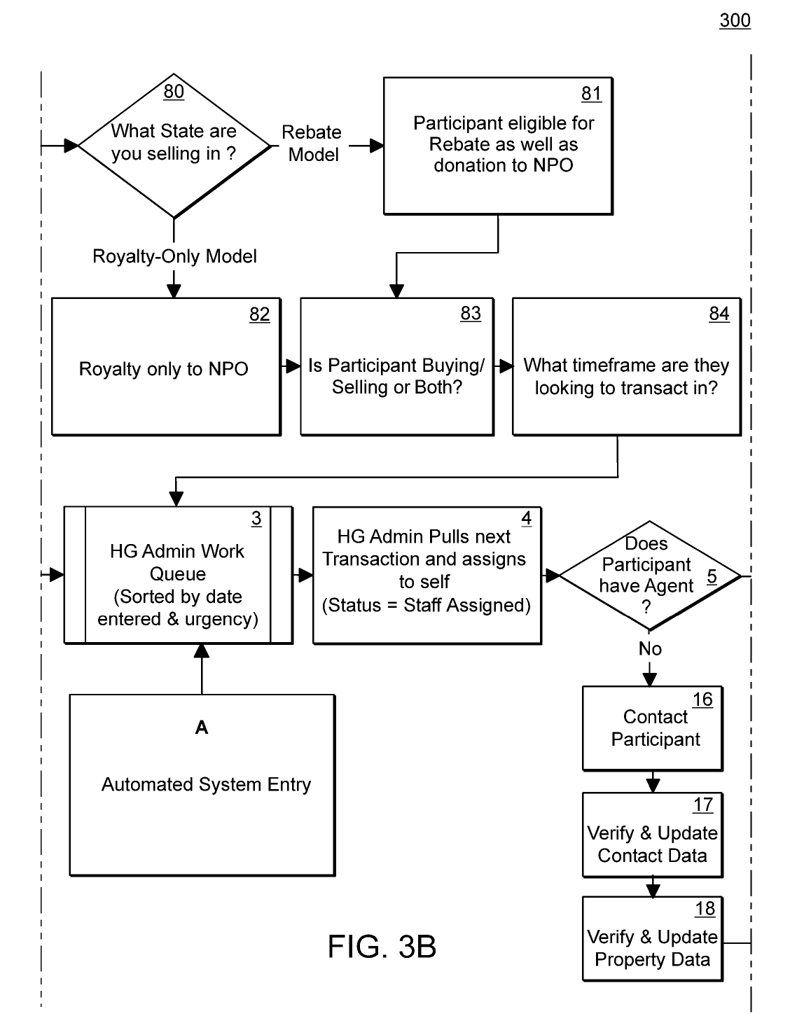

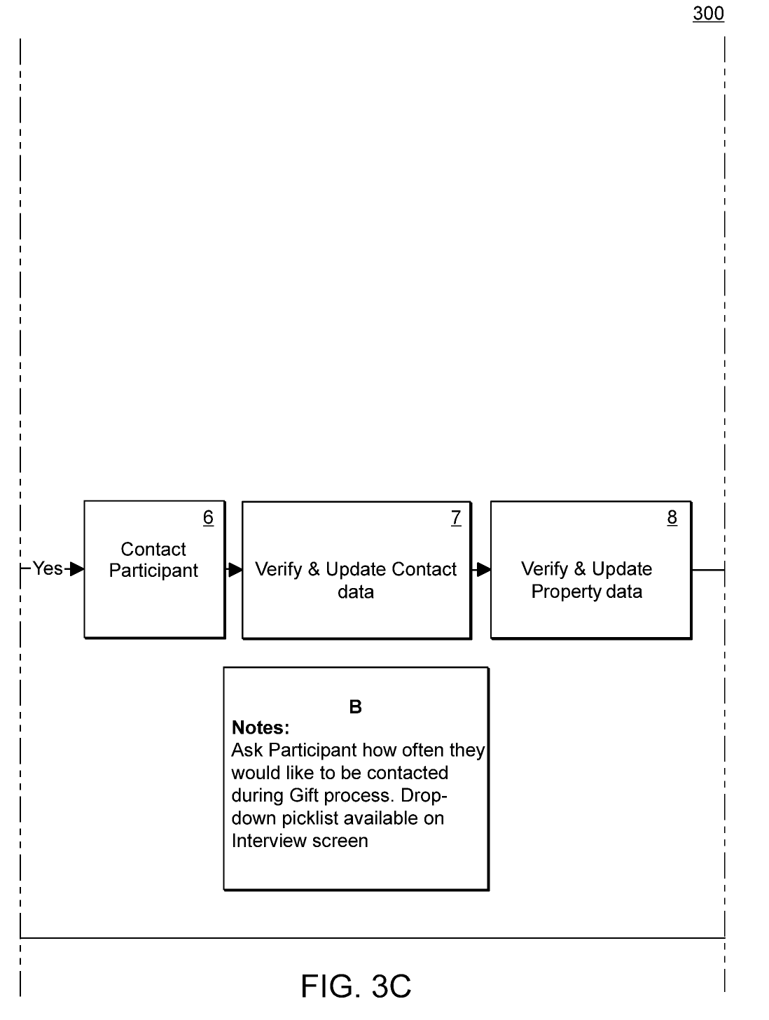

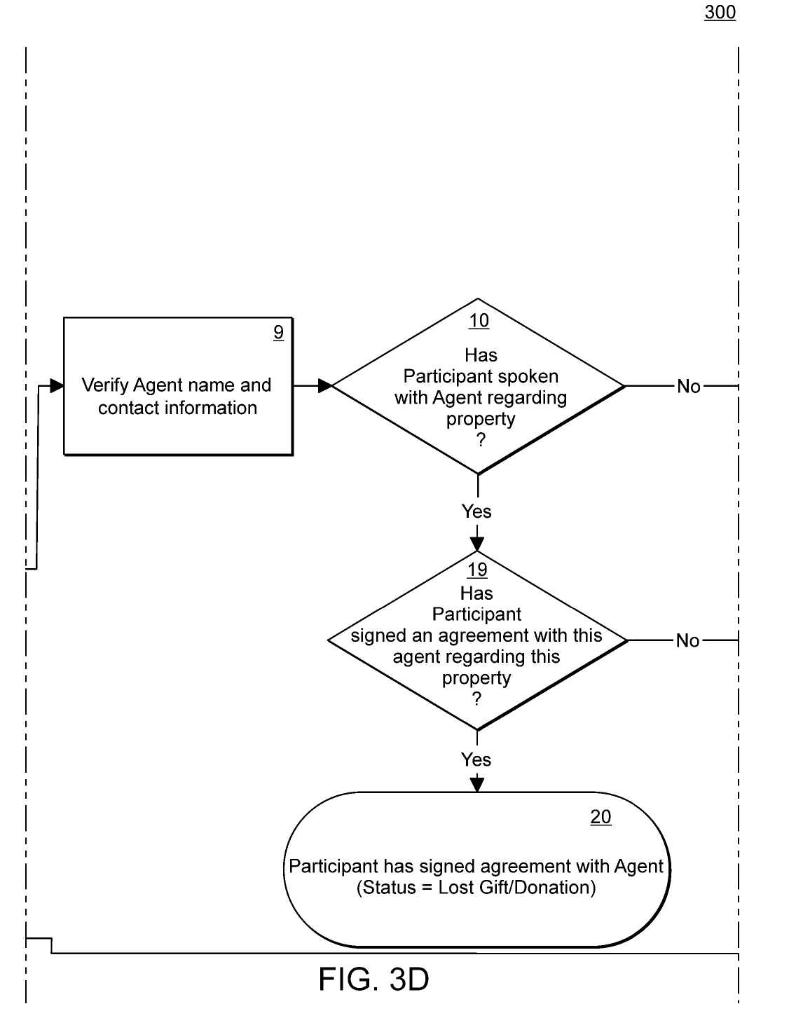

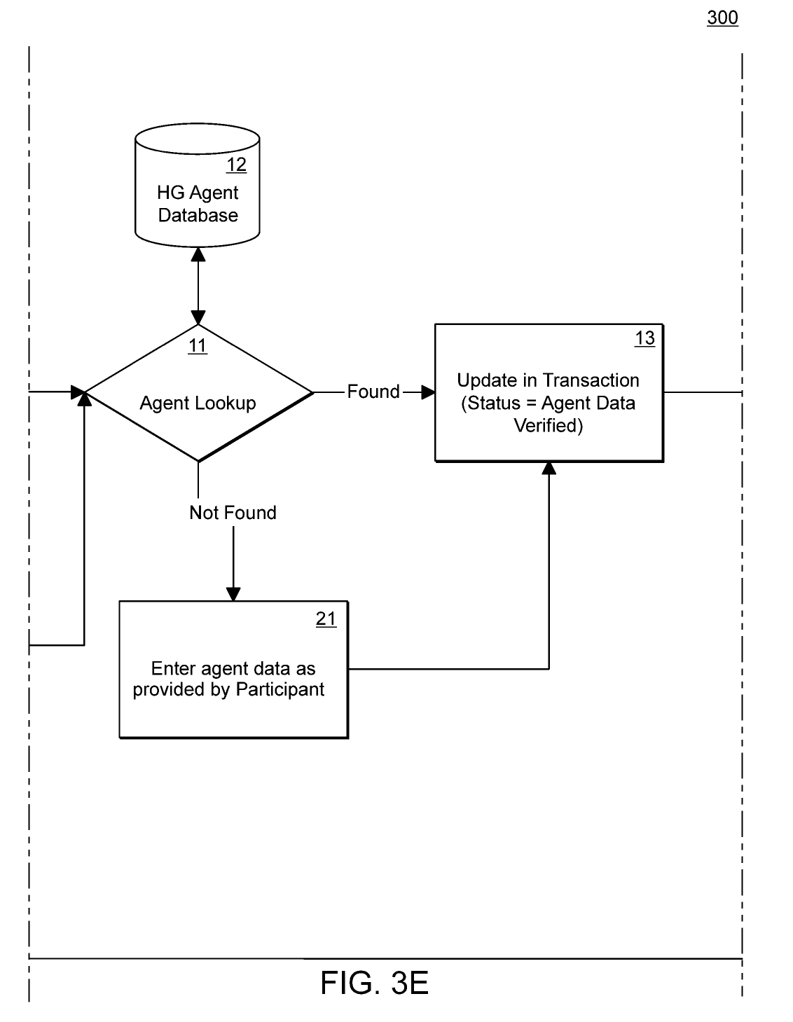

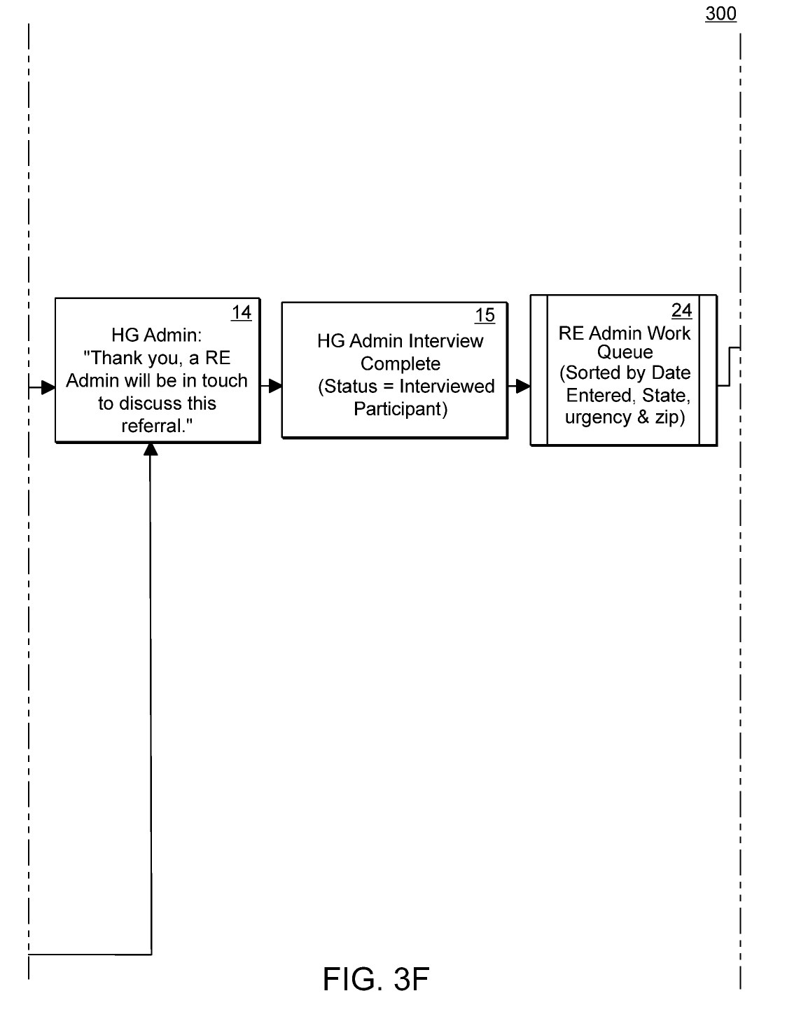

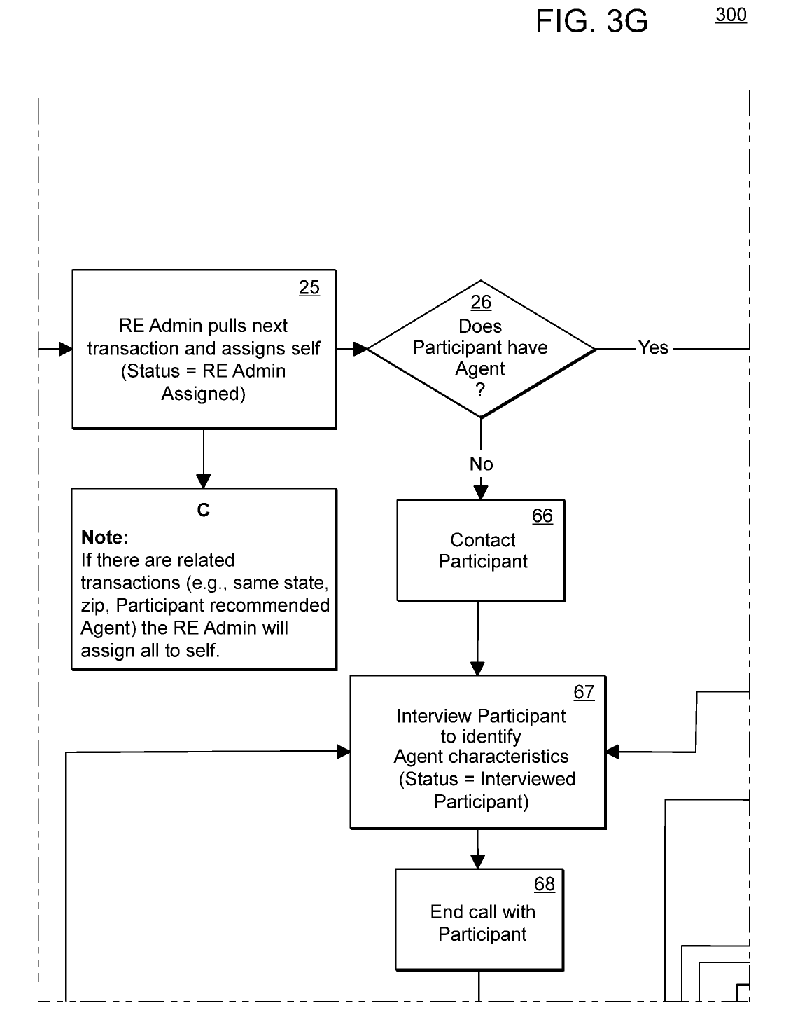

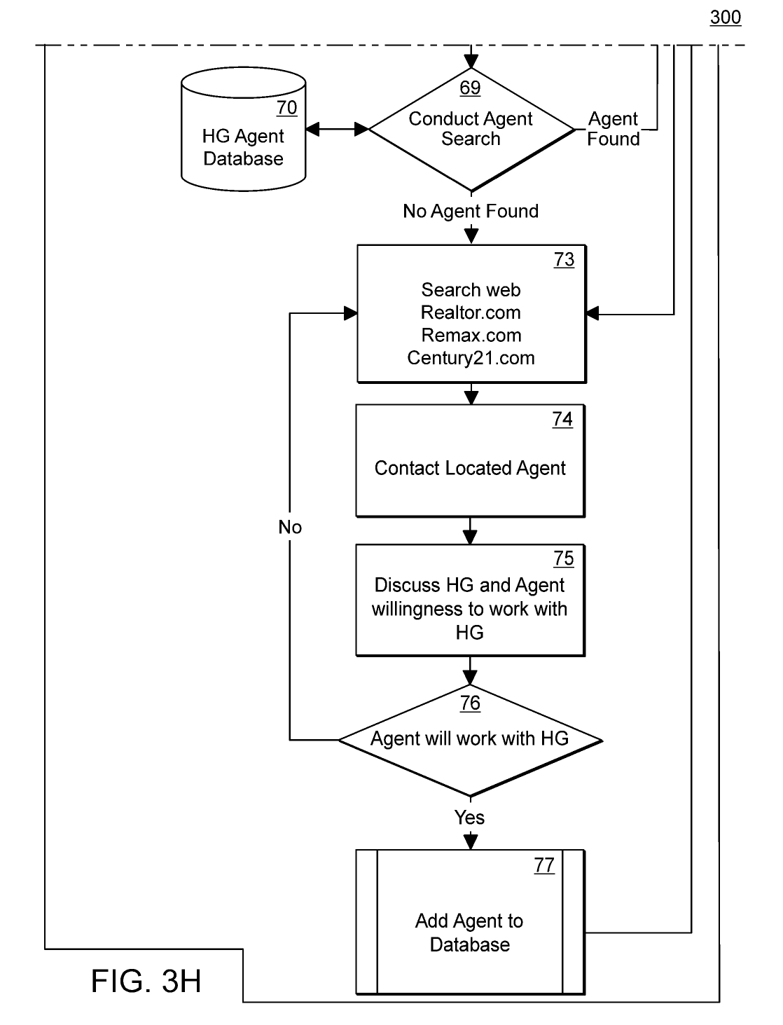

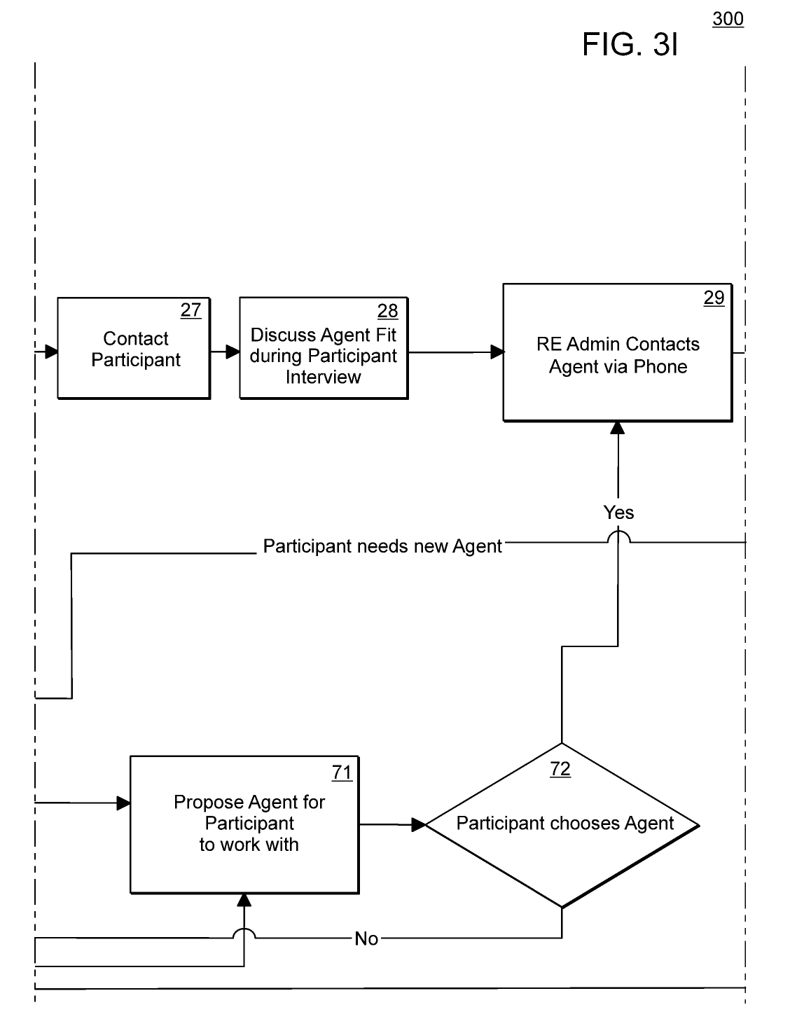

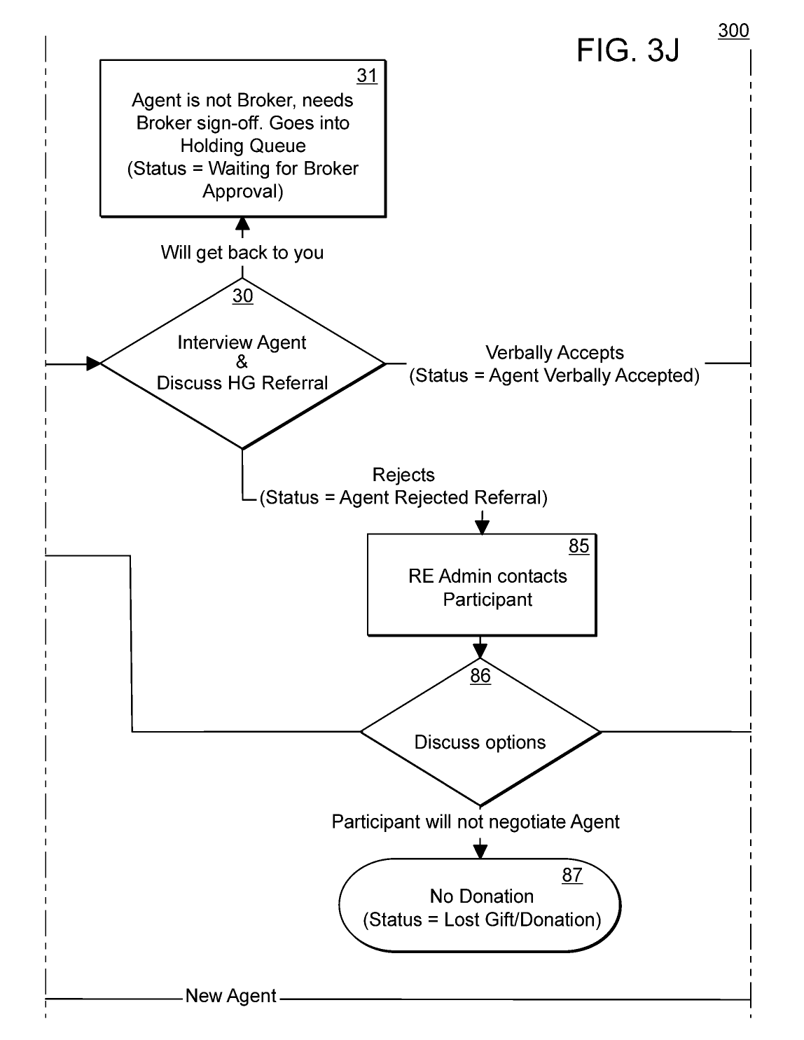

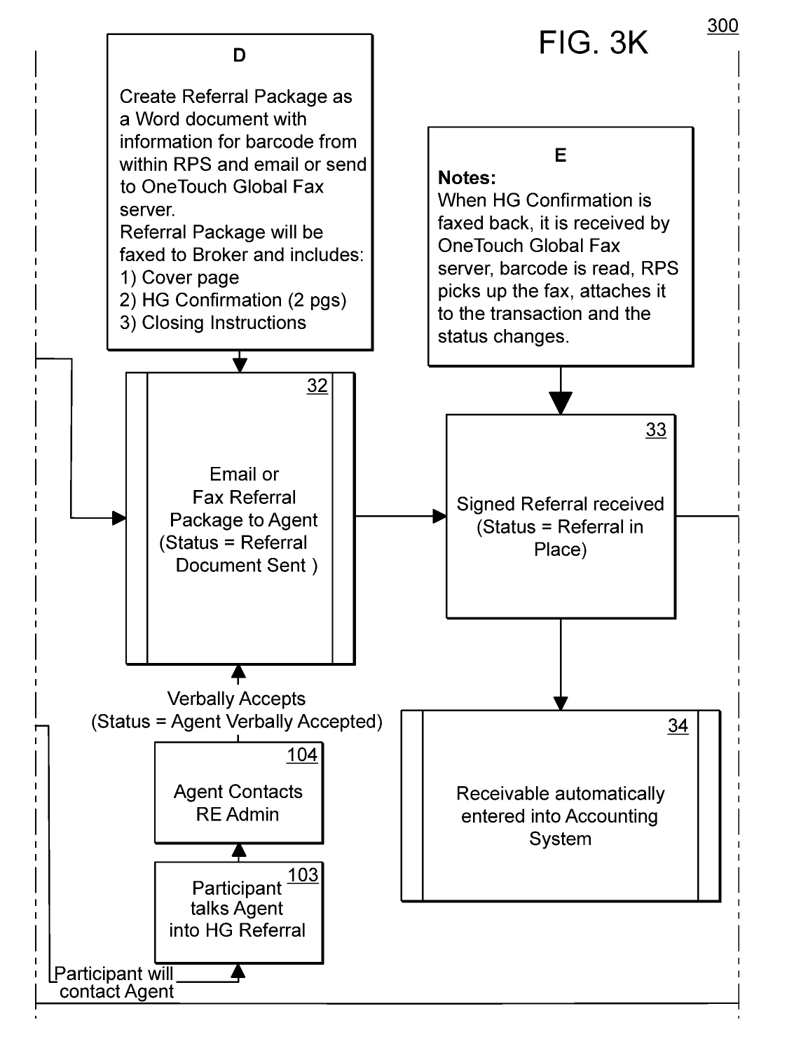

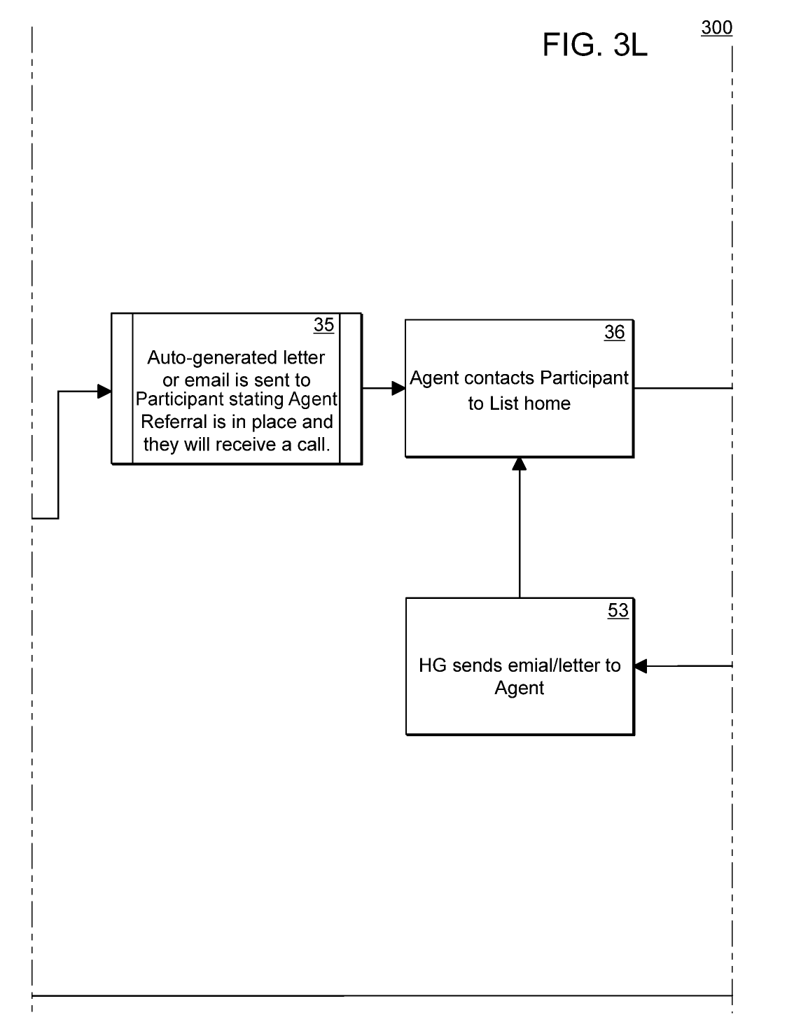

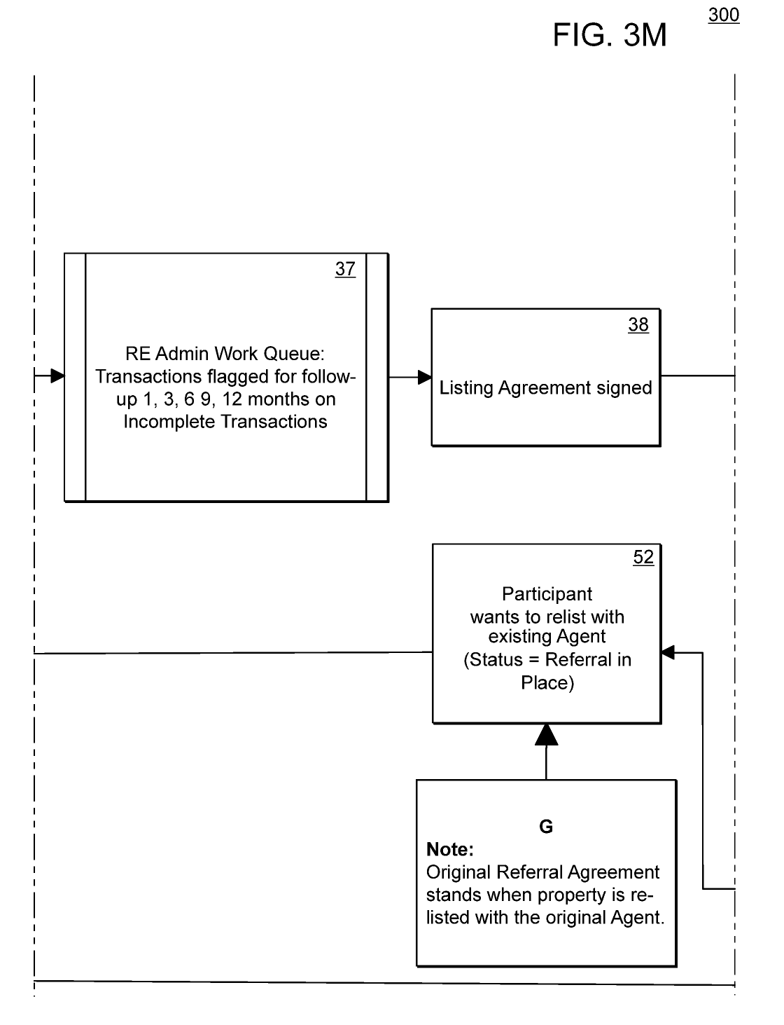

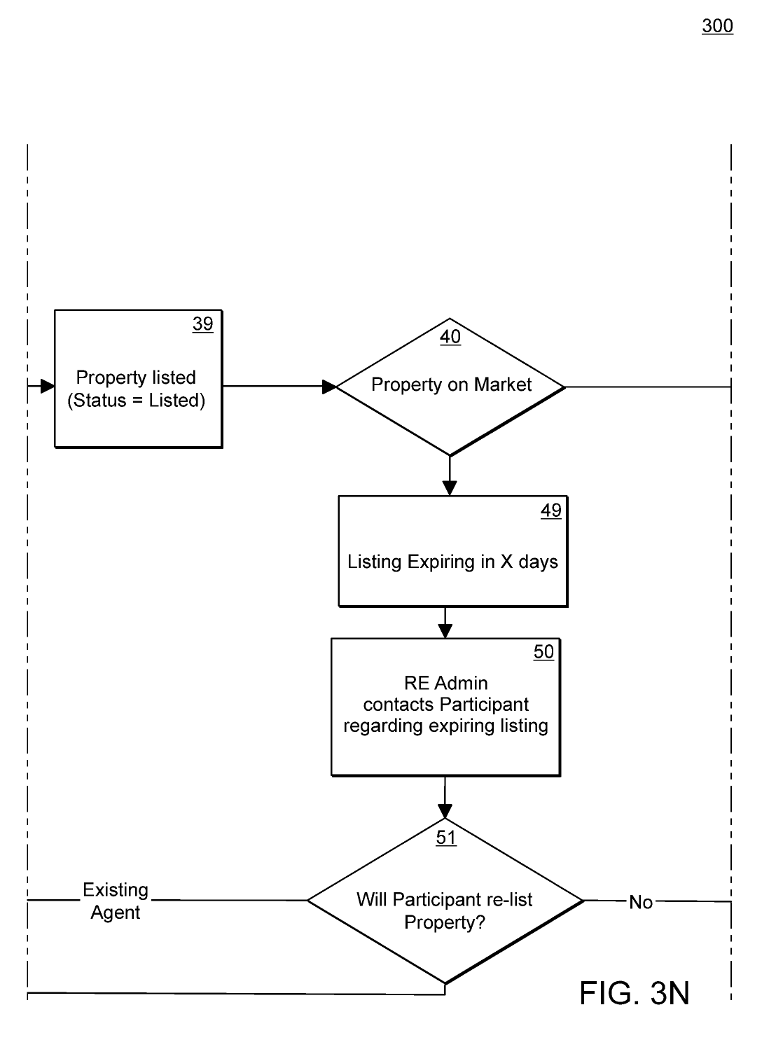

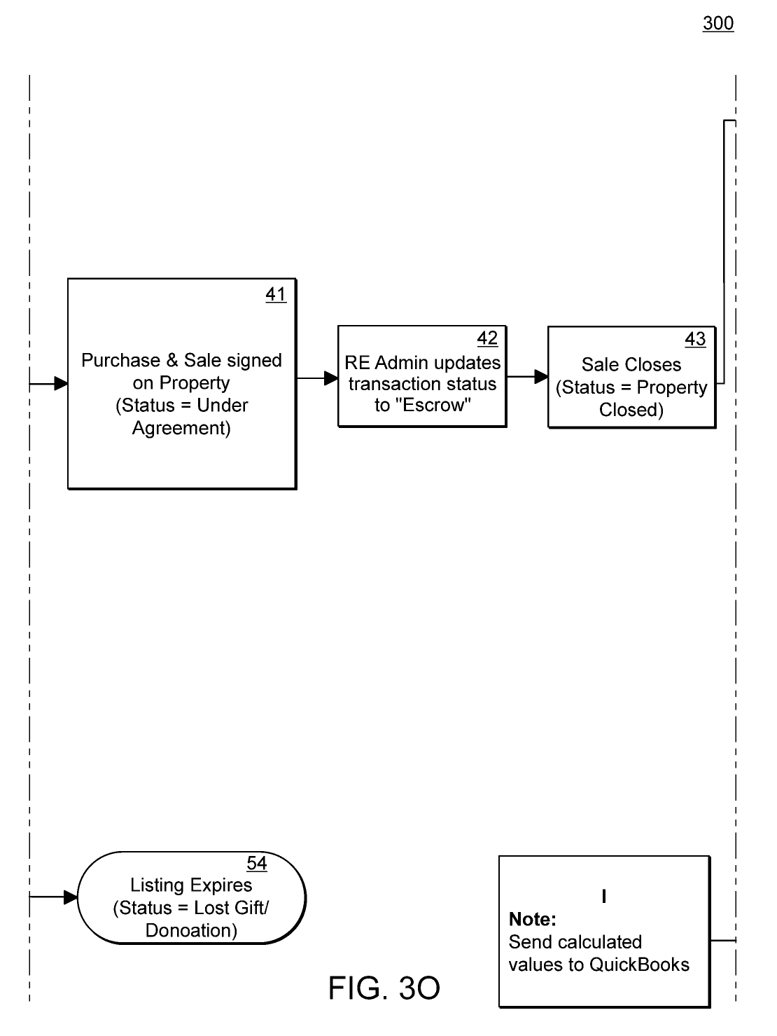

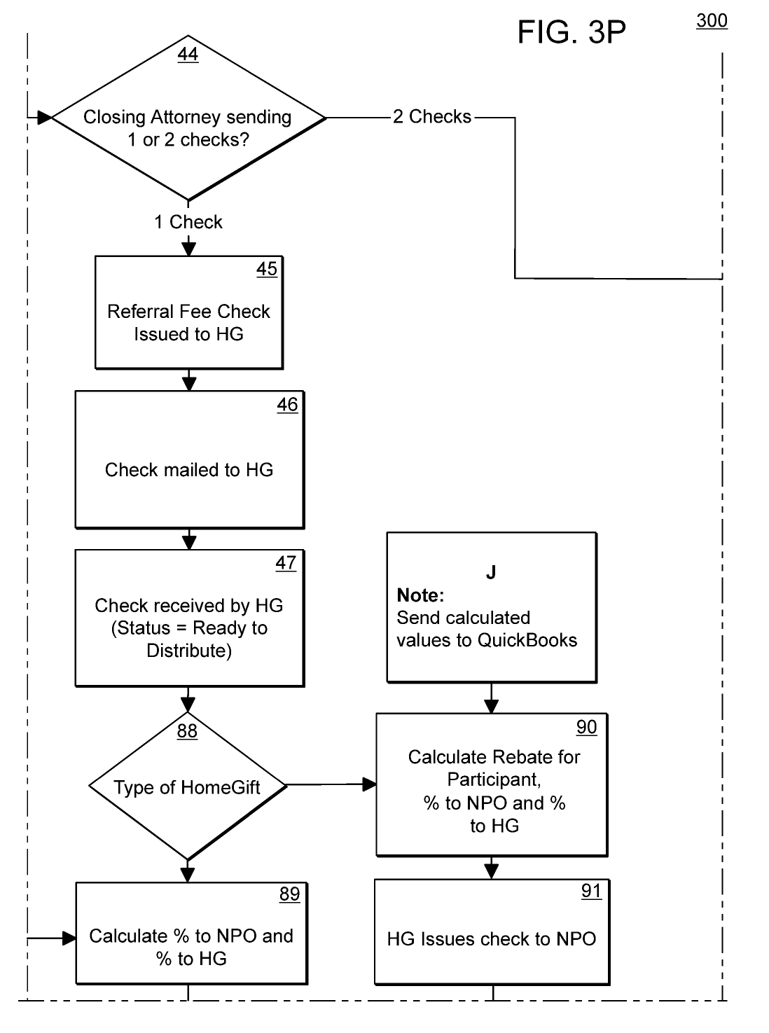

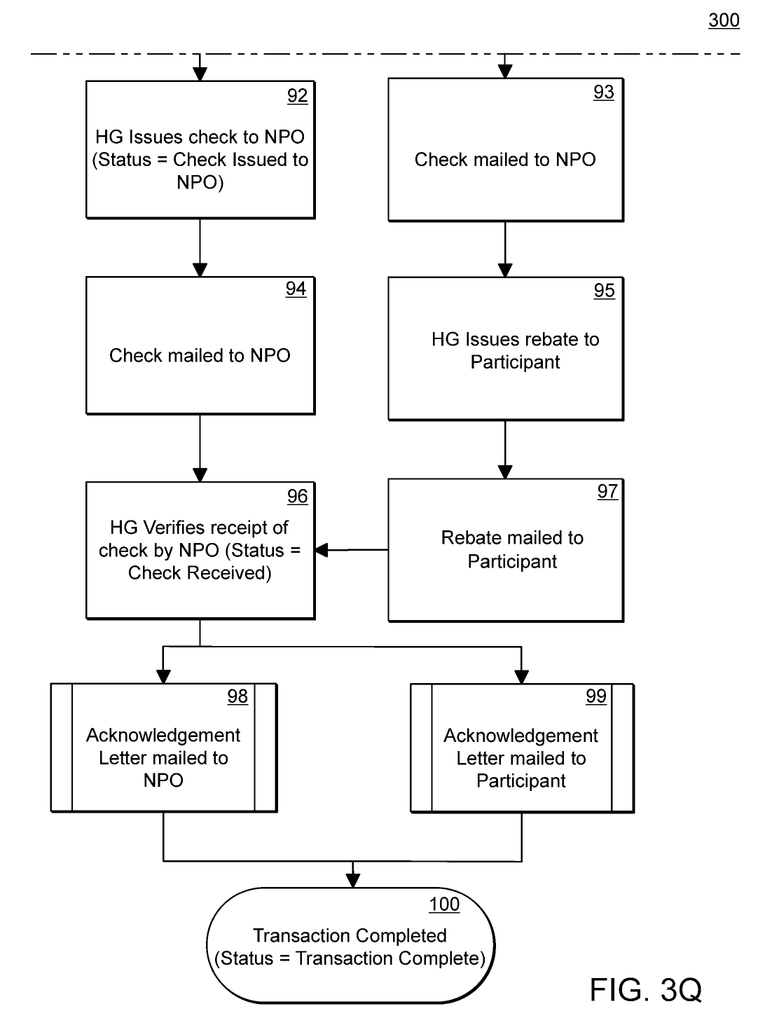

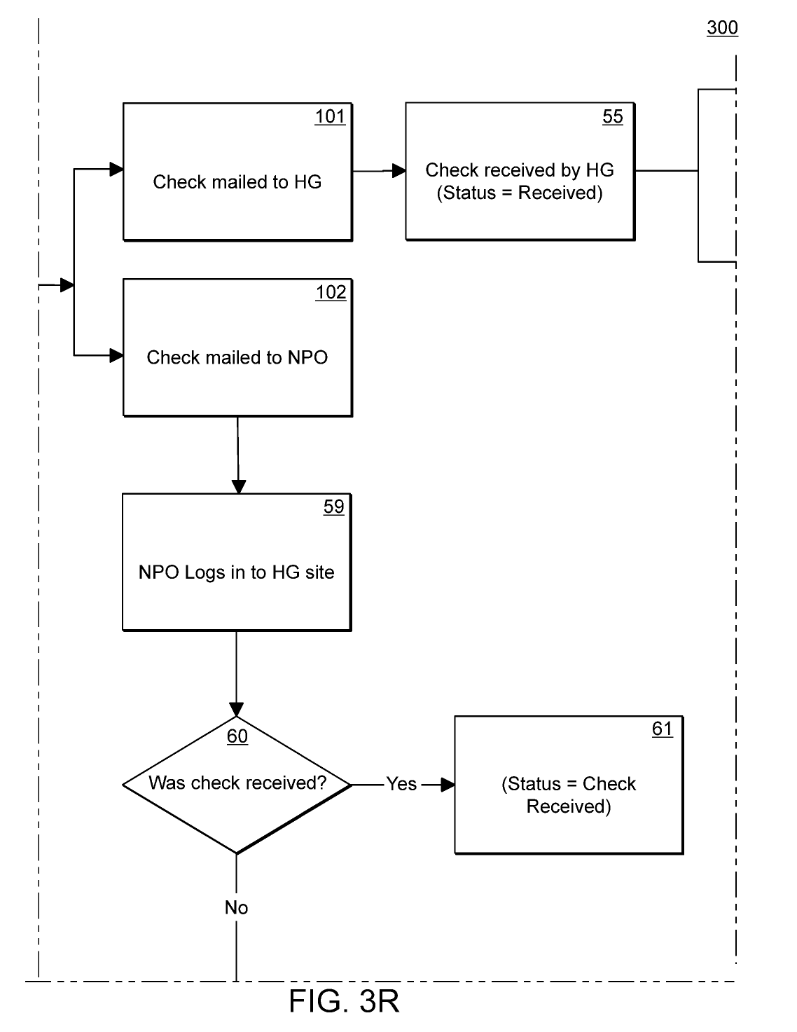

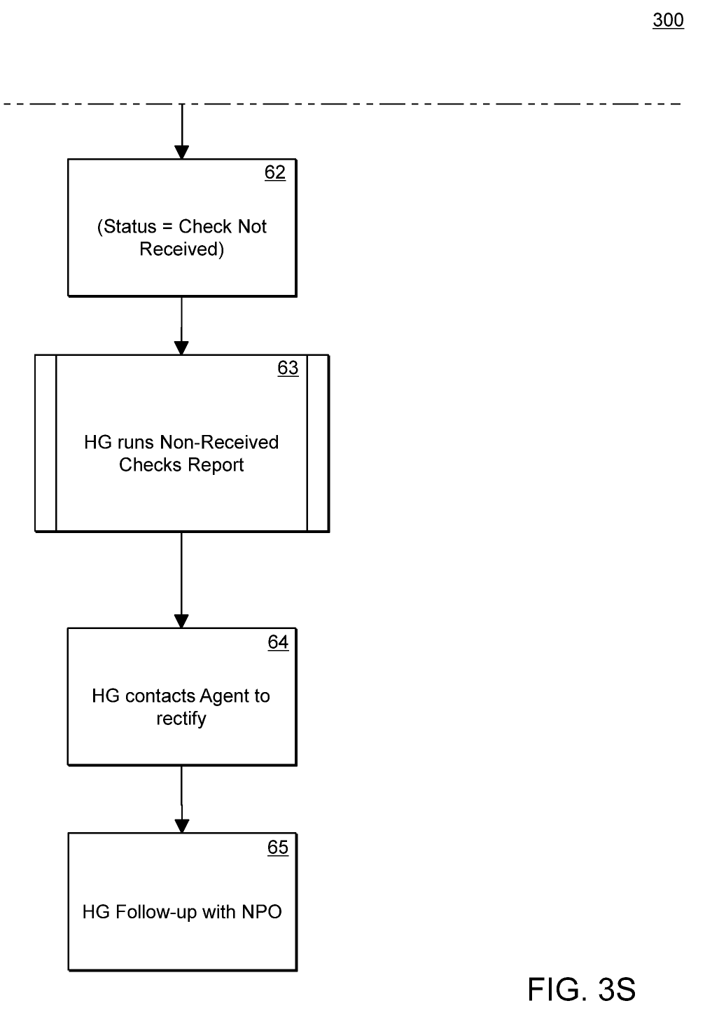

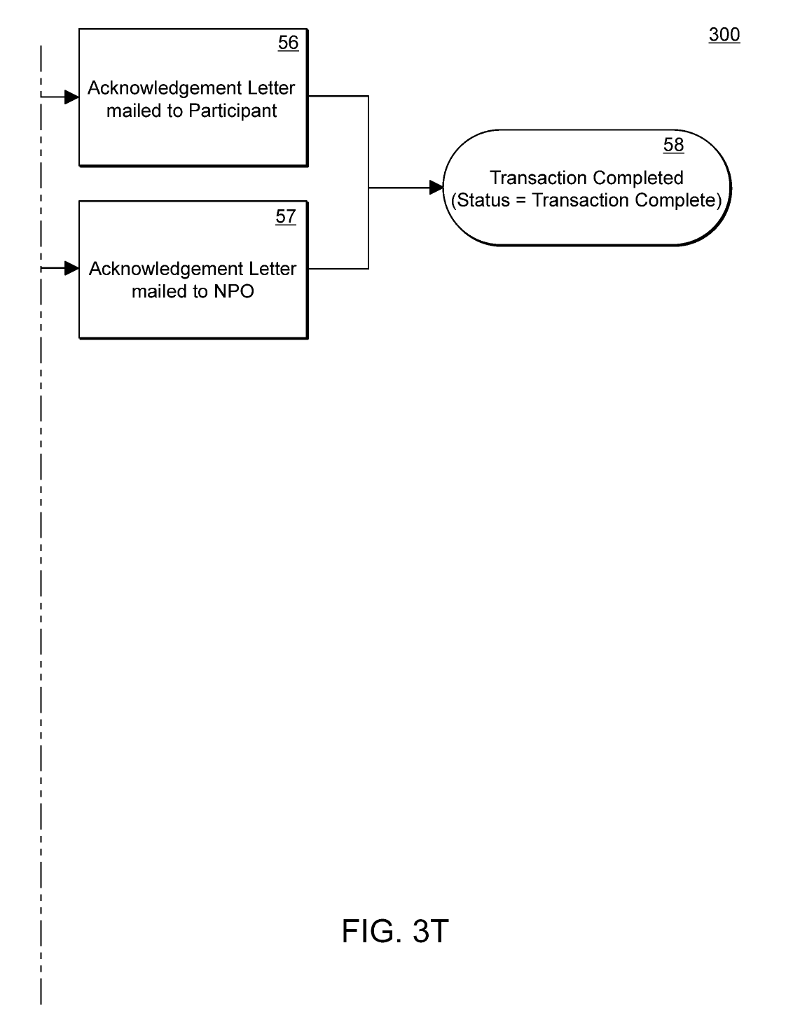

FIGS. 3A-3T depict process flow diagrams associated with a real estate transaction in which property is sold and a seller donates to an NPO. For such exemplary sell-side transactions, the HomeGift technology can apply to each of at least two different real estate scenarios. Such scenarios can include, for example, when a home seller is looking for a listing agent and does not know one; and when a home seller has a listing agent in mind, but wishes to receive a rebate and donate to an NPO. In some cases, HomeGift can seek a referral fee only if the home seller has not already signed a binding listing or seller's agent agreement.

The exemplary process steps of FIGS. 3A-3T for a sell-side transaction are similar to the process steps illustrated as part of the exemplary buy-side transaction of FIGS. 2A-2T. For sell-side transactions, if the participant does not have a real estate agent, the HG AR or RE Admin contacts the participant (16), and verifies and updates contact data (17) and property data (18) as shown in FIG. 3B. For sell-side transactions, the automatically-generated letter or electronic mail that is sent to the participant (35) after the signed referral package is received typically will not include HomeGift rules for buying property through a referral as shown in FIG. 3L.

For sell-side transactions, once the signed referral package is received (33) and the letter or email to the participant automatically generated (35), the real estate agent contacts the participant to list the home or property (36) as shown in FIG. 3K and FIG. 3L. Incomplete transactions can be flagged in the RE Admin work queue for one, three, six, nine and/or twelve month follow-up (37) as shown in FIG. 3M. A listing agreement between the participant and the real estate agent is signed (38) for a specific term, e.g., a specified number of days or months as shown in FIG. 3M. The seller's property is listed (39), and the transaction status is set to “listed” as shown in FIG. 3N. The transaction moves into a post-referral work queue for further monitoring. If the property is still on the market (40), and the listing agreement is set to expire (49), as reflected in the transaction status of the RE Admin work queue, the RE Admin contacts the participant regarding the expiring listing (50) as shown in FIG. 3N. Process steps associated with an expiring listing can be executed, similar to the process steps associated with the expiring buyer's agent agreement depicted in FIGS. 2M-2O.

Once the purchase and sale agreement is signed, the transaction status is set to “under agreement” (41) as shown in FIG. 3O. Subsequent process steps for sell-side transactions associated with, for example, processing and distribution of check(s) to HomeGift, the NPO, and/or the participant, if applicable, are similar to those steps outlined as part of the exemplary buy-side transaction illustrated in FIGS. 2A-2T.

The HomeGift technology supports combination transactions in which property is purchased and sold. Process steps for such combination transactions can include steps associated with buy-side and sell-side transactions depicted in FIGS. 2A-2T and FIGS. 3A-3T, respectively. The questions posed by the call center representative to the participant may differ slightly for combination buy-sell transactions, e.g., state selling, state buying in, buying and selling timeframe of transaction, etc. For combination buy-sell transactions, when the RE Admin contacts the participant, he/she may discuss, for example, the type of property that the participant is looking for, the property that the participant is selling, the real estate agent that the participant may have chosen, or the characteristics that the participant is looking for in a real estate agent to assist the participant with the purchase and sale of property. Depending upon the needs of the participant, one or more real estate agents may be involved to complete the combination buy-sell transaction.

For combination transactions, once a buyer's agent agreement and listing agreement have been signed by the participant and real estate agent(s), the transaction will move into a post-referral work queue for further monitoring. For combination buy-sell transactions, there can be two transactions, e.g., buy and sell, associated with the participant. With combination buy-sell transactions, two checks are typically sent from the closing attorney(s) to HomeGift. One check is associated with the sale of the property and one check is associated with the purchase of another property. The timing of the receipt of these checks may not be the same. Once HomeGift receives the checks, HomeGift can issue one check to the NPO for the donation and another to the participant, if applicable.

In some embodiments, the HomeGift system allows a referred agent to be assigned to a particular transaction, for example, based on the referral. In some embodiments, an agent can be “unassigned” or removed from a particular transaction.

In some embodiments, when the NPO agrees to participate in one of the HomeGift programs, the NPO agrees to provide a mechanism for its members and supporters to contact a real estate agent through HomeGift, and by that same action, provide a portion of funds to the NPO.

In some embodiments, the HomeGift technology involves a participating NPO taking the following exemplary steps: 1) signing a mutual non-disclosure agreement with HomeGift prior to discussion of the HomeGift program and technology; 2) signing a licensing agreement with HomeGift that allows HomeGift to use the NPO's logo, trademark(s), and name in exchange for royalty payments from the referral fee HomeGift receives; 3) after mutual agreement between HomeGift and the NPO, signing a marketing plan that outlines how the HomeGift program will be tested and marketed at the NPO, including the type of rebate models that will be used, where permitted by law; 4) putting a HomeGift link on the NPO's organizational website that links to the NPO-branded, private label HomeGift Web page; and 5) providing information about the HomeGift program to the NPO's members and participants, consistent with requirements under § 501(c)(3) of the Internal Revenue Code and other relevant provisions of the Internal Revenue Code. Typically, this can be done through information in existing communications vehicles, e.g., newsletters, and through specific direct mail campaigns. In some embodiments, the information can highlight the HomeGift program and the financial benefits to the NPO. NPOs can encourage their supporters and members to spread the word to friends and relatives who might be selling and/or buying a home. In some embodiments, information with different emphases is provided to varying segments of participants and supporters based on where the participants and supporters live. These segments can include rebate state-segments and non-rebate state-segments. In some embodiments, a database can be maintained that determines the current legality of rebate programs on a state-by-state basis. The database can be updated periodically to reflect changes in law.

The HomeGift technology and business systems can include externally-facing and internally-facing systems. In some embodiments, HomeGift's internally-facing systems can include a property transaction database, an accounting application, an automated fax server software, for example, One Touch Global Technologies, Inc.'s Fax Server solution, and automated fax server technology for exchanging property transaction documents with real estate brokers, agents, and/or participants. HomeGift's externally-facing systems can include, for example, a public Internet website and a series of dynamic private label websites.

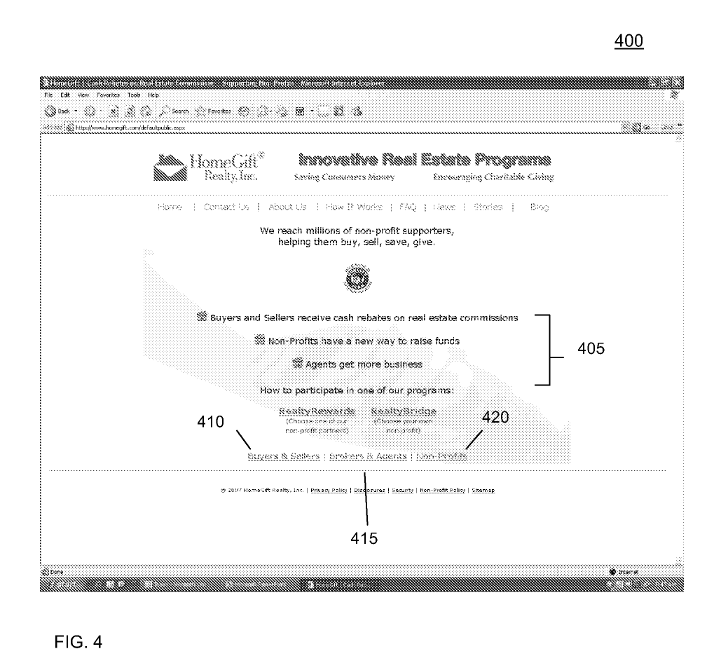

FIG. 4 illustrates a representative displayed home page 400 associated with HomeGift's public Internet website. One version of the website is the public version and can be found at http://www.homegift.com. The displayed Web page 400 provides users with hyperlinks to, for example, an overview of the HomeGift referral program 405 and enables buyers and sellers 410, brokers and agents 415, NPO's 420, and others to contact HomeGift directly or sign-up with HomeGift.

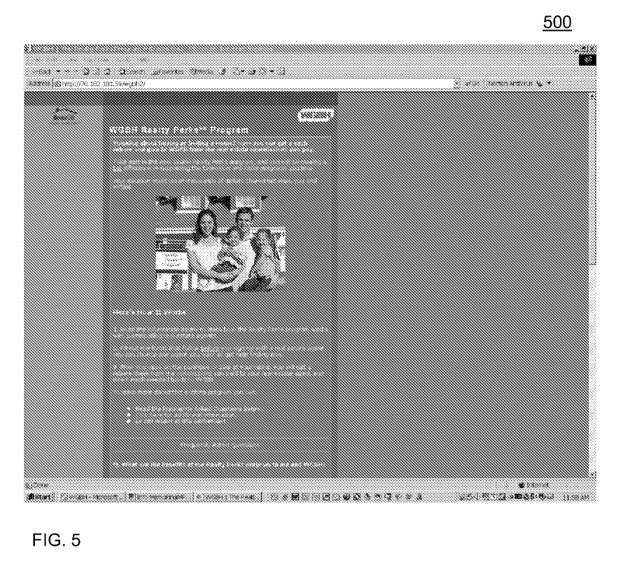

HomeGift's dynamic private label websites can be configured to reflect the look and feel of a specific non-profit organization. FIG. 5 illustrates an exemplary dynamic private label Internet website 500 associated with WGBH Public Broadcasting Station. HomeGift's dynamic private label websites can support entry of information. Such information can be used by HomeGift, for example, to update an SQL database and to arrange a referral to a licensed real estate agent.

HomeGift's externally-facing systems are compatible with, for example, major browser applications, including Internet Explorer®, Firefox®, and Netscape®. Forms of HomeGift's externally-facing websites have been built around Microsoft®'s .NET framework, using ASP.NET, a set of web development technologies marketed by Microsoft®. Programmers may use this set of technologies to rapidly build web applications and XML web services, using various programming languages supported by the .NET framework, such as Visual Basic.NET (proprietary) or C# (standardized), and/or open-source languages such as Perl and Python.

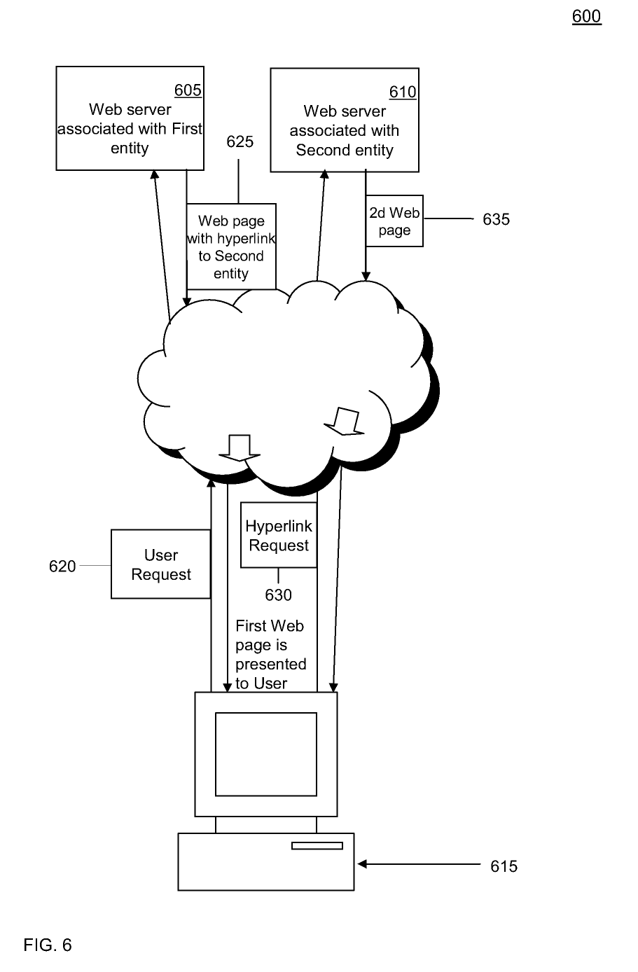

FIG. 6 is a plan diagram of an exemplary system 600 that embodies the technology. The system 600 of the HomeGift technology can include a Web server 605 that is associated with a first entity, a Web server 610 that is associated with a second entity, and a computing device 615 running a browser application, e.g., being interacted with by a user. The user uses the computing device 615 to transmit a request 620 for a Web page 625 from the Web server 605 associated with the first entity. In response to the request 620, the Web server 605 that is associated with the first entity returns the Web page 625, which includes a hyperlink to the Web server 610 that is associated with the second entity. The first Web page 625 associated with the first entity is presented to the user on the computing device 615. The user can click on the hyperlink included in the first Web page 625. In response, the Web server 610 that is associated with the second entity returns a second Web page 635. The second Web page 635 associated with a second entity can be presented to the user on the computing device 615. As explained in more detail below, the second Web page 635 has the look and feel of the first Web page 625. Because of this, the user may not be aware that the second Web page 635 is being transmitted from the Web server 610 that is associated with a second entity. In other words, from the user's point-of-view, it appears to the user that he/she is receiving the second Web page 610 from the same entity (e.g., the same source).

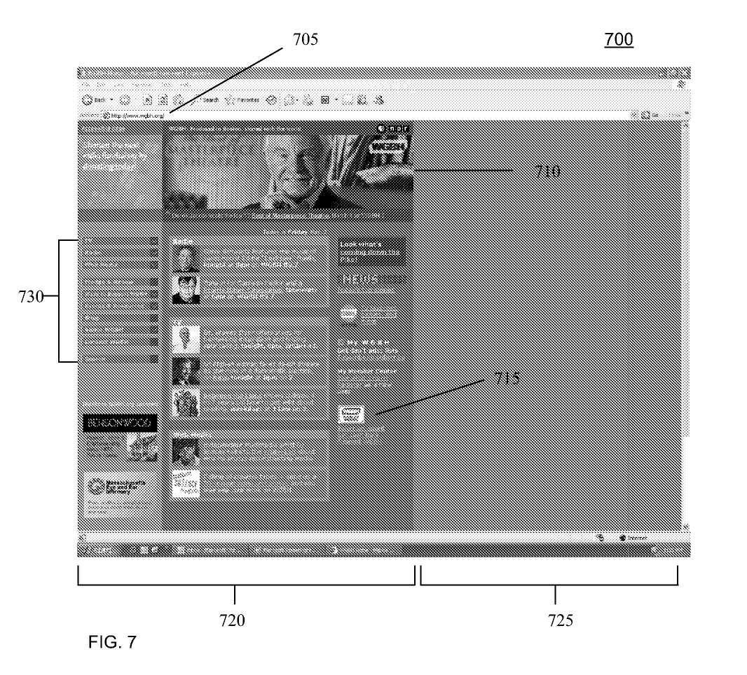

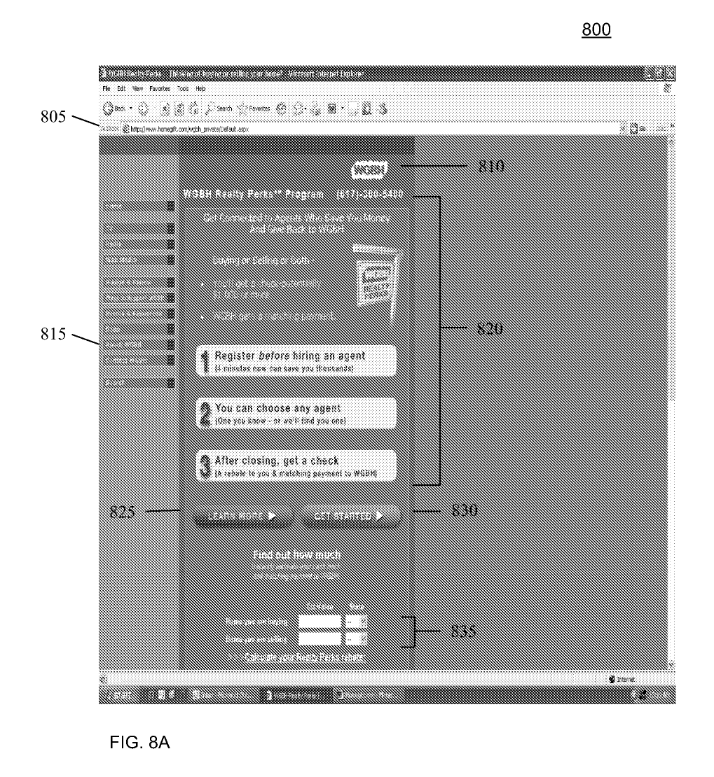

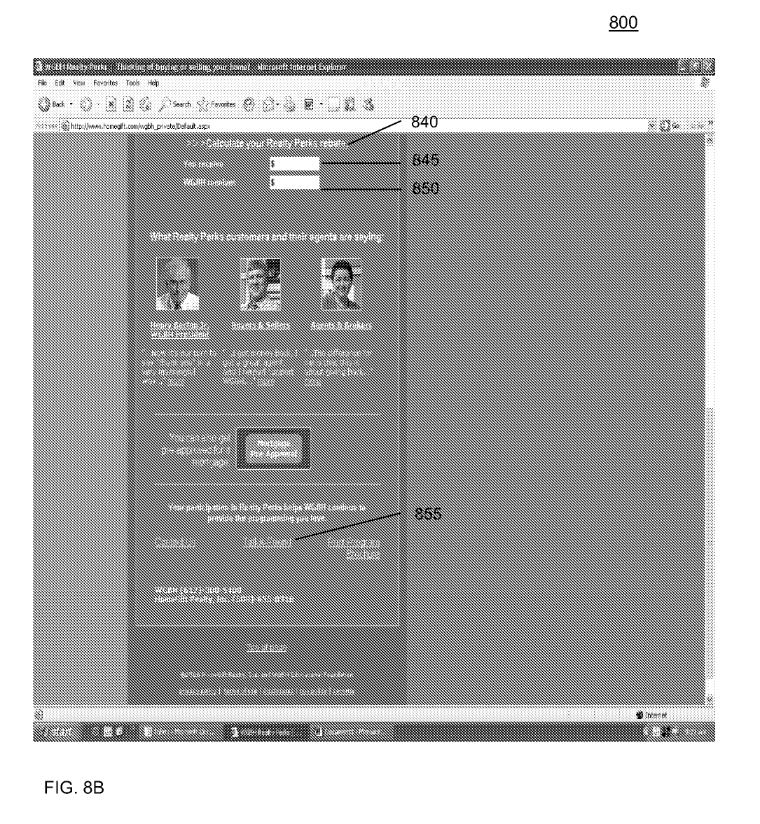

FIG. 7 depicts a specific example of a first Web page associated with a first entity and a hyperlink to a second set of Web pages associated with a second entity as discussed in connection with FIG. 6. Namely, FIG. 7 illustrates an exemplary Web page 700 sent from an exemplary website located at www.wgbh.org 705. In the example of FIG. 7, the first entity is the WGBH Public Broadcasting Station, a non-profit organization participating in the HomeGift referral program. The exemplary first Web page 700 associated with a first entity includes a series of hypertext links 730 associated with the WGBH non-profit organization. The exemplary first Web page 700 is configured to include web content 720 on the left portion of the first Web page 700 and blank space 725 on the right portion of the first Web page 700, providing a specific page format associated with the www.wgbh.org website. A consumer, real estate agent, or other website visitor may access the exemplary NPO website depicted in FIG. 7, and click on a “HomeGift” hyperlink 715 to seamlessly navigate to NPO-branded, private-label HomeGift Web pages such as those depicted in FIGS. 8A-8B. The hyperlink 715 from the NPO's website provides members or participants with a means to access information about the HomeGift program, and leverages the goodwill and reputation of the NPO. Participants may enter the HomeGift website either via a hyperlink 715 on the NPO website or directly from www.homegift.com.

The NPO's HomeGift program can be branded specifically for the NPO. For example, if a supporter clicks on a hyperlink 715 associated with HomeGift from a website such as that of the WGBH Public Broadcasting Station, the supporter will see WGBH-branded HomeGift Web pages depicted in FIGS. 8A-8B, which may be offered under a program name unique to WGBH such as, for example, “Realty Perks.” In this way, a seamless integration between the first entity, e.g., WGBH, and the different second entity, e.g., HomeGift, is presented to the supporter (e.g., user) via the browser.

FIGS. 8A-8B depict a representative introductory Web page associated with a second entity. The Uniform Resource Locator (URL) 805 related to the introductory second Web page 800 associated with the second entity is different from the URL 705 related to the first Web page 700 associated with the first entity depicted in FIG. 7. FIG. 8A represents the top portion of an exemplary second Web page 800 associated with the WGBH Realty Perks-branded HomeGift referral program. FIG. 8B represents the bottom portion of an exemplary Web page 800 associated with the WGBH Realty Perks-branded HomeGift referral program. The second Web page 800 depicted in FIGS. 8A-8B includes a color scheme substantially identical to the first Web page 700 of FIG. 7, a logo 810 associated with the first entity, a second hyperlink 815 associated with the first Web page 700, and a page format substantially identical to the first Web page 700. In some embodiments, flags are used to indicate whether an NPO has a style guide and to provide a link and/or attachment to the style guide to enable a consistent look and feel, design, layout, color scheme, graphics, and/or formatting among Web pages associated with a first entity (e.g., the NPO) and those associated with a second entity (e.g., the service provider).

FIG. 8A provides, for example, a region 820 that includes an overview of the HomeGift referral program, a “learn more” button 825, a “get started” button 830, and a facility 835 (e.g., text boxes and drop down menus) for a website visitor to input data, e.g., estimated value of the home he/she is buying and/or selling and the state where he/she is buying and/or selling. The second Web page 800 associated with the second entity depicted in FIG. 8B provides, for example, a link 840 entitled “Calculate your Realty Perks rebate.” If the user clicks the link 840, consumer rebates 845 and NPO donations 850 will be automatically calculated via a rebate calculator associated with the second entity. In some embodiments, the rebate calculator calculates an estimated amount of funds to be provided to a consumer, an NPO, or both, based on a home value entered in the facility 835 of FIG. 8A by a user.

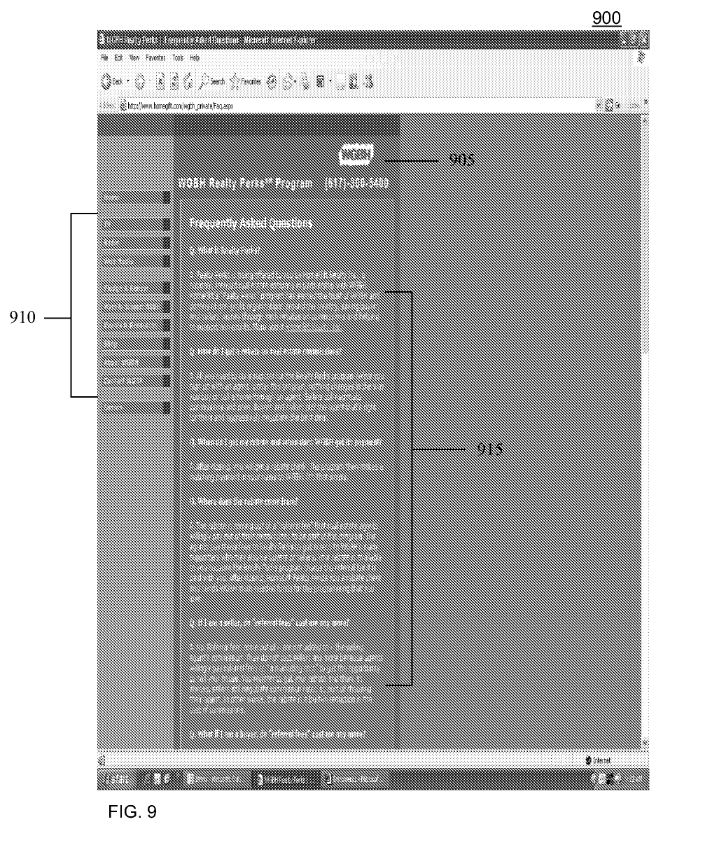

If a user clicks the “learn more” button 825 depicted in FIG. 8A, he/she is sent an exemplary Web page 900, illustrated in FIG. 9, that depicts a “Frequently Asked Questions” (FAQs) region 915 with answers to FAQs about the WGBH Realty Perks-branded HomeGift referral program. The exemplary Web page 900 associated with the second entity (e.g., the service provider, such as HomeGift) includes a logo 905 associated with the first entity, and a second set of hyperlinks 910 related to a Web page associated with a first entity. The “Frequently Asked Questions” region 915 includes information associated with the HomeGift program, details about how the program works, and percentages regarding NPO donations, consumer rebates, and/or HomeGift administrative fees. The FAQs in region 915 disclose to users the details of the HomeGift referral program and exemplify HomeGift's dedication to transparency.

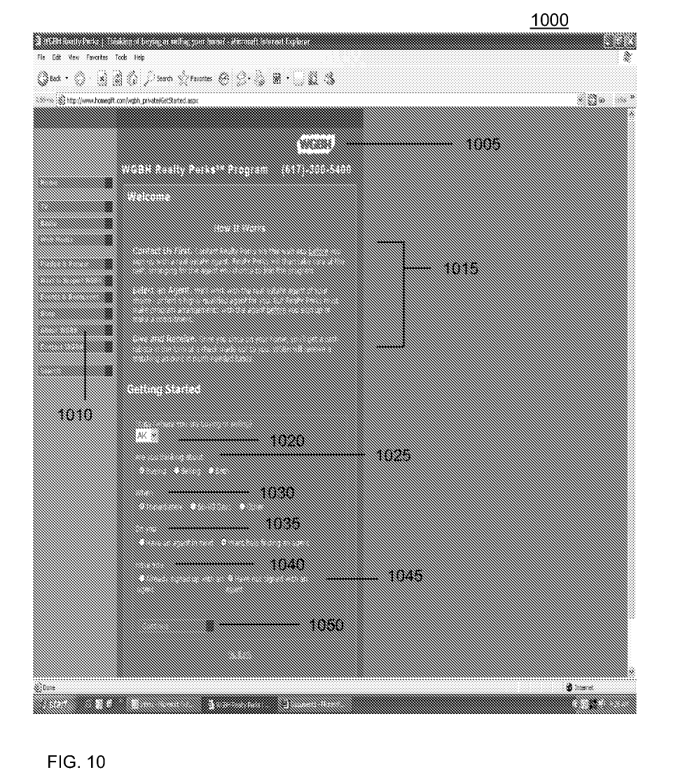

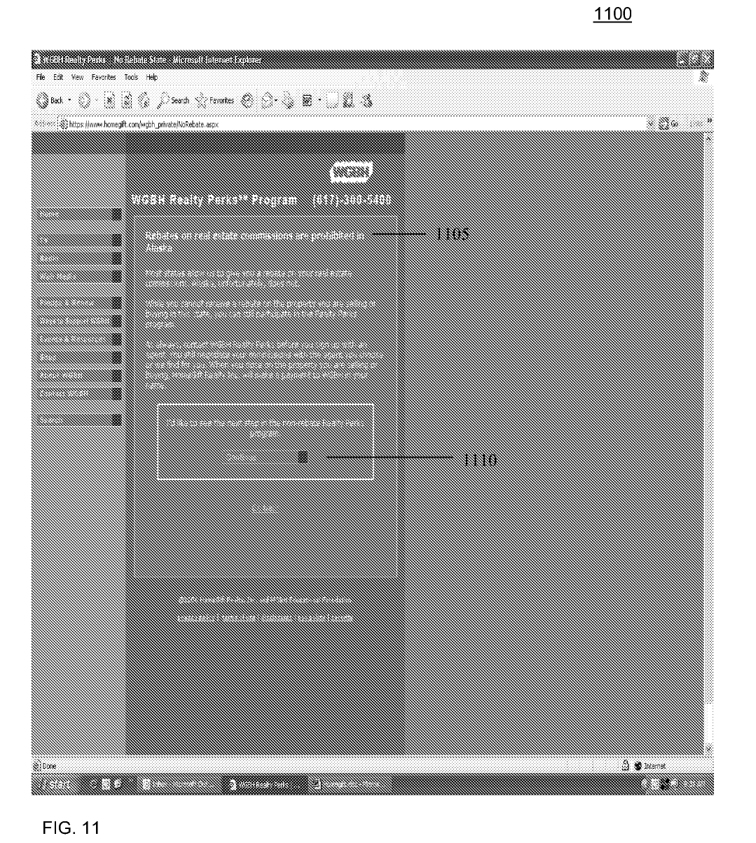

If a user clicks the “get started” button 830 depicted in FIG. 8A, he/she is sent a Web page for home buyers and sellers associated with a second entity (e.g., the service provider, such as HomeGift). FIG. 10 depicts a representative Web page 1000 for home buyers and sellers where the home buyer intends to purchase property in a non-rebate state. The exemplary Web page 1000 of FIG. 10 includes a logo 1005 associated with a first entity (e.g., the NPO to which at least a portion of the rebate will be given), a second hyperlink 1010 related to a Web page associated with a first entity, a region 1015 that can include welcome and introductory information regarding the HomeGift program, a drop-down menu 1020 that enables a user to select a state in which he/she is buying and/or selling property, radio buttons 1025 that enable a user to specify whether he/she is thinking about buying property, selling property, or both, radio buttons 1030 that enable a user to specify the timing of his/her intended purchase and/or sale of property, radio buttons 1035 that enable a user to specify whether he/she has an agent in mind or would like help finding a real estate agent, radio buttons 1040 that enable a user to specify whether he/she has already signed a contract with a real estate agent, and a “continue” button 1050 that enables a user to advance to another Web page. The example of FIG. 10 shows that a home buyer has indicated that he/she intends to purchase a home in Alaska in the immediate timeframe, wants help finding a real estate agent, and has not yet signed with a real estate agent. When the home buyer in this example clicks the “continue” button 1050, he/she is sent a Web page 1100, illustrated in FIG. 11, that indicates that consumer rebates on real estate commissions are prohibited in non-rebate states, e.g., Alaska 1105.

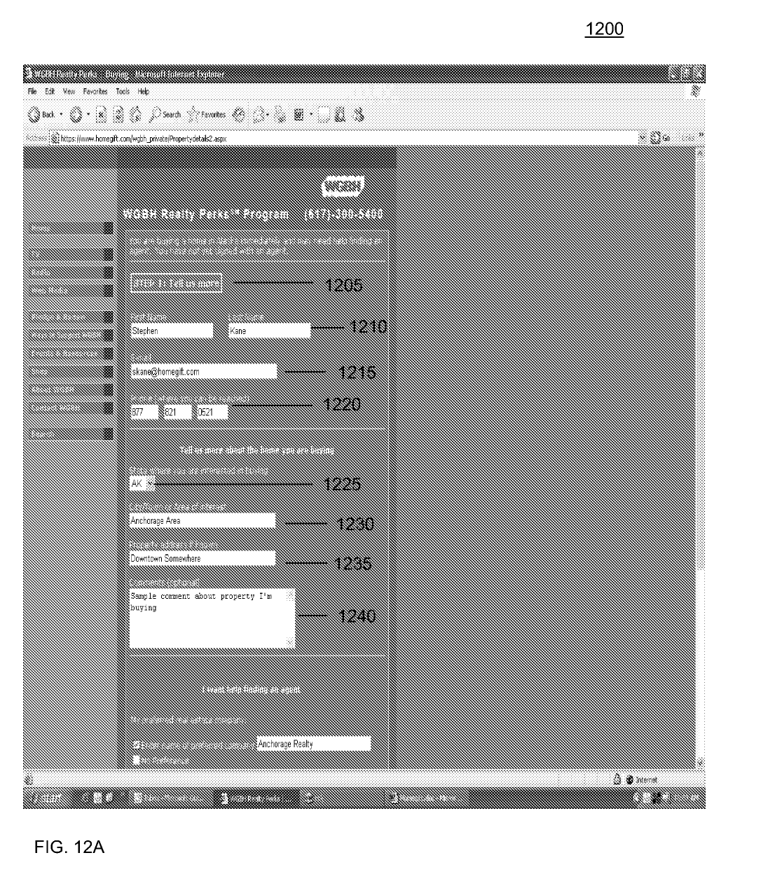

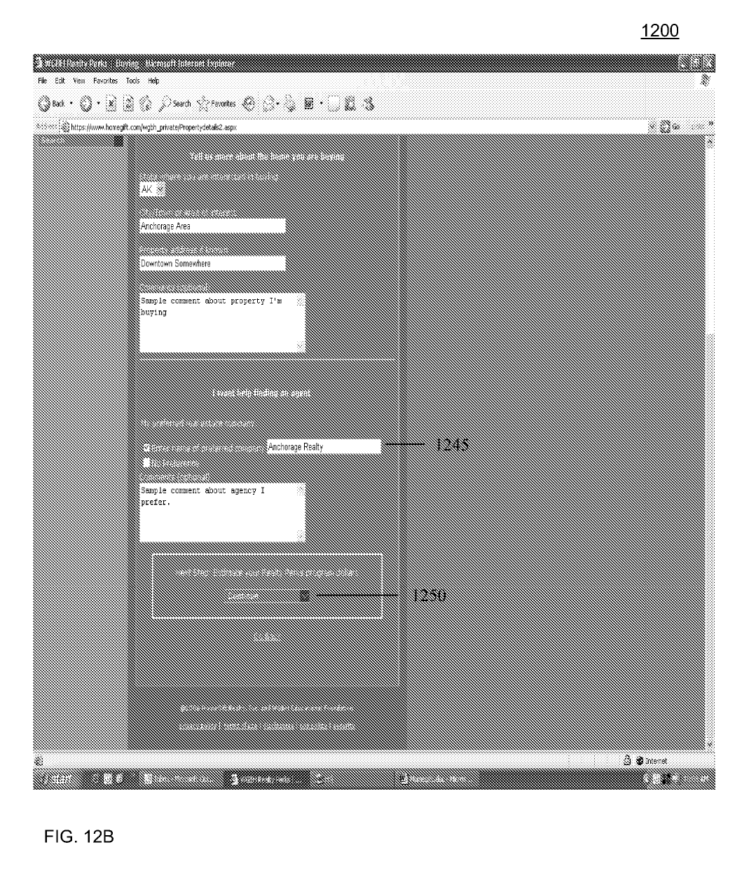

When the home buyer in this example clicks the “continue” button 1110, he/she is sent a Web page 1200, illustrated in FIGS. 12A and 12B, that depicts “Step 1: Tell us more” 1205. FIG. 12A illustrates the top portion of a Web page 1200 that facilitates data entry by a home buyer. FIG. 12B illustrates the bottom portion of a Web page 1200 in which a home buyer may estimate his/her rebate dollars by clicking a “continue” button 1250. As shown in the exemplary Web page 1200 of FIG. 12A, a home buyer may enter, for example, his/her first name and last name via text boxes 1210, an email address via a text box 1215, a telephone number via a text box 1220, the state where he/she is interested in buying property via a drop-down menu 1225, the city/town or area of interest to purchase property via a text box 1230, a property address (if known) via a text box 1235, and/or comments in a text box 1240, if any. As shown in the exemplary Web page 1200 of FIG. 12B, a home buyer may enter, for example, the name of the preferred real estate company in a text box 1245.

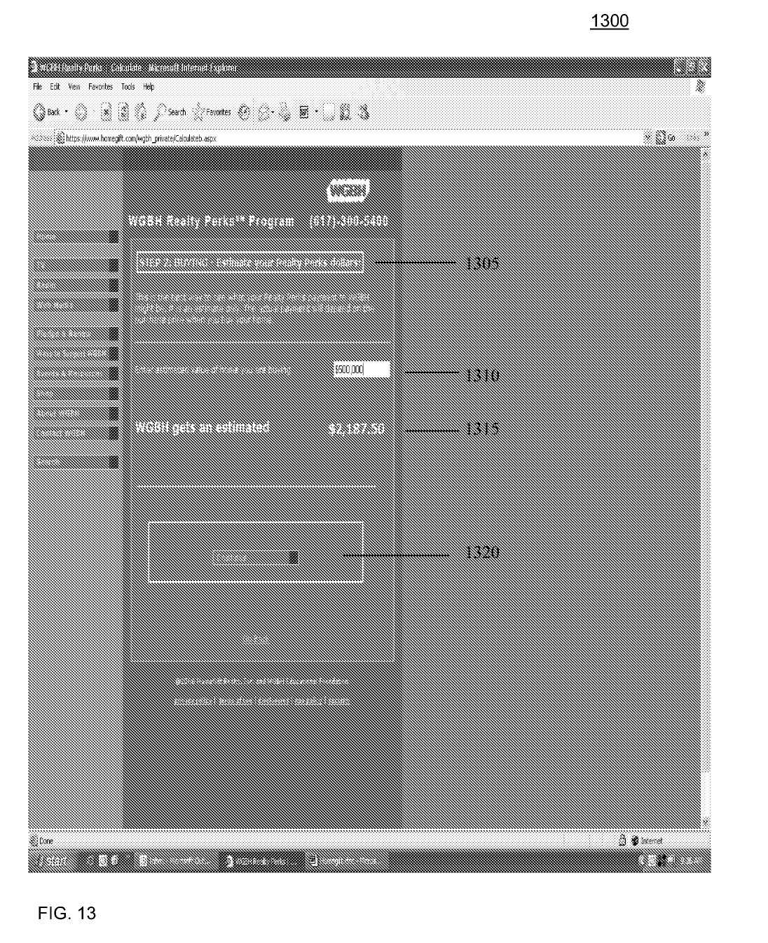

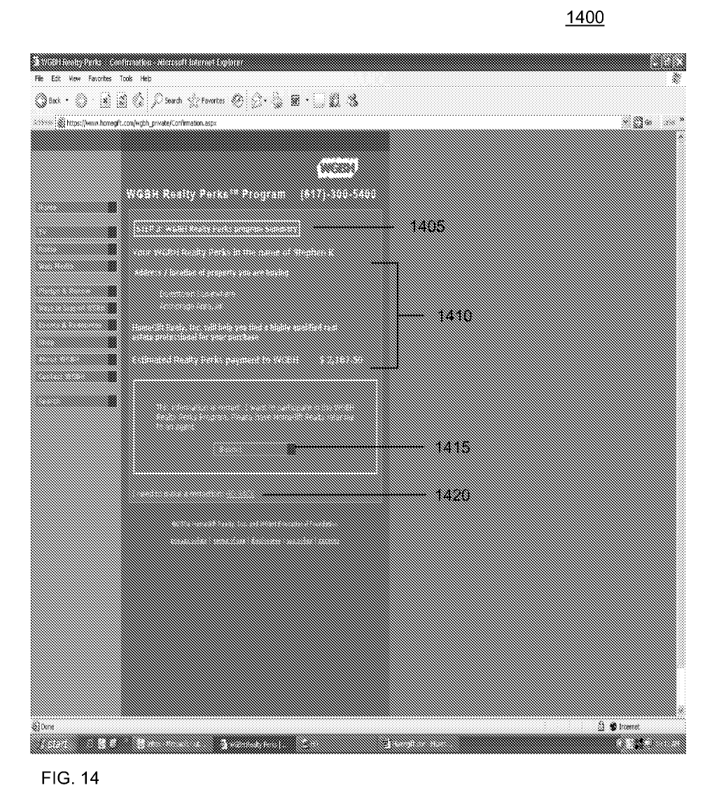

When the home buyer clicks the “continue” button 1250 illustrated in FIG. 12B, he/she is sent a Web page 1300, illustrated in FIG. 13, that depicts “Step 2: BUYING—Estimate your Realty Perks dollars” 1305. In this example, the home buyer is able to enter via a text box 1310 an estimated value of the home he/she intends to buy, and a rebate calculator 1315 automatically calculates the estimated royalty to be provided to the NPO. In this example, the calculator is implemented with executable code (e.g., an applet) that is part of the Web page, advantageously enabling calculations to be made instantaneously without having to access a server. When the home buyer in this example clicks the “continue” button 1320 he/she is sent a Web page 1400, illustrated in FIG. 14, that depicts “Step 3: WGBH Realty Perks program summary” 1405.

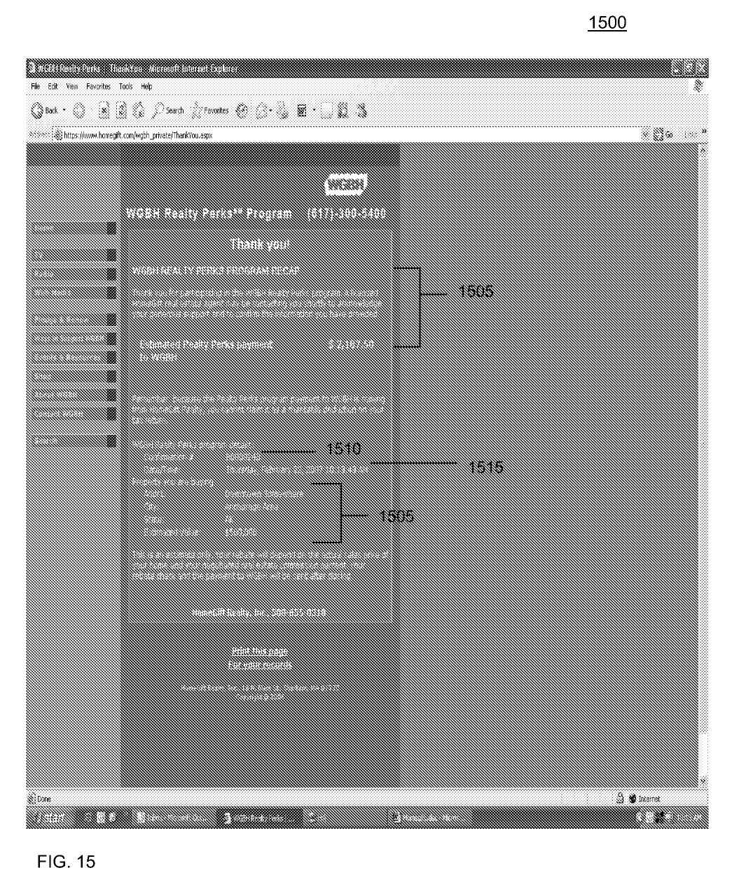

The exemplary Web page 1400 depicted in FIG. 14 provides a summary of the home buyer's intended purchase, including, for example, information input by the home buyer and the estimated donation to the NPO 1410. The exemplary Web page 1400 of FIG. 14 includes a facility for the home buyer to click a “submit” button 1415 to participate in the HomeGift program or a “go back” hyperlink 1420 enabling a user to make any corrections to his/her input data. Once the home buyer in this example clicks the “submit” button 1415, he/she is sent a thank you Web page 1500, depicted in FIG. 15.

The exemplary Web page 1500 of FIG. 15 provides a recap of the home buyer's intended purchase including, for example, a recap of input data, an estimated NPO donation and an indication area 1505 indicating that a licensed HomeGift real estate agent may be contacting the home buyer shortly, an area 1510 indicating a confirmation number associated with the transaction, and an area 1515 indicating a date and time associated with the transaction.

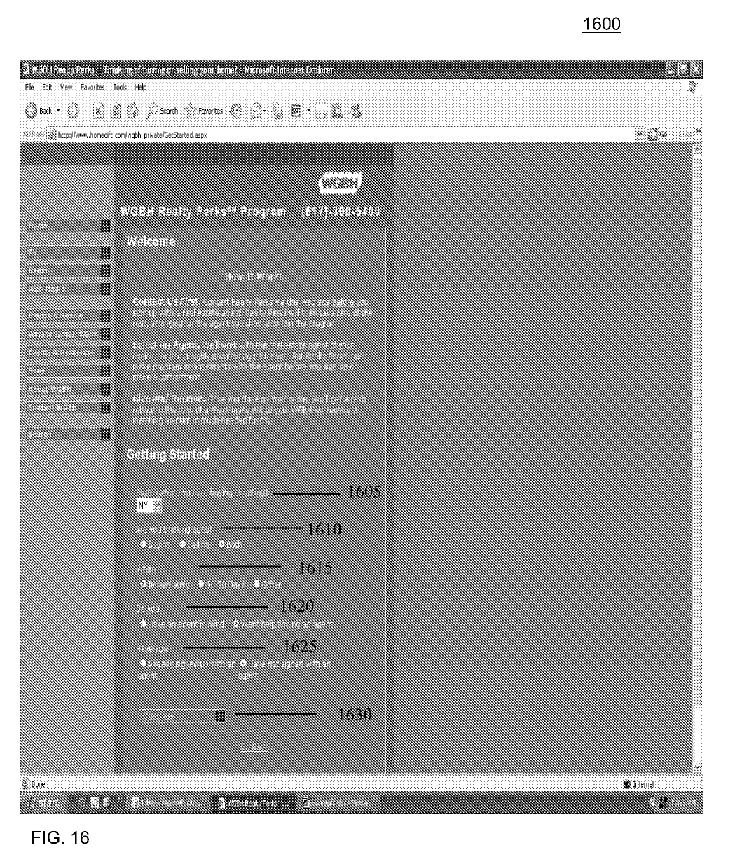

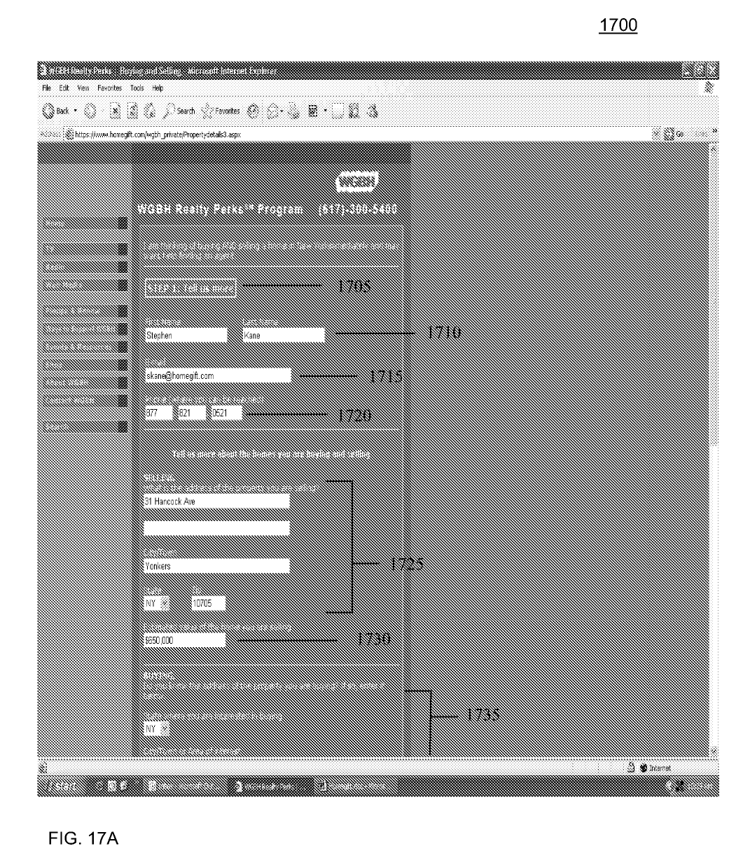

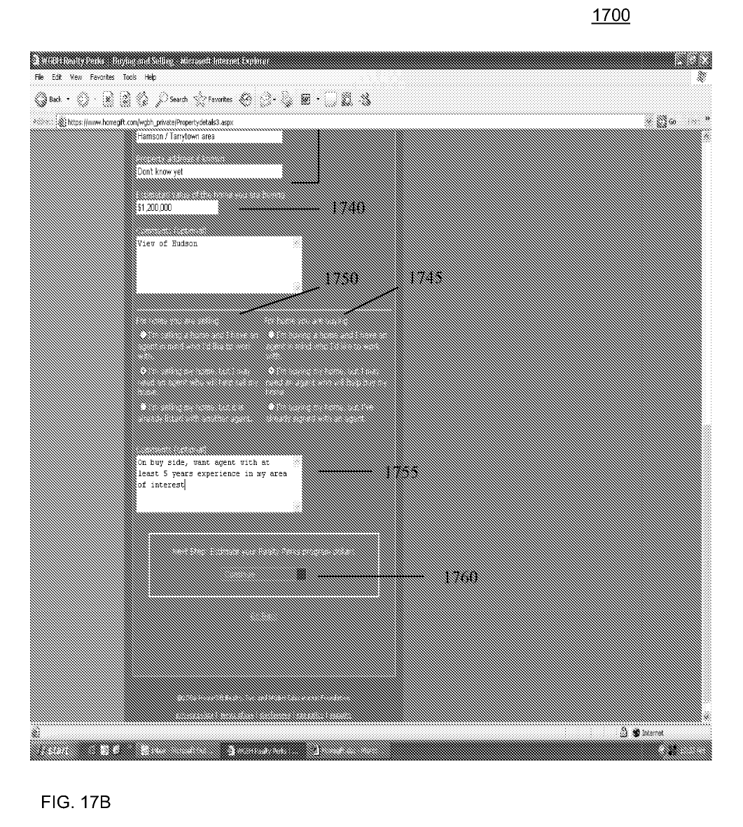

FIG. 16 depicts a representative Web page 1600, associated with a second entity, for home buyers and sellers where the consumer intends to both purchase and sell property. The exemplary Web page 1600 includes a drop-down menu 1605 that enables a user to specify the state in which he/she intends to purchase and/or sell property, radio buttons 1610 that enable a user to specify whether he/she is thinking about buying property, selling property, or both, radio buttons 1615 that enable a user to specify the timing of his/her intended purchase and/or sale of property, radio buttons 1620 that enable a user to specify whether he/she has an agent in mind or would like help finding a real estate agent, radio buttons 1625 that enable a user to specify whether he/she has already signed a contract with a real estate agent, and a “continue” button 1630 that enables a user to advance to another Web page. The example of FIG. 16 shows that a consumer has indicated that he/she intends to purchase and sell a home in New York in the immediate timeframe, wants help finding a real estate agent, and has not yet signed with an agent. When the home buyer/seller in this example clicks the “continue” button 1635 he/she is sent a Web page 1700, illustrated in FIGS. 17A and 17B, that depicts “Step 1: Tell us more” 1705. FIG. 17A illustrates the exemplary Web page 1700, associated with a second entity, for home buyers and sellers depicting Web forms associated with the purchase and sale of property in a rebate state. FIG. 17A illustrates the top portion of a Web page 1700 that facilitates data entry by a home buyer/seller. FIG. 17B illustrates the bottom portion of a Web page 1700 that facilitates data entry by a home buyer/seller.

The exemplary Web page 1700 of FIG. 17A includes text boxes that enable a user to enter his/her first and last name 1710, a text box that enables a user to enter his/her email address 1715, text boxes that enable a user to enter his/her telephone number 1720, text boxes and a drop-down menu that enable a user to enter information about the home he/she is selling 1725, a text box that enables a user to enter the estimated value of the home he/she is selling 1730, and text boxes and drop-down menus that enable a user to enter information about the home he/she is buying 1735. In some embodiments, where a consumer is only purchasing a home, the consumer is sent a Web page that contains text boxes and drop-down menus that enable the collection of data associated with the purchase of a home 1735. In some embodiments, where a consumer is only selling a home, the consumer is sent a Web page that contains text boxes and drop-down menus that enable the collection of data associated with the sale of a home 1725 and 1730. The exemplary Web page 1700 of FIG. 17B includes a text box that enables a user to enter the estimated value of the home he/she is purchasing 1740, radio buttons that enable a user to specify whether he/she has an agent in mind or has contracted with an agent for the home he/she is selling 1750, radio buttons that enable a user to specify whether he/she has an agent in mind or has contracted with an agent for the home he/she is buying 1745, a text box 1755 that enables a user to specify comments, if any, and a “continue” button 1760 that enables a user to advance to another Web page. The example of FIGS. 17A-17B shows that a consumer has indicated that he/she intends to purchase and sell a home in New York in the immediate timeframe, wants help finding a real estate agent, and has not yet signed with an agent.

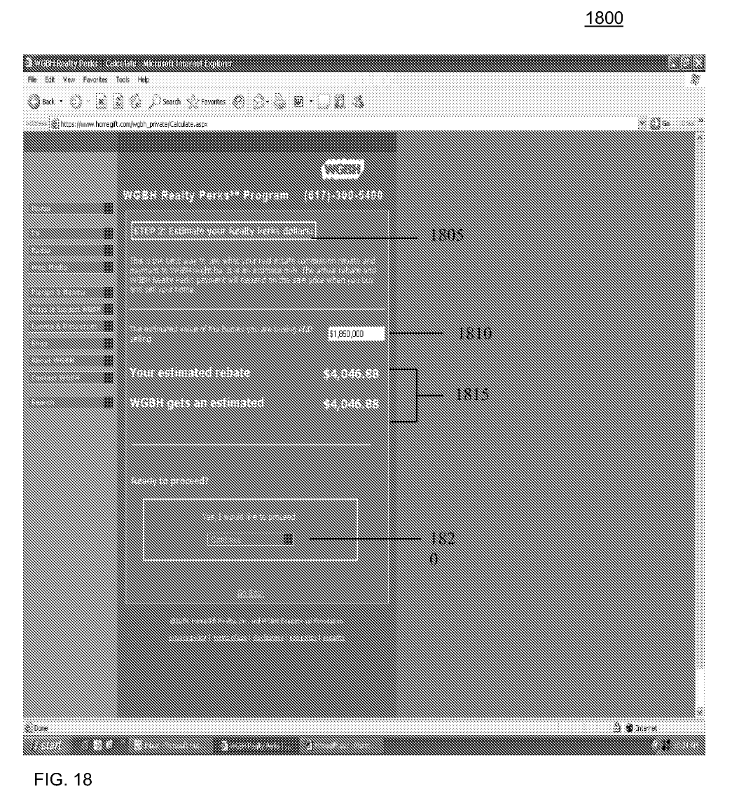

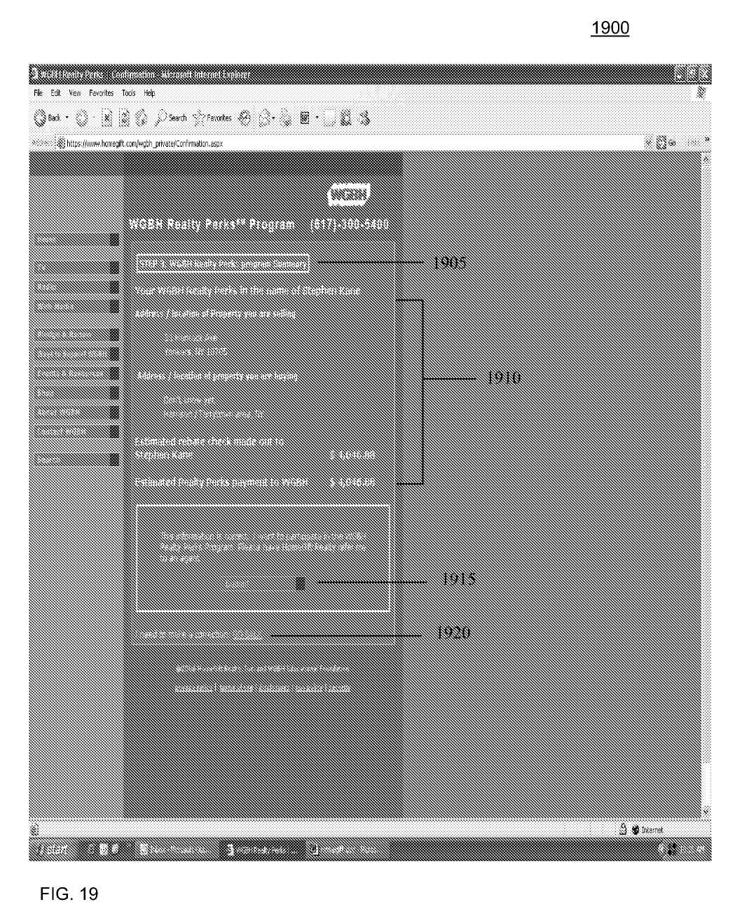

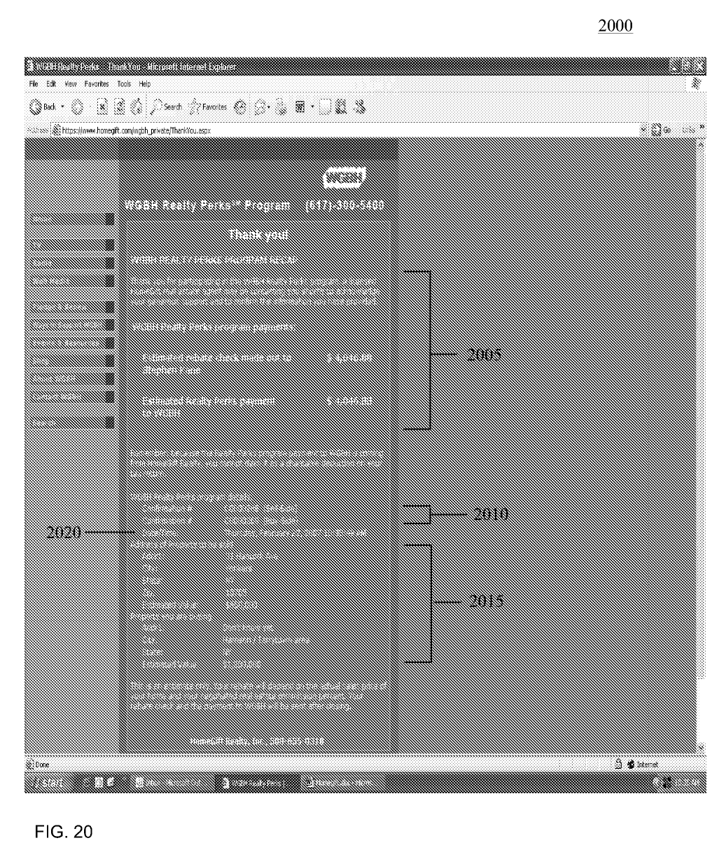

The home buyer/seller in this example, may move to the step of estimating his/her rebate dollars by clicking the “continue” button 1760 depicted in FIG. 17B The home buyer/seller in this example, is sent a Web page 1800 that depicts “Step 2: Estimate your Realty Perks dollars” 1805 as illustrated in FIG. 18. The exemplary Web page 1800 includes a text box that enables a user to specify the estimated value of the home he/she is buying and selling 1810. A rebate calculator calculates an estimated consumer rebate and an estimated NPO royalty 1815 based on the estimated home value specified by the home buyer/seller. When the home buyer/seller in this example, clicks the “continue” button 1820, he/she is sent an exemplary Web page 1900 depicted in FIG. 19. FIG. 19 depicts a representative Web page 1900 for home buyers and sellers associated with a second entity depicting a summary of the consumer's intended purchase and sale. The exemplary Web page 1900 depicts “Step 3: WGBH Realty Perks program summary” 1905, and provides a region 1910 that includes a summary of the information input by the home buyer/seller, an estimated donation to the NPO, and an estimated rebate to the home buyer/seller, and a facility for the home buyer/seller to click the “submit” button 1915 to participate in the HomeGift program or a “go back” hyperlink 1920 to make any corrections to his/her input data. Once the home buyer/seller in this example clicks a “submit” button 1915, he/she will view a thank you Web page 2000 depicted in FIG. 20. The exemplary Web page 2000 of FIG. 20 depicts a representative Web page for home buyers and sellers associated with a second entity depicting a recap of the consumer's intended purchase and sale. The exemplary Web page 2000 provides a region 2015 that includes a recap of the input data, an area 2005 that includes an estimated NPO donation, an estimated consumer rebate, and that provides an indication that a licensed HomeGift real estate agent may be contacting the home buyer/seller shortly, an area 2010 that includes confirmation numbers associated with the buy-side and sell-side transactions of this example, and an area 2020 that includes a date and time associated with these transactions.

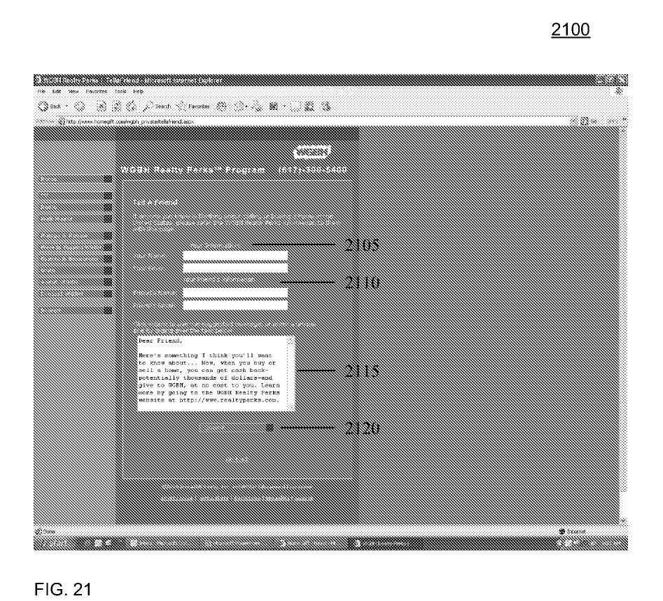

When a user clicks the “tell a friend” button 855 of FIG. 8b, he/she will view a Web page associated with HomeGift's “tell a friend” functionality. FIG. 21 depicts a representative Web page 2100 for home buyers and sellers associated with a second entity depicting HomeGift's tell-a-friend functionality. In some embodiments, the HomeGift system includes the “tell a friend” functionality that enables participants to tell a friend about the HomeGift program. The participant may use a form on a Web page 2100 to enter via text boxes, his/her name and email address 2105, and his/her friend's name and email address 2110. When the participant clicks a “submit” button 2120, this triggers an automatic email to be sent to the participant and his/her friend(s).

In some embodiments, the HomeGift system includes “remind me” functionality. If a participant is not selling or buying a home, but would like to work with HomeGift in the future, the participant can select a “remind me” function that can remind him/her in six months and/or one year about HomeGift via email or a telephone call from HomeGift.

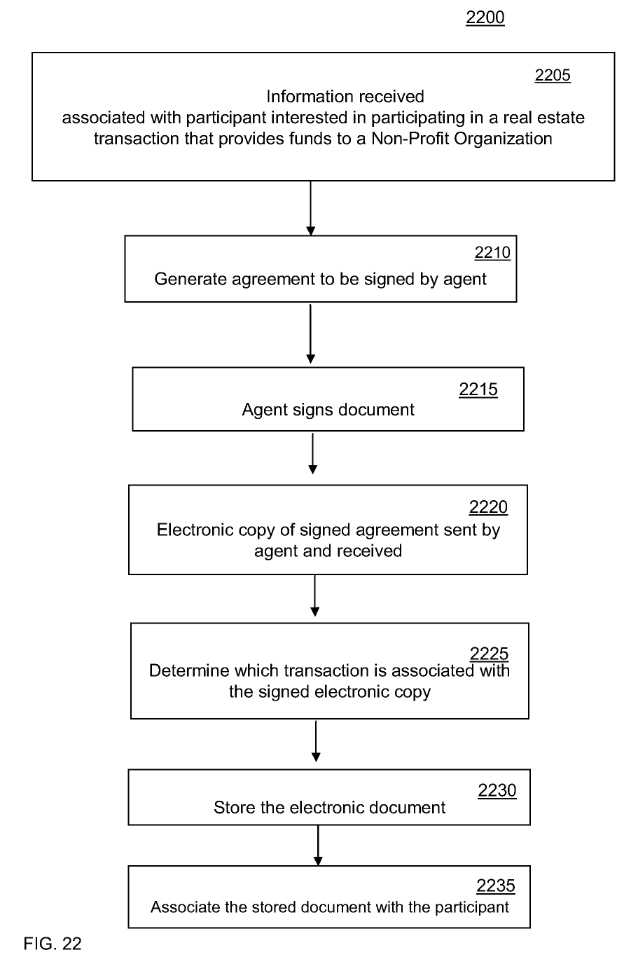

FIG. 22 is a representative flow chart 2200 illustrating the process associated with electronic document generation and storage. The process can include, for example, receiving information associated with a participant interested in participating in a real estate transaction in which funds can be provided to a non-profit organization (2205). An agreement is automatically generated to be signed by a real estate agent associated with the transaction (2210). The real estate agent signs the automatically generated document (2215). An electronic document of the agreement signed by the agent is received by HomeGift (2220). The transaction with which the signed agreement is associated is automatically determined (2225). The received electronic document is stored (2230), and associated with the participant (2235).

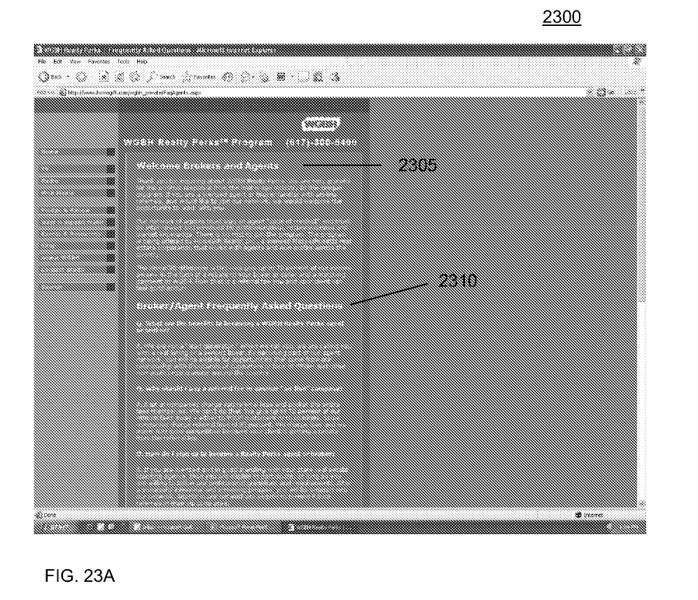

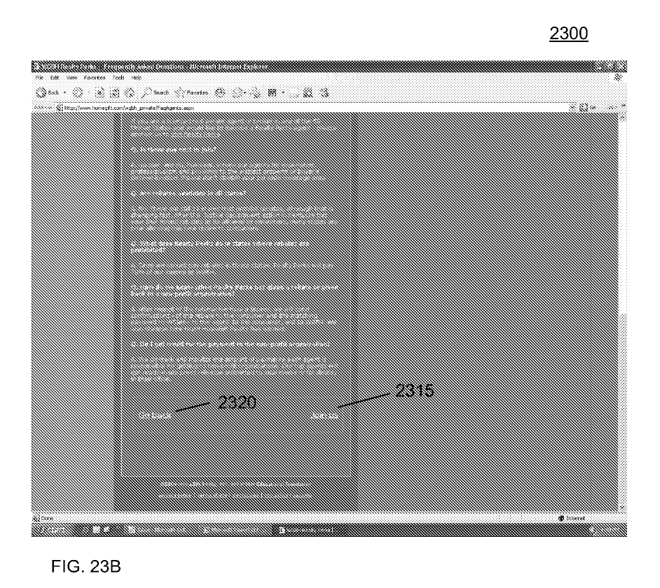

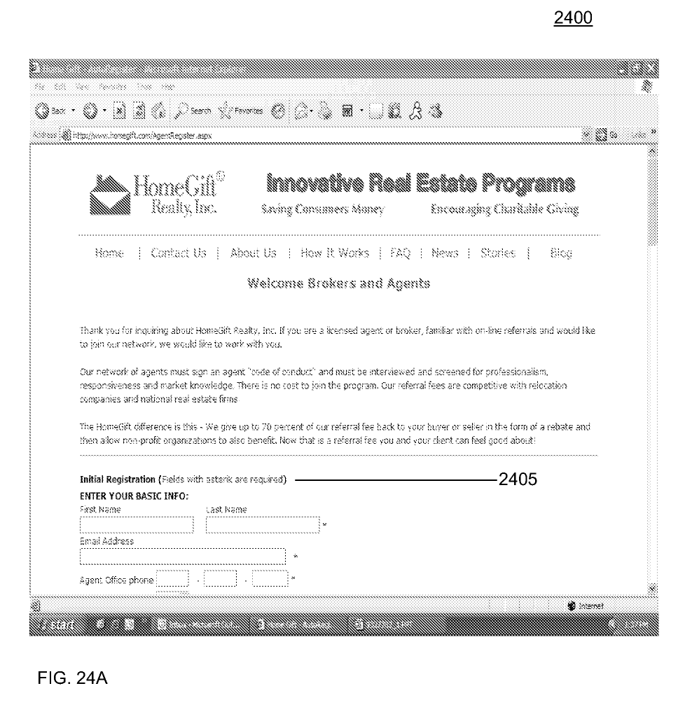

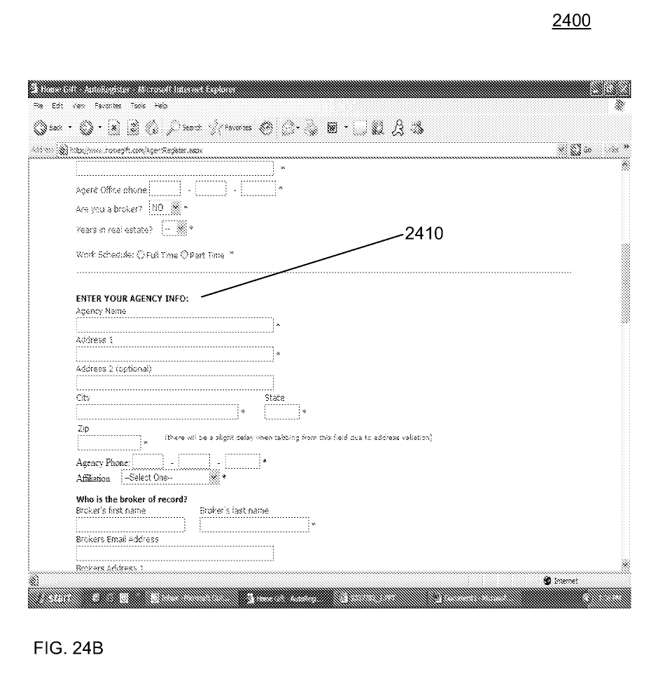

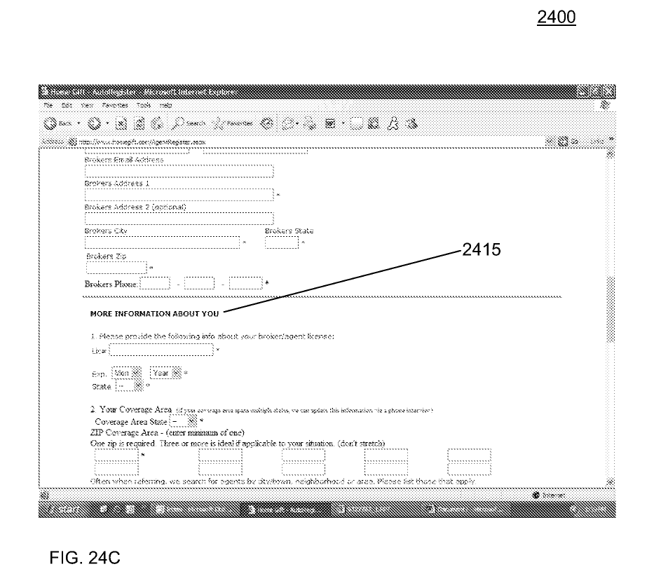

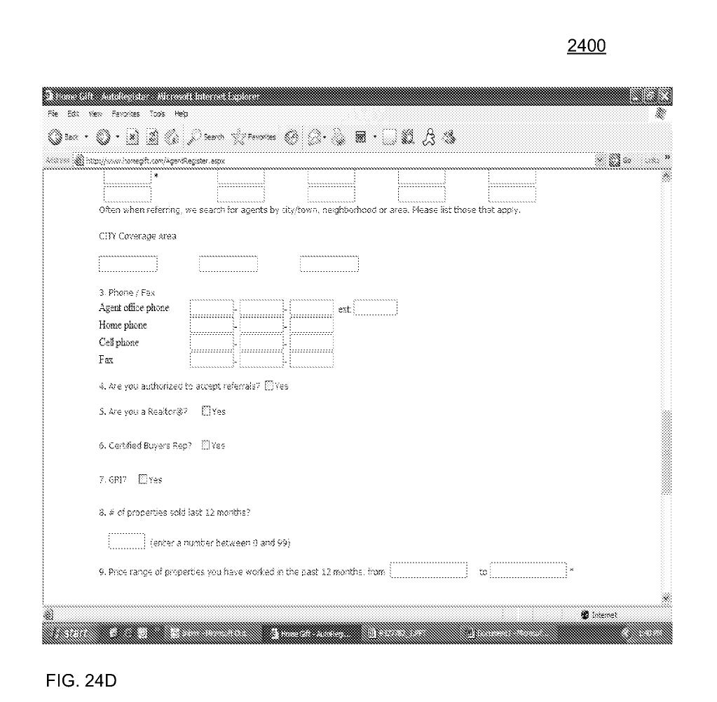

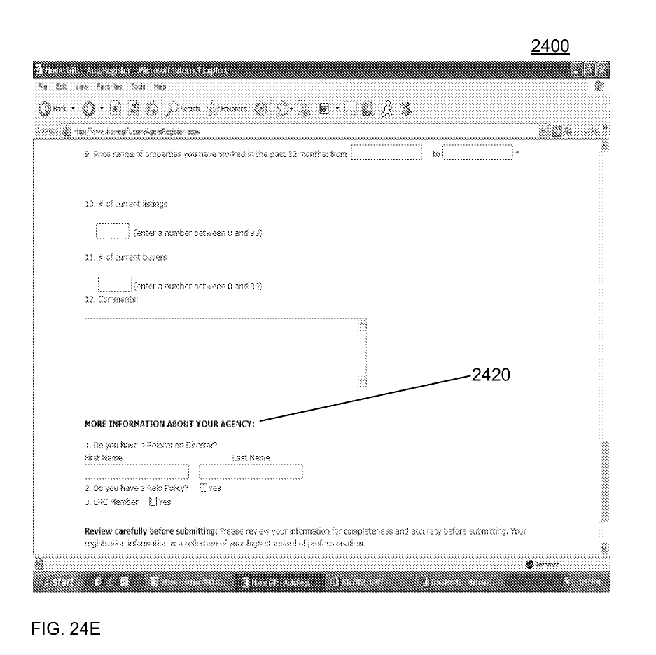

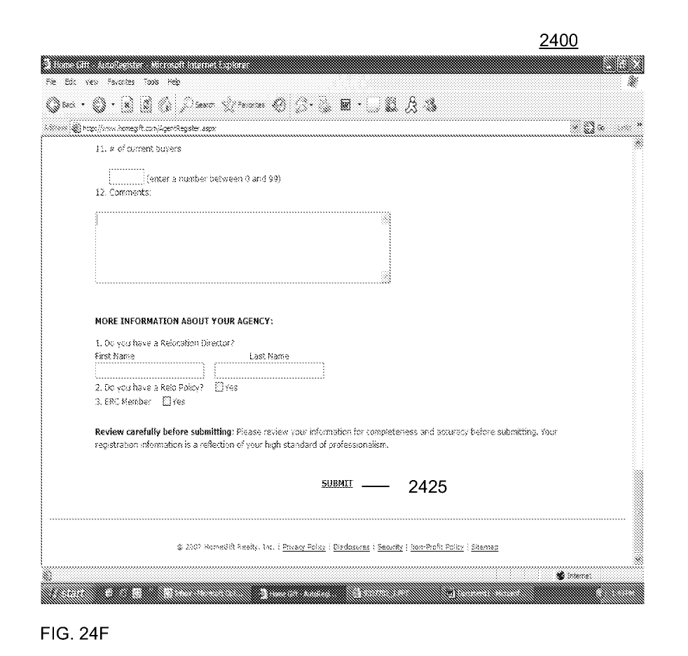

FIGS. 23A-23B depict representative introductory Web pages for real estate agents and brokers associated with a second entity. FIGS. 23A and 23B depict an exemplary welcome Web page 2300 for real estate brokers and agents. FIG. 23A represents the top portion of an exemplary welcome Web page 2300. FIG. 23B represents the bottom portion of an exemplary welcome Web page 2300. The exemplary welcome Web page 2300 shown in FIG. 23A includes a brief overview of the HomeGift referral program 2305, and broker/agent frequently asked questions 2310. The exemplary Web page 2300 of FIG. 23B includes a facility for the agent and/or broker to either “go back” 2320 to a prior Web page or click a “join us” button 2315. Once the broker and/or agent clicks the “join us” button 2315, he/she will view a Web page 2400 that enables him/her to register with the HomeGift referral program, depicted in FIGS. 24A-24F.

FIGS. 24A-24F depict representative HomeGift sign-up Web pages for real estate agents and brokers associated with a second entity. As shown on exemplary Web page 2400 of FIG. 24A, the broker and/or agent can enter initial registration information 2405 to begin the process of registering with HomeGift. Initial registration information area 2405 can include, for example, the broker and/or agent's first name, last name, email address, office telephone, whether he/she is a broker or not, the number of years that he/she has been involved in real estate, and whether he/she works full time or part time. As shown in FIGS. 24B and 24C, the broker and/or agent can enter agency information in area 2410 that can include, for example, the name of the real estate agency, the agency address, the agency telephone number, agency affiliation, the first and last name, email address, postal address, and telephone number of the broker of record.

As shown on exemplary Web page 2400 of FIG. 24C, the broker and/or agent can enter additional information about himself/herself in area 2415. FIGS. 24C-24E show exemplary additional agent information such as real estate license information, state, city, and/or zip code in which the broker and/or agent provides real estate services, facsimile information, whether the broker and/or agent is authorized to accept referrals, whether the broker and/or agent is a member of the National Association of Realtors®, whether he/she is a certified buyer's representative, whether the broker and/or agent is Graduate Realtor® Institute (GRI)-trained, the number and/or price range of properties that the broker and/or agent has sold in the last twelve months, the broker and/or agent's current number of listings, the agent's current number of buyers, and/or comments, if any. As shown in FIGS. 24E-24F, the broker and/or agent can enter additional information about his/her real estate agency 2420, including, for example, the first and last name of the relocation director, if any, whether the agency has a relocation policy, and/or whether the agency is a member of the ERC relocation services industry trade group. The exemplary Web page 2400 of FIG. 24F includes a “submit” button 2425 that the broker and/or agent can click to effectuate his/her registration with HomeGift.

Home buyers, home sellers, NPOs, real estate agents, brokers, and other visitors to the HomeGift website may navigate Web pages by clicking a “continue” button or hyperlink to advance their transactions and/or clicking a “go back” button or hyperlink to review and/or make any corrections to their input data. Examples of these navigation buttons or hyperlinks are illustrated in at least FIGS. 10, 11, 12B, 13, 14, 16, 17B, and 18.

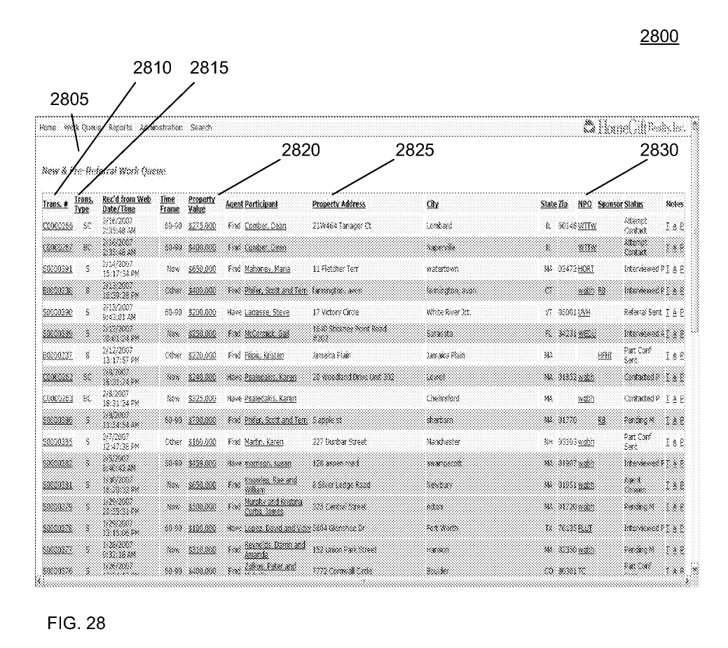

The HomeGift referral process system can include the capture of referral transaction data from forms submitted by non-profit supporters through the HomeGift website (see process step 1 of FIG. 2A) and/or inbound call center personnel who post this information to the HomeGift referral process system (see process steps 7-9 of FIG. 2C and FIG. 2D). Once the referral transaction data is in the HomeGift RPS system, the transaction data can be tracked in work queues for HomeGift staff to process to completion. For example, work queues similar to that shown in FIG. 28. Once an NPO has signed an agreement with HomeGift to receive a percentage of the referral fee from a real estate transaction, the NPO information is entered into the HomeGift system via a new NPO screen, e.g., via a graphical user interface (GUI). The new NPO screen can include, for example, information regarding the royalty and sharing models. For the sharing model, the rebate that is given to the participant can also be defined, e.g., Lowe's Gift Card, 401K donation, etc. After an NPO record has been created and activated, the NPO is ready to be selected as the donation location of choice for a participant.

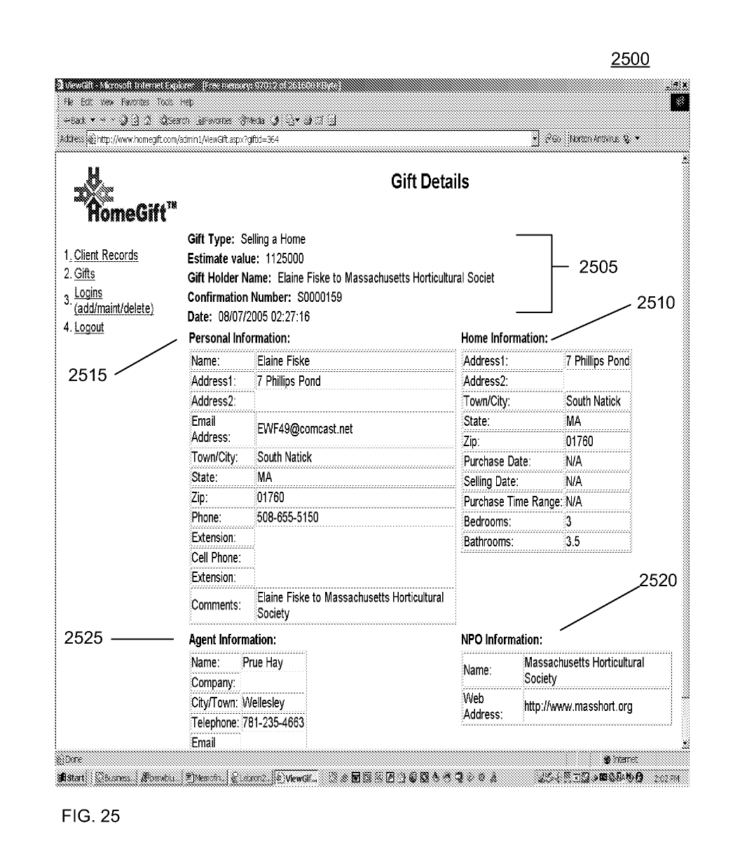

In some embodiments, the HomeGift technology relies on web-based order management systems that track referrals coming from NPOs. Orders that come in from these NPOs can be tracked via an administrative worksheet that allows HomeGift to contact a consumer and complete a real estate referral. FIG. 25 illustrates an exemplary administrative worksheet for tracking NPO orders. The order tracking worksheet 2500 includes, for example, basic gift information 2505, personal participant information 2515, information about the home purchased and/or sold 2510, real estate agent information 2525, and/or NPO information 2520. In some embodiments, documents associated with referrals can be automatically generated and faxed to real estate agents upon receipt by the HomeGift referral process system. Back-up copies of referral files can be maintained in hardcopy form.

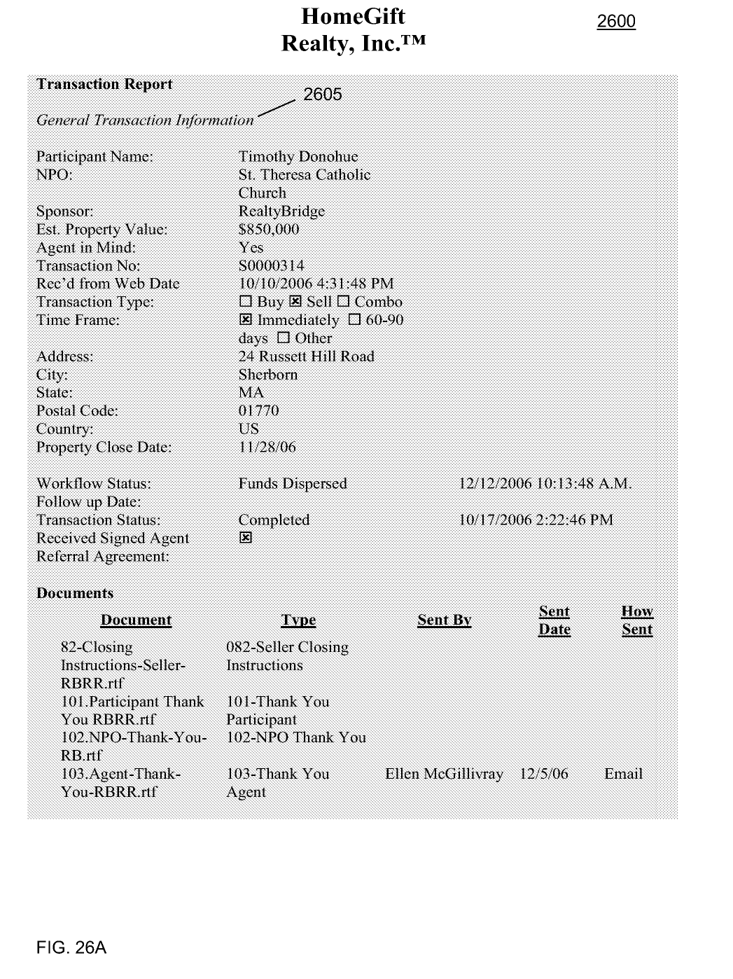

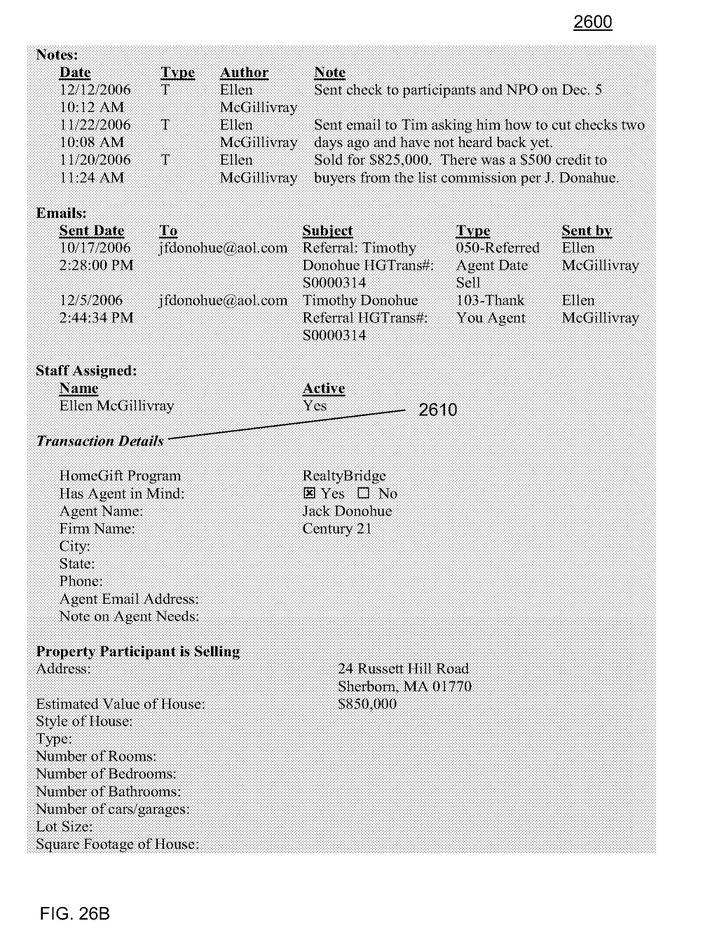

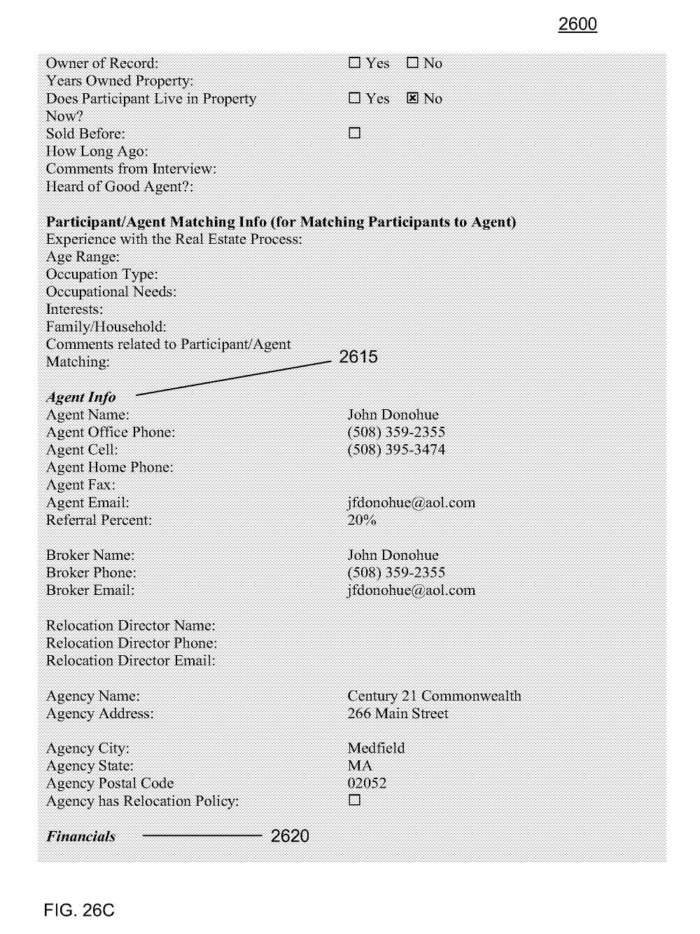

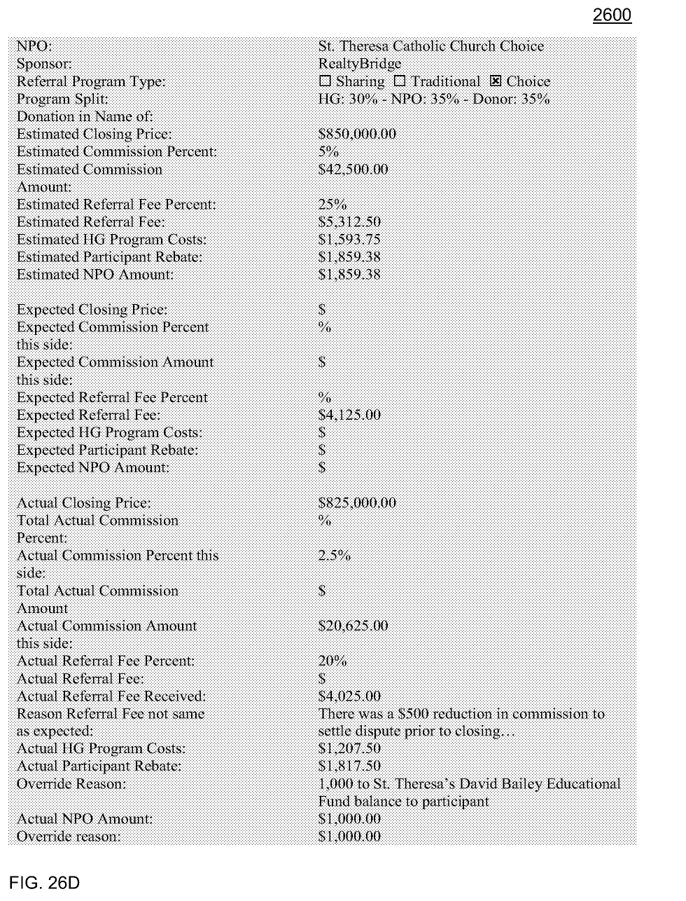

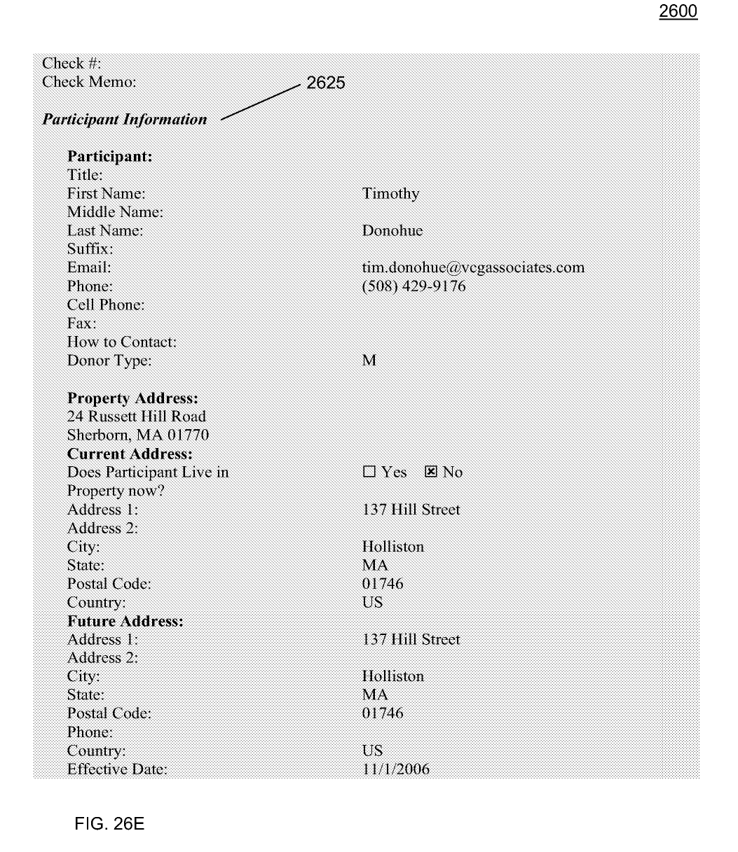

In some embodiments, the HomeGift system supports transaction maintenance, tracking, and reporting. FIGS. 26A-26E illustrate an exemplary automatically-generated transaction report. The exemplary HomeGift transaction report 2600 illustrated in FIGS. 26A-26E includes data such as general transaction information 2605 depicted in FIG. 26A, transaction details 2610 depicted in FIG. 26B, real estate agent information 2615 depicted in FIG. 26C, financial information pertaining to a specific real estate transaction 2620 depicted in FIGS. 26C-26E, and participant information 2625 depicted in FIG. 26E.

General transaction information 2605 depicted in FIG. 26A can include, for example, participant name, NPO name, estimated property value, transaction number, transaction type, e.g., buy, sell, both, and transaction status, and workflow status. Workflow statuses can include, for example, “Attempted Contact,” “Contacted Participant,” “Interviewed Participant,” “Contacted Agent,” “Interviewed Agent,” “Referral Doc Sent,” “Participant Confirm Sent,” “Pending Participant Interview of Multiple Agents,” “Pending Participant Interview of Agent,” “Agent Chosen,” “Buyer's Agency Agreement,” “Property Listed,” “Escrow,” “Property Closed,” “Receipt of Funds,” “Participant Survey Sent,” “Participant Survey Received,” “Disperse Funds,” and/or “Lost Transaction.” Exemplary transaction statuses can include: “New,” “Pre-Referral,” “Post-Referral,” “Complete,” “Lost,” and/or “Test.” Transaction statuses can be used internally by HomeGift staff and/or externally to provide status updates to NPOs and/or participants. Workflow statuses up through “Agent Chosen” are included in the new & pre-referral work queue. Once a transaction has reached “Buyer's Agency Agreement” or “Property Listed,” the transaction moves to the post-referral work queue. A transaction is not complete until funds have been dispersed to HomeGift, the NPO, and the consumer, if applicable.

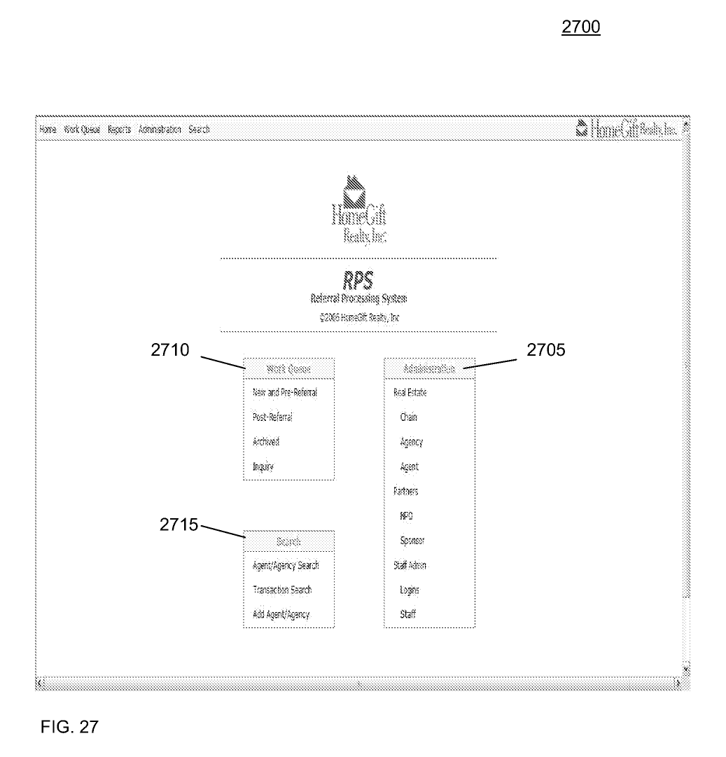

FIG. 27 illustrates an exemplary introductory Web page of the backend of the HomeGift referral process system. The exemplary introductory Web page 2700 of FIG. 27 enables a user to navigate to other HomeGift RPS Web pages via hypertext links. HomeGift RPS Web pages can be accessed through a Web browser by, for example, HomeGift staff, including at least RE Admins and HG Account Representatives. The exemplary Web page 2700 includes hypertext links to HomeGift work queues 2710 (e.g., new & pre-referral, post-referral, archived, and inquiry work queues), administrative screens 2705 (e.g., real estate, NPO, and staff administrative screens), and search functions 2715 (e.g., agent/agency search, transaction search, and add agent/agency functions).

In some embodiments, the HomeGift system can track real estate transactions on the buy-side and sell-side. These transactions can be tracked automatically or via direct contact from HomeGift with the participant and/or real estate agent (see process steps 3-4 of FIGS. 2B and 23-24 of FIG. 2F and FIG. 2G). Automatic tracking can be accomplished by, for example, electronic tracking and management of incoming referrals via a custom work queue system that prioritizes orders based on data supplied by the consumer. When a user of the HomeGift backend system clicks, for example, the new & pre-referral hypertext link from the work queue set of hypertext links 2710, he/she is sent a new & pre-referral work queue Web page depicted in FIG. 28. The new & pre-referral work queue 2805 Web page 2800 shown in FIG. 28 enables HomeGift staff to view and access new & pre-referral transactions. The work queues of the HomeGift system can be sorted by clicking on column headers, e.g., transaction number 2810, transaction type 2815, property value 2820, property address 2825, NPO 2830, etc. Work queues can include, for example: admin work queues supporting follow-up by HomeGift staff; Real Estate Admin work queues supporting the process of completing a referral agreement with a real estate agent; new & pre-referral work queues; my new & pre-referral work queues which include transactions assigned to a specific user where an initial participant interview has yet to be completed; post-referral work queues, my post-referral work queues which include all post-referral transactions assigned to a specific user; 501c validation work queues, NPO reports work queues; and/or expiring listing work queues.

In some embodiments, an archived work queue can be generated. The archived work queue can include, for example, information relating to transactions that have been completed. The data associated with completed transactions cannot be readily changed because such transaction data represents transactions that have already occurred. Archived data can be useful for preserving institutional knowledge.

In some embodiments, HomeGift database(s) can be configured to contain real estate agent and broker data. Agent and/or broker data can include, for example, real estate license numbers, status, professional designations, contact information, and an agent profile that ranks the agent's past performance. In some embodiments, HomeGift can store data on agents who have been screened, but not used. These agents may have a special code to designate this status (see process step 21 of FIGS. 2E and 75 of FIG. 2H).

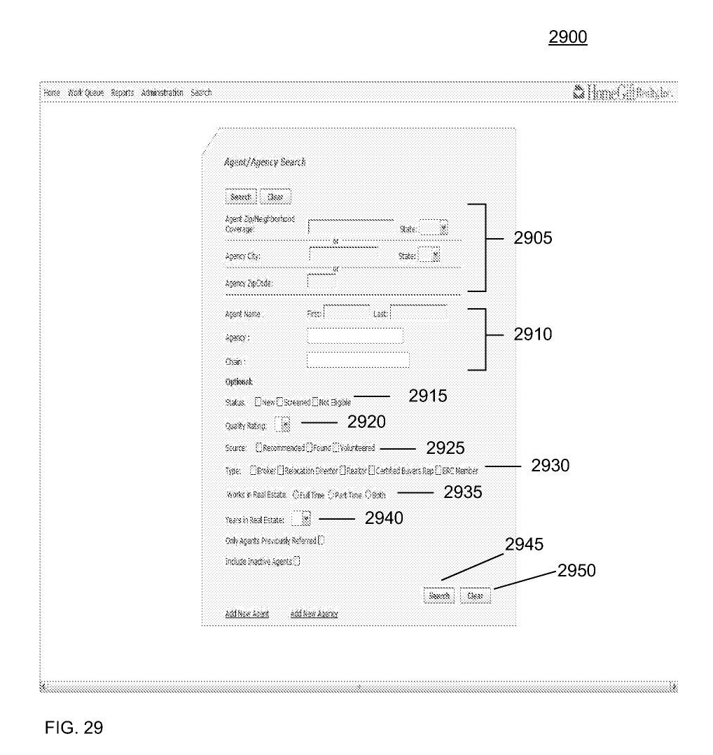

In some embodiments, the HomeGift technology includes search capabilities that allow a user to search for real estate agents and agencies, and/or HomeGift transactions based on, for example, transaction number, participant name, property address, agent name, and/or NPO name. FIG. 29 illustrates HomeGift's real estate agent/agency search functions. The exemplary agent/agency search Web page 2900 is accessible to HomeGift Account Representatives and RE Admins. The HomeGift technology supports searching for real estate agencies and real estate agents. In some embodiments, agents can be searched by specified criteria shown in FIG. 29. Agent/agency criteria searching is enabled by, for example, text boxes and drop-down menus for searching by agent zip code/neighborhood, agent state, agency city, agency state, agency zip code 2905, text boxes for searching by agent first and/or last name, agency name, and/or chain 2910, check boxes for searching by agent status 2915 (e.g., new, screened, not eligible), a drop-down menu for searching by agent quality rating 2920, check boxes for searching by agent source 2925 (e.g., recommended, found, volunteered), check boxes for searching by agent type 2930 (e.g., broker, relocation director, Realtor®, certified buyer's rep, ERC member), radio buttons for searching by agent employment status 2935 (e.g., full time, part time, or both), and/or a drop-down menu for searching by the number of years the agent has been involved in real estate 2940. The exemplary Web page 2900 includes a “search” button 2945 that enables a user to execute his/her agent/agency search, and a “clear” button 2950 that enables a user to clear the search criteria he/she has entered.

In some embodiments, the HomeGift system can include one or more administrative screens for entering and maintaining data depicted on exemplary Web page 2700 of FIG. 27. Exemplary screens of the HomeGift system can include the following: Add NPO, View/Update NPO, View/Update NPO Contact, Add Transaction, View/Update Transaction, View/Update Donor, Add Agent, View/Update Agent, Add Real Estate Agency, View/Update Real Estate Agency, Add Chain, View/Update Chain, Add Campaign, View/Update Campaign, View Archive, Agent Locator, Email text maintenance, Follow-up Survey, Staff Maintenance, Maintenance Screens, and Rapid Input Screens for volume input of data.

The Add NPO screen can be used to enter new NPO into the HG NPO database. The View/Update NPO screen can be used to view and/or update NPO information in the HG NPO database. The View/Update NPO Contact screen can be used to view and/or update NPO Contact information. The Add Transaction screen can be used to initiate a transaction for a participant that has called HomeGift and will not be submitting information through a website form on a HomeGift website. The Add Transaction screen can include, for example sections for participant contact information, participant property information (if sell or combination transaction), and/or participant purchase information (if buy or combination transaction). The Web & Interview screen can be used to interview a participant that has entered information via a HomeGift website and to update a Transaction screen. The View/Update Transaction screen can include sections for participant contact information (Participant Tab), participant property information (if sell or combination transaction), General & Detailed Transaction Tabs, participant purchase information (if buy or combination transaction), General & Detailed Transaction Tabs, Financials Tab to show the calculations of the transaction, and/or Agent Tab to show the referred or assigned agent to the transaction. The View/Update Donor screen can be used to view and/or update participant contact information. The View/Update Agent screen can be used to view and/or update agent information in the HG Agent database. The Add Real Estate Agency screen can be used to add a new real estate agency to the HG Agent database. The View/Update Real Estate Agency screen can be used to view and/or update real estate agency information in the HG Agent database. The Add Chain screen can be used to add a new real estate chain to the HG Agent database. The View/Update Chain screen can be used to view and/or update real estate chain information in the HG Agent database. The Add Campaign screen can be used to add a new campaign into the HomeGift system for an NPO. The View/Update Campaign screen can be used to view and/or update a campaign for an NPO. The View Archive screen can be used to view data that has been archived. Archival data can include, for example, NPO, transaction, agent and/or participant data. The Agent Locator screen can be used to search the HomeGift Agent database.

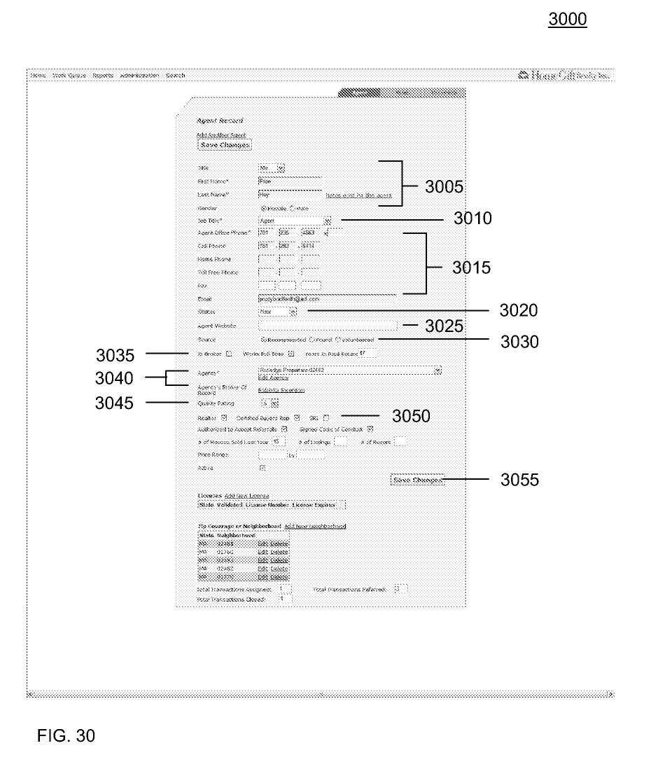

In some embodiments, the HomeGift system maintains agent profile data. An Add Agent screen can be used to add a new agent and/or broker to and/or maintain agent profile data in a HomeGift Agent database. FIG. 30 illustrates HomeGift's RPS Add Agent record Web page 3000. The exemplary Add Agent record Web page 3000 includes text boxes and drop-down menus that enable the addition and/or maintenance of an agent and/or broker's title and his/her first and last name 3005, a drop-down menu that enables the addition and/or maintenance of the agent's job title 3010, text boxes that enable the addition and/or maintenance of an agent's office, cell, and home telephone and fax numbers and email address 3015, a drop-down menu that enables the addition and/or maintenance of an agent's status 3020, a text box enables the addition and/or maintenance of an agent's website 3025, and radio buttons that allow for the addition and/or maintenance of agent source information 3030. As illustrated in FIG. 30, the exemplary RPS Add Agent record Web page 3000 includes check boxes and drop-down menus that enable indication of whether the agent is a licensed broker, whether the agent works full or part time, and the number of years that the agent has been involved in real estate 3035, drop-down menus and text boxes that enable the addition and/or maintenance of the agent's agency and the agency's broker of record 3040, a drop-down menu that enables the addition and/or maintenance of the agent's quality rating 3045, and check boxes that enable indication of whether the agent is a member of the National Association of Realtors®, whether he/she is a certified buyer's representative, and/or whether the broker and/or agent is Graduate Realtor® Institute (GRI)-trained 3050, etc. The exemplary RPS Add Agent record Web page 3000 of FIG. 30 includes a “save changes” button 3055 that enables a user to save the changes that he/she has made to a real estate agent's record.

Real estate agents associated with the HomeGift program can include, for example, recommended agents and located agents. Recommended agents include those suggested by a home buyer and/or home seller that meet minimum requirements, e.g., licensed, proximate to property or location. Since the home buyer and/or home seller already knows the recommended agent, the need for HomeGift's screening of the agent for professionalism, proximity, training, etc. can be reduced. Located real estate agents are those located, screened, and interviewed by HomeGift when the home buyer and/or home seller does not have a real estate agent in mind. The home buyer and/or home seller has the opportunity to select which agent he/she prefers. Once the real estate agent is selected, the agent is added to the HomeGift system and tracked for performance.

Some embodiments of the HomeGift technology include the ability to upload a spreadsheet with multiple agents/agencies to, for example, save time and ensure greater accuracy in the Agent data. The Donor Interview screen can provide a tool for HomeGift to create and modify scripts to be used as interview questions for HG Account Reps and/or RE Admin users when speaking with a participant. The Email Text Maintenance screen can provide a tool for HomeGift to maintain auto-generated emails that can be sent from the HomeGift system. The Follow-up Survey screen can provide a survey that can be used to email or call the participant after a gift is completed. Staff Maintenance screens can include screens to add, view and update staff users of the HomeGift system. The Maintenance Screens can provide the ability to maintain backend tables within one or more HomeGift databases.

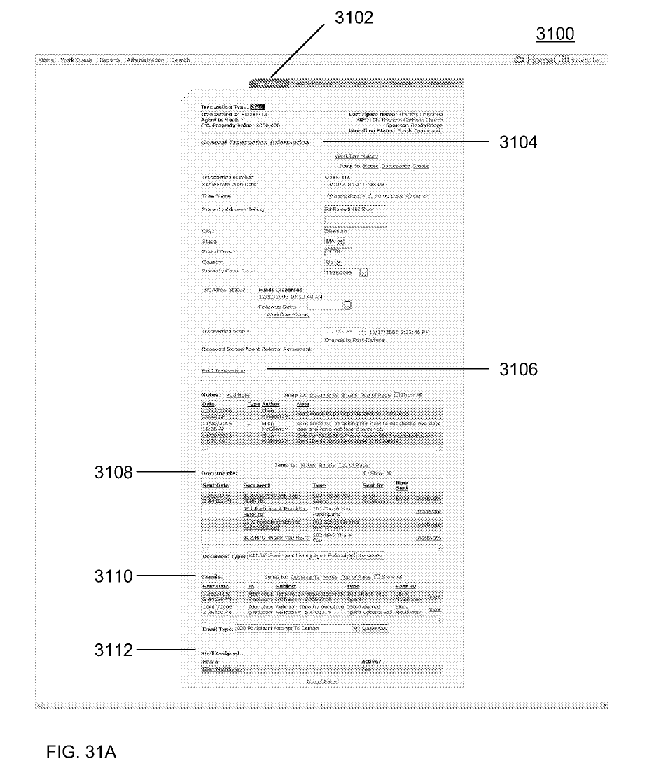

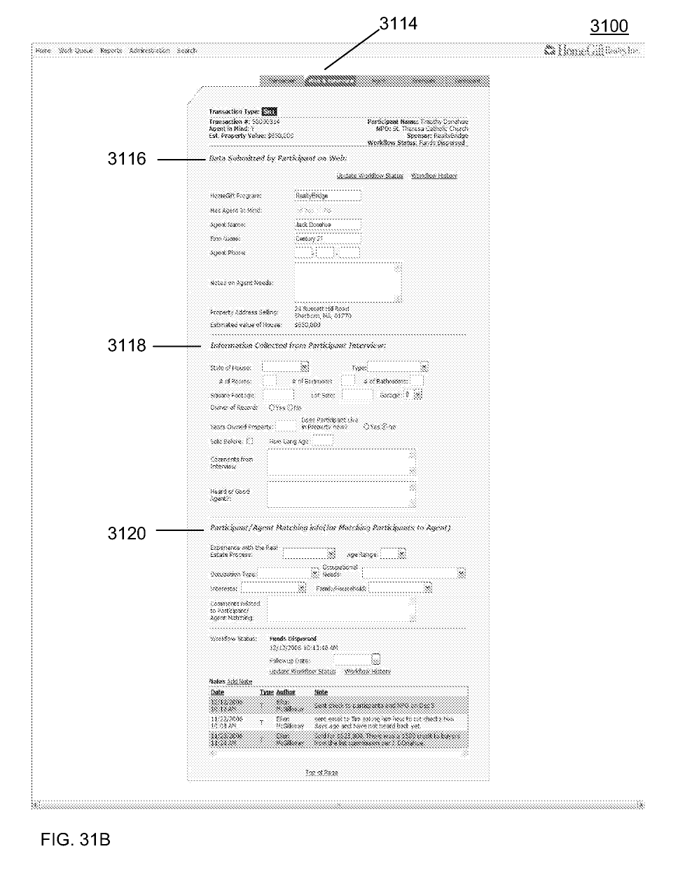

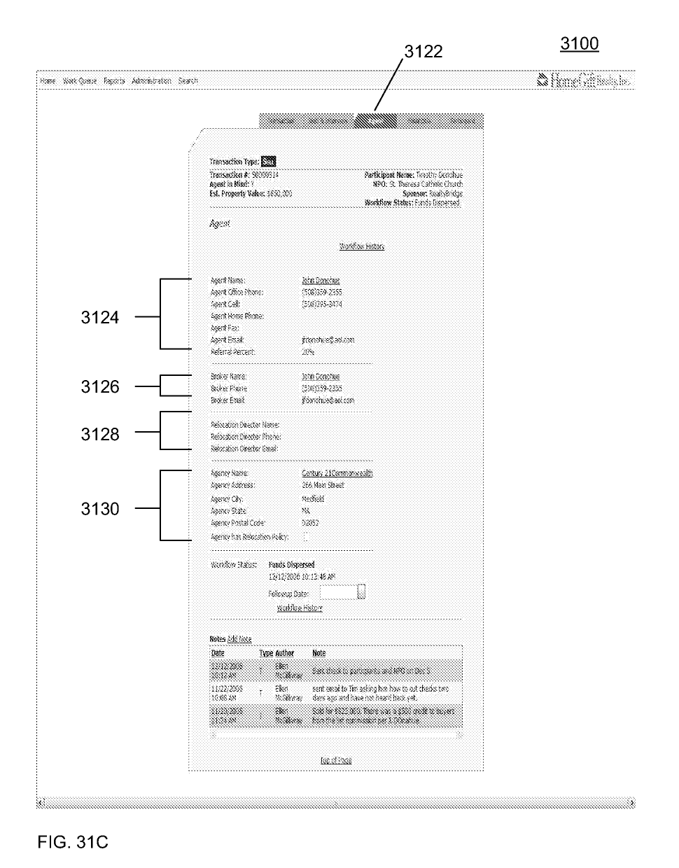

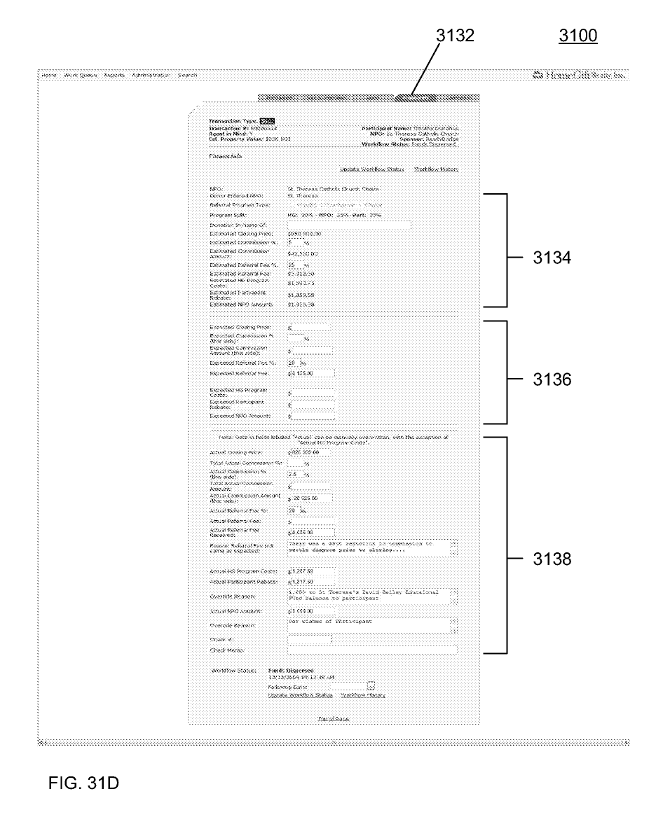

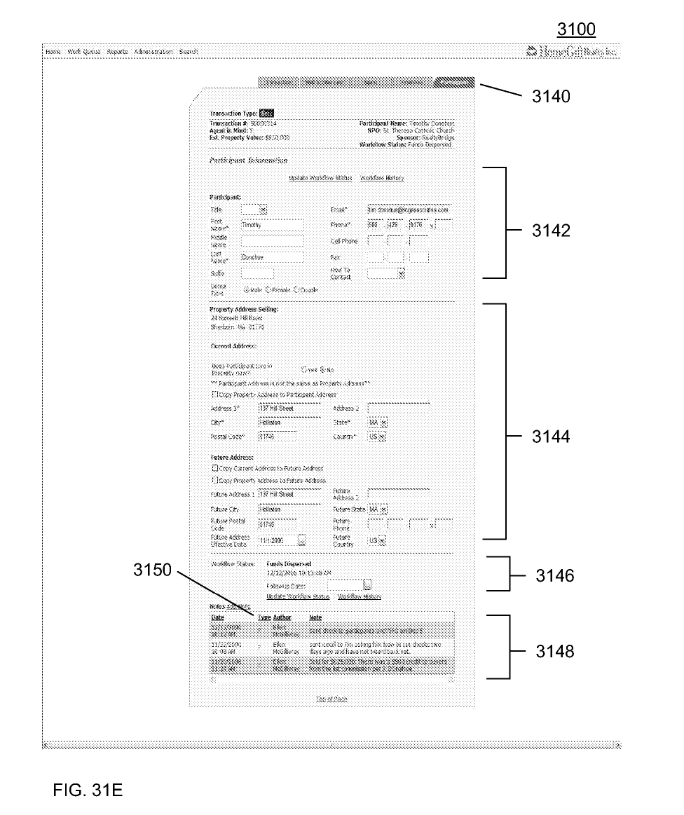

FIGS. 31A-31E illustrate exemplary Web pages depicting transaction, participant interview, real estate agent, financial, and participant data that is maintained in the HomeGift system. The exemplary Web page 3100 of FIG. 31A depicts a transaction tab 3102. The transaction tab 3102 is accessible to HomeGift staff, and includes, for example, general transaction information 3104 (e.g., transaction number, urgency of transaction, workflow status), an inventory of the documents 3108 and emails 3110 associated with the transaction, and an indication of the HomeGift staff 3112 assigned to the transaction. In some embodiments, after information about a transaction is entered into the HomeGift system, a user can print the displayed information to memorialize the transaction. For example, a print command 3106 can launch a new browser or browser tab that prints the transaction data.

Once a participant accesses the HomeGift system, participant contact information can be collected (see process step 1 of FIG. 2A). The HomeGift website enables the collection of participant contact information, the timing of the purchase and/or sale, and/or any real estate agent information that the participant may have (see process step 21 of FIG. 2E). This data can be stored in one or more tables within one or more databases for access later by users of the HomeGift system. In some embodiments, new participant information can be entered into the HomeGift system through a screen accessible to HomeGift Account Representatives (see process steps 7 of FIG. 2C). FIG. 31B illustrates web & interview tab 3114 of an exemplary Web page 3100. The web & interview tab 3114 includes data submitted by a participant via a HomeGift website 3116 (see process step 1 of FIG. 2A), information collected from an interview of a participant by a member of the HomeGift staff 3118 (see process steps 27 of FIGS. 21 and 65 of FIG. 2G), and participant/agent matching information 3120 (see process steps 27 of FIGS. 2I and 65 of FIG. 2G).

FIG. 31C illustrates an exemplary agent tab 3122, which includes real estate agent contact data 3124 (e.g., agent name, office, cell, and/or home telephone numbers, and email address), broker contact data 3126 (e.g., broker name, broker telephone number, and broker email address), relocation director contact data 3128, and agency data 3130. FIG. 31D illustrates an exemplary financials tab 3132, which includes estimated financial information 3134 (e.g., estimated closing price, estimated commission percentage, estimated referral fee, estimated HG program costs, estimated participant rebate, and estimated NPO amount), expected financial information 3136 (e.g., expected closing price, expected commission percentage, expected referral fee, expected HG program costs, expected participant rebate, and expected NPO amount), and actual financial information 3138 (e.g., actual closing price, actual commission percentage, actual referral fee, actual HG program costs, actual participant rebate, and actual NPO amount).

FIG. 31E illustrates an exemplary participant tab 3140, which includes participant information 3142 (e.g., participant name, email address, telephone number), participant property information 3144 (e.g., address of property being sold, future property address), workflow status and HomeGift follow-up date(s) 3146, and notes 3148. In some embodiments, the HomeGift technology allows a user to create predefined notes that can be selected from, for example, a drop-down menu. In some embodiments, the user can enter notes in a textbox. In some embodiments a Predefined Note List is utilized that displays predefined notes. The Predefined Note List can contain an edit button to edit the note, and/or a link to add new predefined notes. In some embodiments, notes on a transaction tab 3102, depicted in FIG. 31A, an agent tab 3122, depicted in FIG. 31C, and a participant tab 3140, depicted in FIG. 31E, are displayed independent of one another. In some embodiments, notes on a transaction tab 3102, an agent tab 3122, and a participant tab 3140 contain notes from the other two tabs and include a “type” column 3150, depicted in FIG. 31E, that is either set to “T” for transaction, “A” for agent, or “P” for participant to indicate the source of notes.

Some embodiments can include tables in one or more databases that include a status column near the transaction date, e.g., for referral fee realization and accounting purposes. The status column is associated with the current step in the workflow process as per the transaction status, e.g., “interviewed participant,” “referral sent,” “listed,” “escrow,” etc. Tables in the one or more databases can be searched by column to facilitate ease of use by both backend and browser-side system participants.

In some embodiments, the HomeGift system can produce monthly, quarterly, and/or annual reports that will disclose, for example, revenue for HomeGift, NPOs, and/or real estate agents. Reports can be transmitted in electronic and/or hardcopy form. Where reports are electronically transmitted, a job can run and email the report(s) to intended recipient(s), e.g., HomeGift staff, NPOs, and/or real estate agents, at specified intervals. HomeGift personnel can fax and/or mail hardcopy report(s) to intended recipient(s). In some embodiments, report recipient(s) have the ability to opt in to or opt out of receiving HomeGift automated report(s). Reporting formats can include, for example, XLS, CSV, and/or HTML. In some embodiments, the HomeGift system can include a tool that enables users to select criteria and generate their own report(s). Exemplary reports of the HomeGift system can include, for example: “estimates” report(s), “actuals” report(s), “overview” report(s), “non-receipt of gift” report(s), “agent” report(s), “HomeGift top realtors” report(s), and/or “NPO” report(s).

“Estimates” report(s) can include data such as transaction number, transaction date, participant name, address, email and telephone number, estimated home or property price, estimated commission percentage, estimated referral percentage, estimated referral fee, estimated HomeGift payment, estimated participant payment, and/or estimated NPO payment. “Actuals” report(s) can include information similar to that provided in the “estimates” report(s), but data values are actuals rather than estimated values.

“Overview” report(s) can include, for example, data such as transaction status, estimated gift amount, estimated closing date, estimated HomeGift percentage, estimated rebate, and/or donation, actual rebate and/or donation amount, and/or actual HomeGift percentage. “Agent” report(s) can include data such as the number of referrals sent to the agent for the current week and/or month, and/or the number of referrals currently assigned to the real estate agent. “NPO” report(s) can include information related to outstanding gifts and completed gifts associated with the NPO.

An aspect of the success of the HomeGift program is the experience that the consumer/NPO supporter has during and after the referral process. In cases where the consumer requests a specific real estate agent, it is assumed that there is a comfort level that already exists between the real estate agent and the consumer. Even where the consumer has a preferred real estate agent, HomeGift screens the agent to verify that he/she is licensed and that the agent is not stretching his/her territory to get the listing or the buyer.

When a consumer asks HomeGift to locate a real estate agent for him/her, the screening and selection of the agent can be critical to the quality of the consumer's experience. In these cases, HomeGift interviews the agent candidate by telephone. In some embodiments, interview results are posted with the agent's other information in an agent database. When HomeGift searches for an agent for a buyer or seller, HomeGift “will conduct profiles on at least two agents per referral—unless an acceptable agent who has already been screened is in the database.” In some embodiments, HomeGift can monitor the relationship of the consumer with the real estate agent during the buying and/or selling process. In some embodiments, HomeGift can conduct electronic customer satisfaction surveys after the transaction is completed to evaluate the home buyer and/or home seller's satisfaction with the real estate agent that was referred to him/her by HomeGift. Customer quality scores for each agent can be determined based on, for example, these customer satisfaction surveys. Where a real estate agent performs well, the agent is kept in a HomeGift database. Where an agent performs poorly, the agent is either placed on probation or receives a “do not use” status, which prohibits the agent from getting further business until issues are resolved. The customer satisfaction information can be stored in a HomeGift database.

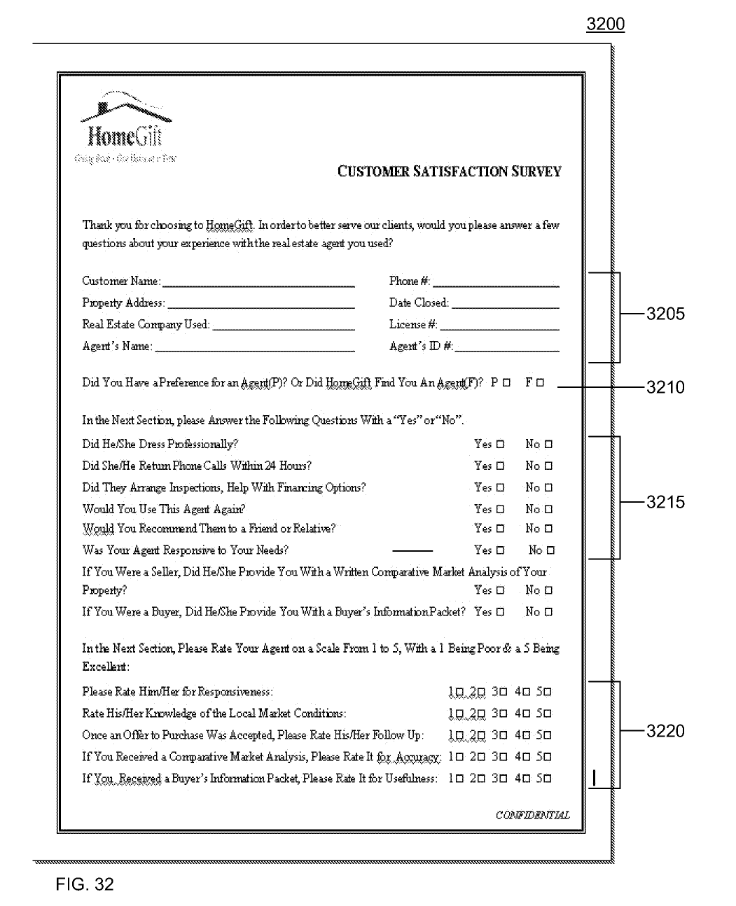

FIG. 32 represents an exemplary customer satisfaction survey of the HomeGift system. The exemplary customer satisfaction survey 3200 can include a basic customer and agent demographic section 3205, a question as to whether the customer had a preferred real estate agent or HomeGift found the agent 3210, a series of “yes/no” questions 3215, and a section for rating the agent 3220. The basic customer and agent demographic section 3205 can include, for example, customer name, property address, and telephone number, date of closing, real estate agency used, real estate agent used, agent's license number, and/or agent's ID. The series of “yes/no” questions 3215 can include whether the agent dressed professionally, whether he/she returned telephone calls within twenty-four hours, whether the agent arranged inspections and assisted the home buyer and/or home seller with financing options, whether the home buyer and/or home seller would use the real estate agent again, etc. The section for rating the agent 3220 can include, for example, a one through five scale for rating the agent's responsiveness, his/her knowledge of the local market, accuracy of comparative market analysis provided to the customer, etc. In some embodiments, customer satisfaction surveys can include those that poll satisfaction levels with the HomeGift program in general.

In some embodiments, the HomeGift system supports NPO campaign tracking. When a participant enters a transaction via the HomeGift website or over the telephone, the non-profit or charitable campaign that brought the participant to HomeGift can be tracked. Tracking can be accomplished via a question on the HomeGift website such as “how did you hear about us.” If the participant mails in information, an envelope or tracking code can be used to track the NPO campaign. If the participant calls in to a call center, a call center representative can identify the campaign with the caller. In some embodiments, an NPO customer relationship management or campaign management product may be utilized to create or manage various campaigns used by NPOs. In some embodiments, the HomeGift referral process system can store a campaign ID for campaign tracking purposes.

In some embodiments, the HomeGift system can create receivables and/or payables invoices in the QuickBooks Online Edition, using Intuit's published API's. In such embodiments, the HomeGift system can store the projected selling price of a home. The actual purchase price is not determined until a purchase and sale agreement is signed. Once the transaction, e.g., home purchase and/or sale, has closed, an authorized HomeGift staff member can enter the actual purchase price of the home and other pertinent data into the HomeGift system. For a royalty provided as part of the royalty-only model, the HomeGift system can use the actual closing price of the home and calculate the HomeGift and NPO percentages based on transaction-specific percentages, such as the actual transaction-side commission percentage and the referral fee percentage. For donations and royalties provided as part of a rebate model, the HomeGift system can use the actual purchase price of the home and calculate the HomeGift, NPO, and participate rebate percentages based on transaction-specific percentages.

In some embodiments, a HomeGift batch system can, for example, transfer calculated amounts from groups of transactions to a QuickBooks Online Edition application to create receivables invoices to real estate agents and/or brokers and payables invoices to NPOs and to determine information to generate participant rebates. For transactions that involve commission only agents, payables invoices can be created for these agents. In some embodiments, a QuickBooks Online Edition can handle accounting distributions associated with the receivables and payables transactions.

In some embodiments, the HomeGift system can include a HomeGift real estate agent program. This program can include, for example, referrals of additional transactions to agents participating in the real estate program, recognition through, for example, annual newspaper advertisements in local papers that celebrate HomeGift realtors who have achieved certain levels of “giving” via their clients, and premium-level membership and promotion for HomeGift real estate agents who agree to donate a designated percentage of every transaction to the NPO of their choice, where these contributions can count toward HomeGift recognition levels. HomeGift does not receive a share of these contributions.

In some embodiments, the HomeGift system can maintain master data associated with NPOs, participants, properties, and/or real estate agents in, for example, one or more databases. A data model associated with the HomeGift system can include the following exemplary data tables: NPO, real estate agent and broker, rebate/state data, participant, real estate agency, property data, transaction data, and/or login data, e.g., roles for users such as administrators, NPOs, participants, and/or other HomeGift staff.

Some embodiments include one or more tables that hold information about non-profit organizations. NPO table(s) can store information about each NPO that has signed on with HomeGift. An exemplary NPO table can include telephone, fax, and billing and street address information for an NPO, and/or the following fields:

NPO Table

| Column | Description |
|---|---|
| Name | NPO's name |
| NameForWeb | NPO's name as it should appear on the |
| | HG website |
| PageContent | HTML that should appear on the NPO's |
| | page on the HG website |
| URL | URL for the NPO's website |
| HGBuySideAdminPercent | Percentage of the donation that HomeGift |
| | will receive for a buy transaction |
| HGSellSideAdminPercent | Percentage of the donation that HomeGift |
| | will receive for a sell transaction |
| 501cNumber | 501c number for the NPO |
| 501cValidationDate | The date that HomeGift last validated |
| | the 501c |
| 501cExpirationDate | The date that the 501c number expires |
| Parent | If this NPO is part of another NPO, |
| | then this field will contain the ID of |
| | the parent company |
| ParentNPOPercent | Percentage of the referral fee that the |
| | Parent NPO will receive for any |
| | donations of this NPO |
| Login | Record in a Login table containing |
| | login information for this NPO |
| IsActiveYesNo | ‘Y’ if the NPO is active and |
| | HomeGift will administer donations |
| | for this NPO; ‘N’ otherwise. An |
| | NPO may be inactive because, for |
| | example, not all data has been entered, |
| | or the 501c number is not valid |
| IsExemptYesNo | ‘Y’ if the NPO is exempt; |
| | ‘N’ otherwise |

In some embodiments, the HomeGift system can store one or more contacts for an NPO in an NPOContact table. The NPOContact table can include the following fields:

NPOContact Table

| Column | Description |
|---|---|
| NPO | The NPO for this contact |
| FirstName | First name of the contact |
| LastName | Last name of the contact |
| Phone | Phone number of the contact |
| Email | Email address of the contact |
| ContactType | Type of contact (from the lkpContactType table) |

In some embodiments, notes about an NPO can be stored in an NPONote table. Notes may not be updated, but one or more notes may be created for an NPO. The NPONote table can include the following fields:

NPONote Table

| Column | Description |
|---|---|
| NPO | The NPO for this contact |
| Note | The note |

In some embodiments, NPOs track marketing campaigns related to HomeGift. Campaign codes for each NPO can be maintained in an lkpNPOCampaign table, which can include the following fields:

lkpNPOCampaign Table

| Column | Description |
|---|---|
| NPO | The NPO for this contact |
| CampaignCode | The code for this campaign |

In some embodiments, one or more tables can be used to store information about an NPO's reporting requirements. An lkpReport table can contain a list of reports available to NPOs. The lkpReportFormat table can list possible report formats. An lkpDeliveryMedium table can store possible delivery mediums for each report. An NPOReportingProfile table can include a record for each report that an NPO would like to receive. The NPOReportingProfile table can include the following fields:

NPOReportingProfile Table

| Column | Description |
|---|---|
| NPO | The NPO (From the NPO table) requesting the report |
| Report | The Report ID from the lkpReport table |
| FrequencyCd | Frequency with which the NPO would like to receive |
| | the report. Values can include: ‘M’—monthly, |
| | ‘Q’—quarterly, ‘Y’—yearly |
| ReportFormat | The format of the report (from the lkpReportFormat) |
| DeliveryMedium | How the NPO would like to receive the report (from |
| | the lkpDeliveryMedium table) |

An NPOReport table can store information about reports that were distributed. The NPOReport table can include the following fields:

NPOReport Table

| Column | Description |
|---|---|
| NPOReport | The NPO Report (from the NPOReportingProfile) |
| ReportContents | A copy of the report |
| DateSent | The date the report was sent |
| SentByUser | The user that sent the report |

In some embodiments, NPO data can be entered and maintained via web forms by HomeGift staff. NPO Admins can update at least a portion of this NPO data.

In some embodiments, a participant can receive a rebate in the form of a gift card. The availability of this option depends on state law and the NPO to which the participant is giving. This information can be stored in an lkpRebate table, which can include the following fields:

LkpRebate Table

| Column | Description |
|---|---|
| RebateDesc | The description of the rebate, e.g., Lowes' $1000 gift |
| | card |
| Vendor | Who the gift card is for, e.g., Lowes |
| MaxValue | The maximum value of the gift card in USD |
| IncrementsOf | The value of the gift card is a multiple of this number |

In some embodiments, a RebateState table can list rebates that are valid for each state, and can include the following fields:

RebateState Table

| Column | Description |
|---|---|
| Rebate | The rebate |
| StateOrProvince | The state that allows this rebate |

In some embodiments, a RebateNPO table can list rebates that a particular NPO will offer, and can include the following fields:

RebateNPO Table

| Column | Description |
|---|---|
| Rebate | The rebate |
| NPO | The NPO |

In some embodiments, real estate agent data can be stored in an Agent table. Real estate agency data can be stored in an REAgency table. Real estate agency chain information can be stored in a Chain table.

The Agent table can include the following fields:

Agent Table

| Column | Description |
|---|---|
| REAgency | The Agency for which the agent works |
| | (from the REAgency table) |
| FirstName | First name of the agent |
| LastName | Last name of the agent |
| CellPhone | Agent's cell phone number |
| HomePhone | Agent's home phone number |
| OtherPhone | Another phone number for this agent |
| Email | Agent's email address |
| SSN | Agent's Social Security number |
| QualityRating | Number from 1-10 indicating HG's rating |
| | of this agent |
| NumYearsLicensed | Number of years this agent has been licensed |
| BrokerOfRecord | The ID of the broker for whom this agent works |
| | (from the Agent table) |
| IsBrokerYesNo | ‘Y’ if this agent is a broker; ‘N’ otherwise |
| Notes | Any notes about this agent |

The REAgency table can include the following fields:

REAgency Table

| Column | Description |
|---|---|
| Name | The real estate agency name |
| OfficePhone | The office phone for this REAgency |
| TaxIdNum | The tax id number for this REAgency |
| Chain | The Id of the Chain that this REAgency belongs to if any |

The Chain table can include the following fields:

Chain Table

| Column | Description |
|---|---|
| Name | The parent real estate agency name |
| DisplayLogoYesNo | ‘Y’ - display the logo on pages where the |
| | participant is asked to choose a preferred chain |
| LogoUrl | The URL of this chain's logo |

Real estate agent licensing information can be stored in an AgentLicense table, which can include the following fields:

AgentLicense Table

| Column | Description |
|---|---|
| Agent | The agent (from the Agent table) |
| State | The state where the agent is licensed |
| StateRELicenseNum | The real estate license number |

Data regarding a real estate agent's expertise in certain neighborhoods can be stored in an AgentNeighborhood table. In some embodiments, there can be one record for each neighborhood for which the real estate agent has expertise. The AgentNeighborhood table can include the following fields:

AgentNeighborhood Table

| Column | Description |
|---|---|
| Agent | The agent (from the Agent table) |
| Neighborhood | The description of the city or neighborhood |

In some embodiments, if an agent has an affiliation with a non-profit organization, that information can be captured in an AgentNPOAffiliation table, which can include the following fields:

AgentNPOAffiliation Table

| Column | Description |
|---|---|
| Agent | The id of the agent (from the Agent table) |
| NPO | The id of the NPO with which this agent has an affiliation |

In some embodiments, participant information can be stored in a Donor table. In addition to name, address, fax, and phone number, the Donor table can include the following fields:

Donor Table

| Column | Description |
|---|---|
| Email | The participant's email address |
| HowtoContact | The participant's preferred method of contact: |
| | phone, email, or mail |
| AcceptTermsYesNo | Y - Donor accepted website terms |
| | N - Donor did not accept website terms |

In some embodiments, when a new participant that is buying property is created in the HomeGift system, a record can be created in, for example, the following tables: PropertyBuyInfo, PropertyTransaction, and AgentEnteredByDonor (if the participant has an agent in mind). When a new participant that is selling property is created in the HomeGift system, a record can be created in, for example, the following tables: PropertySellInfo, PropertyTransaction, and AgentEnteredByDonor (if the participant has an agent in mind).

A participant may enter information into the HomeGift system about a listing or buying agent. That information can be stored in the AgentEnteredByDonor table. The AgentEnteredByDonor table can be a holding table. Once a member of the HomeGift staff has verified participant data, he/she can search the Agent table to attempt to find the agent in the HomeGift system. If the agent is not found, then the member of the HomeGift staff can create a new Agent record and link the new Agent record to the property for the particular participant. In this way, an end-user cannot create an Agent record directly with the possibility of creating duplicated Agent data. The AgentEnteredByDonor table can contain the following fields:

AgentEnteredByDonor Table

| Column | Description |
|---|---|
| Name | The agent's name |
| REAgencyName | The name of the Real Estate Agency for |
| | which the agent works |
| City | The city where the agent works |
| Phone | The agent's phone number |
| EmailAddress | The agent's email address |
| PropertyTransaction | The ID of the property transaction |
| | (from the PropertyTransaction table) |

In some embodiments, a PropertyBuyInfo table can store information about a participant who is buying property. The PropertyBuyInfo table can include the following fields:

PropertyBuyInfo Table

| Column | Description |
|---|---|
| WhenLookingCd | When the person is looking to buy. |
| | Values are: Immediately, 3 months, |
| | 6 months, 9 months, 1 year, More than |
| | 1 year |
| PropertyTypeCd | The type of property the buyer is |
| | looking to buy. Values will include: |
| | MF—multi-family, SF—single- |
| | family, CONDO—condo, TH— |
| | townhouse, L—land |
| LookingAtAddress | The address of the property if the |
| | participant already has one in mind |
| LookingAtCity | The city where the participant is |
| | looking to buy |
| LookingAtCountry | The country where the participant is |
| | looking to buy |
| LookingAtStateOrProvince | The state or province where the |
| | participant is looking to buy |
| LookingAtPostalCode | The zip code where the participant is |
| | looking to buy |
| REAgencyPreference | The Real Estate Agency the participant |
| | would prefer |
| PriceRange | The price range of the participant |
| BuyerAgreementExpirationDate | The expiration date of the buyer's |
| | agreement once one is signed |
| PropertyTransaction | The property transaction (from the |
| | PropertyTransaction table) |
| Notes | Any additional notes |

In some embodiments, a PropertySellInfo table can store information about a participant who is selling property. The PropertySellInfo can include the following fields:

PropertySellInfo Table

| Column | Description |
|---|---|
| NumBedrooms | Number of bedrooms in the property |
| NumBathrooms | Number of bathrooms in the property |
| ListingExpirationDate | Date the listing agreement expires |
| PlannedListingDate | When the seller plans on listing the property |
| PurchasedDate | The date the seller bought this property |
| DaysOnMarket | The number of days that this property was on |
| | the market. This number would not be populated |
| | until the property had sold |
| Property Transaction | The property transaction (from the |
| | PropertyTransaction table) |

In some embodiments, an lkpTransactionStatus table can store transaction statues such as:

lkpTransactionStatus Table

| Column | Description |
|---|---|
| StatusDesc | Description of the status |
| Order | The order that a transaction may be in this |
| | status |
| PromptTouchpointYesNo | ‘Y’ if this status should prompt a |
| | touchpoint in the Contact Management system, |
| | such as the 1, 3, 6, 9, or 12 month follow-up |

In some embodiments, PropertyTransaction records can include information about a transaction for a property that is being bought or sold. In addition to the property address, the PropertyTransaction table can include the following fields:

PropertyTransaction Table

| Column | Description |
|---|---|
| TransactionNumber | System-generated unique |
| | identifier for the purchase |
| BuyOrSellFlag | Is this property being bought or |
| | sold by the participant? |
| Donor | The ID of the donor for this |
| | property (from the Donor table) |
| | transaction |
| Agent | The ID of the agent (from the |
| | Agent table) for this property |
| | transaction. This will be null |
| | until an agent is assigned |
| DonorSource | How the participant for this |
| | property transaction found |
| | HomeGift. This field contains |
| | an ID from the lkpDonorSource |
| | table (described below). This |
| | field can be stored with the |
| | transaction record in case the |
| | participant starts a future |
| | transaction from a different |
| | source |
| Status | The status of this transaction |
| | (from the lkpTransactionStatus |
| | table) |
| StatusDate | The date related to this status. |
| | For example, if the Status is |
| | “Closed”, then this field |
| | would contain the closing date |
| EstimatedRECommissionPercent | The estimated commission percent of |
| | the transaction (default is 3%) |
| ActualRECommissionPercent | The actual commission percent of |
| | the transaction. This can be |
| | populated once a listing or |
| | buyer's agreement has been signed |
| EstimatedReferralPercent | The estimated percentage of the |
| | commission that will be the NPO |
| | donation & HG Admin fee (default |
| | is 25%) |
| ActualReferralPercent | The actual percentage of the |
| | commission that will be the NPO |
| | donation & HG Admin fee |
| ActualReferralFee | The actual amount of the referral |
| | fee |
| NPOCampaign | The ID of the Campaign from the |
| | lkpNPOCampaign |
| EstimatedPrice | The estimated price for this |
| | transaction. This will be used for |
| | the purposes of forecasting revenue |
| | for HG and for forecasting donations |
| | for NPOs |
| ActualPrice | Price the property was sold or bought |
| | for in this transaction. This is the |
| | value that will be used to calculate |
| | the donation to the NPOs and the |
| | Administrative fees that HG will |
| | receive |

In some embodiments, flags are associated with PropertyTransactions if an actual commission does not match an expected commission. In some embodiments, for a buy transaction, the property address will not populated until the buyer has closed on the property. Where property is being both bought and sold, there can be two records in the PropertyTransaction table.

A PropertyTransactionDocument table can store a copy of documents related to a particular transaction. Records in this table may not be updated, but users may create additional records. The PropertyTransactionDocument table can include the following fields:

PropertyTransactionDocument Table

| Column | Description |
|---|---|
| PropertyTransaction | ID of the property transaction (from the |
| | PropertyTransaction table) that this |
| | document is for |
| DocumentDescription | A description of this document |
| DocumentContents | The actual contents of this document |
| Notes | Any notes about this document |

In some embodiments, a DonorRebate table can store information for a participant rebate associated with a transaction. The DonorRebate table can include the following fields:

DonorRebate Table

| Column | Description |
|---|---|
| PropertyTransaction | The transaction from which the gift card |
| | will be taken |
| Rebate | The rebate (from the lkpRebate table) |
| Percent | The percentage of the referral fee that |
| | will go toward the gift card |
| Amount | The final amount of the gift card |

In some embodiments, an NPODonation table can track NPOs that are receiving a donation for a property sale or purchase. If there is a parent NPO that is receiving a percentage of the referral fee, there will be one record for the child and one for the parent. The NPODonation table can include the following fields:

NPODonation Table

| Column | Description |
|---|---|
| PropertyTransaction | ID of the property transaction (from the |
| | PropertyTransaction table) that this document |
| | is for |
| NPO | The NPO getting a part or all of the donation |
| NPOPercent | The percentage of the donation that this NPO |
| | will receive. The sum of this field for all |
| | records for a property transaction plus the |
| | percentage of the participant rebate |
| | totals 100% |
| NPODonationAmount | The actual amount of the donation to the NPO |
| HGAdminPercent | The percentage of the donation that HomeGift |
| | will receive |
| HGAdminAmount | The actual amount that HG is receiving based |
| | on this NPO donation |
| DonationInNameOf | The name that the donation will be given in, |
| | including ‘Anonymous’ |

In some embodiments, the HomeGift system can calculate the following based on the previously disclosed data tables: HG admin fee, NPO parent donation, participant rebate, and/or NPO donation. In some embodiments, calculations can be based on the following exemplary formulas. HG admin fee for this donation=Sum(ReferralFee*NPOPercent*HGAdminPercent). NPO parent donation=ReferralFee*NPOPercent (for the parent). Donor rebate=ReferralFee*DonorRebate.Percent (rounded down to the nearest increment or max value). NPO donation=(ReferralFee−DonorRebate−HG Admin Fee−Sum(NPO Parent Donations))*NPOPercent.

In some embodiments, an lkpDonorSource table can store possible sources of participants, e.g., NPO website. The lkpDonorSource table can include the following fields:

lkpDonorSource Table

| Column | Description |
|---|---|
| DonorSourceDesc | Description of the participant |
| | source |
| AllowNPODonationChangesYesNo | ‘Y’ if a transaction from |
| | this source can have donation |
| | changes after creation. ‘N’ |
| | if the transaction cannot have |
| | donation changes. The purpose |
| | of this column is to ensure that |
| | participants that started a |
| | transaction from an NPO site |
| | cannot change the donation to |
| | another NPO |

In some embodiments, a Login table can store user login information, including, for example, the following fields:

Login Table

| Column | Description |
|---|---|
| Login | The user's login |
| Password | The user's password |

In some embodiments, the NPO, Donor, and Staff tables can have a foreign key field to the Login table to associate login information to the various types of users.

In some embodiments, there can be at least two tables related to login roles. These roles establish the permissions that a user has to view and edit data. An lkpRole table can store possible roles for a user, including, for example, NPO, Donor, HGStaff, and Admin. In some embodiments, a user can have one or more roles. A LoginRole table can store information about which logins have which roles, and can include the following fields:

LoginRole Table

| Column | Description |
|---|---|
| Login | The login ID for the user (from the Login table) |
| Role | The role ID for the role (from the lkpRole table) |

In some embodiments, when an NPO is created in the HomeGift system, a login can be created for the NPO with the role of “NPO.” In some embodiments, when a new HG staff member is created, a login can be created and assigned the role of “HGStaff.”

In some embodiments, one or more tables can store HomeGift staff data. A Staff table can include one record for each member of the HomeGift staff. The Staff table can include the following fields:

Staff Table

| Column | Description |
|---|---|
| EmployeeNum | This staff member's employee number |
| FirstName | Staff member's first name |
| LastName | Staff member's last name |
| Phone | Staff member's phone number |
| EmailAddress | Staff member's email address |
| Login | ID of the login record (from the Login table) for this |
| | employee |

In some embodiments, a HomeGift staff member can have one or more roles to identify what type of work he/she is doing and what the staff member needs to view from HomeGift's work queue screens. The list of HomeGift staff roles can be stored in a lkpStaffRole table. Roles can include, for example, AccountRep, RE Admin, and/or Admin. The roles that an HG staff member may have can be maintained in a StaffRole table, which can include the following fields:

StaffRole Table

| Column | Description |
|---|---|
| StaffRole | The ID of the role (from the lkpStaffRole table) |
| Staff | The ID of the staff member (from the Staff table) |

In some embodiments, HomeGift staff members can have one or more regions in which they are assigned to do work. The region that a HomeGift staff member is assigned to can be used to assign property transactions to that staff member. In some embodiments, there are four tables related to region information. An lkpState table can store state abbreviations. An lkpRegion table can store a list of regions. A RegionState table can identify which states belong to a region. In some embodiments, a region may have several states, but a state belongs to one region. The RegionState table can include the following fields:

RegionState Table

| Column | Description |
|---|---|
| Region | The ID of the region (from the lkpRegion table) |
| State | The ID of the state (from the lkpState table) |

One or more HomeGift staff members may be assigned to be an Account Manager for an NPO. This assignment or relationship can be stored in an NPOAccountManager table, which can include the following fields:

NPOAccountManager Table

| Column | Description |
|---|---|
| Staff | The ID of the role from the lkpStaffRole table |
| NPO | The ID of the staff member (from the Staff table) |
| IsActiveYesNo | ‘Y’ - This relationship is active; ‘N’ - |
| | This relationship is not active. The purpose of this |
| | field is to keep track of HG/NPO relationships. A |
| | relationship might be inactive if the Account Manager is |
| | going on vacation for example. |

One or more HomeGift staff members can be assigned to work on a transaction. This assignment can be stored in the StaffTransactionAssignment table, which can include the following fields:

StaffTransactionAssignment Table

| Column | Description |
|---|---|
| Staff | The staff member (from the Staff table) |
| PropertyTransaction | The property transaction |
| | (from the PropertyTransaction table) |
| IsActiveYesNo | ‘Y’ - This relationship is active; ‘N’ - |
| | This relationship is not active. The purpose of this |
| | field is to keep track of HG/NPO relationships. A |
| | relationship might be inactive if the RE Admin is |
| | going on vacation, for example. |

In some embodiments, the HomeGift system can include two tables that store data entered by a user when the user invokes HomeGift's “tell a friend” functionality. A TellAFriendFrom table can store data about the person who is referring a friend. The TellAFriendFrom table can include the following fields:

TellAFriendFrom Table

| Column | Description |
|---|---|
| FromName | Name of the person who is referring friends |
| FromEmail | Email address of the person who is referring friends |
| Message | Message to send in the email |
| CreateDate | Date the record was created |

In some embodiments, a TellAFriendTo table can store data about the people who are receiving email(s) as a “friend.” The TellAFriendTo table can include following fields:

TellAFriendTo Table

| Column | Description |
|---|---|
| ToName | Name of the person who is being referred |
| ToEmail | Email address of the person who is being referred |
| TellAFriendFrom | The ID of the person (from the TellAFriendFrom |
| | table) that is referring this person |
| CreateDate | Date this record was created and the email was sent |

In some embodiments, the HomeGift system can include two tables that store data entered by a user who would like to be reminded about HomeGift in some future period of time. These tables can include the lkpRemindMeWhen table and the RemindMe table. Exemplary lkpRemindMeWhen and RemindMe tables are set forth below.

lkpRemindMeWhen

| Column | Description |
|---|---|
| WhenDescription | Description of the time increment, e.g., 6 months |
| Number of Months | The actual number of months to remind the user |

RemindMe Table

| Column | Description |
|---|---|
| NPO | Which NPO this user came from |
| EmailAddress | Email address of the person who wants to be reminded |
| RemindMeWhen | How many months to send the email |
| | (from lkpRemindMeWhen) |
| CreateDate | Date this record was created |
| EmailSentYesNo | 1 indicates the email was sent; 0 indicates the email |
| | still needs to be sent |

In some embodiments, the HomeGift system can include one or more documents to be sent out to various parties throughout the lifecycle of a transaction. These documents can be stored in a DocumentTemplate table, which can include the following fields:

DocumentTemplate Table

| Column | Description |
|---|---|
| DocumentDescription | A description of what the document is and its |
| | purpose |
| DocumentContents | The actual contents of the document |
| DocumentTypeCd | The type of this document. Values can include: |
| | Referral Agreement, Donor Thank You, Buyer |
| | Interview Script, etc. |
| Notes | Any notes about this document |
| State | The state that this document is associated with, |
| | if any |

In some embodiments, the content of these documents can include fields that can be replaced with data specific to a transaction.

In some embodiments, the HomeGift system can include a NotificationRole table which can include login roles of individuals related to specific transaction(s) who should receive email notification(s) based on a change in the status of a transaction. The NotificationRole table can include the following fields:

NotificationRole Table

| Column | Description |
|---|---|
| TransactionStatus | ID of the transaction status (From the |
| | lkpTransactionStatus table) on which the sending |
| | of this notification will be triggered |
| DocumentTemplate | ID of the document template (from the |
| | DocumentTemplate table) that will be sent |
| DeliveryMedium | ID of the delivery medium (from the |
| | lkpDeliveryMedium table) in which the document |
| | should be sent. If this field is null then |
| | default to Email. Note that hard-copy documents |
| | will not be automated |

In some embodiments, data in at least the following tables can include an audit trail: Donor, PropertyBuyInfo, PropertySellInfo, PropertyTransaction, NPODonation, Rebate, NPORoyalty, and/or Agent. Audit data can be stored in a table named with the original table name plus “_Audit”. Audit tables can have the same structure as the original tables. In some embodiments, when a user saves a record to one of these tables, the HomeGift system can copy the data before the save into a new record in the corresponding audit table and save the updated data to the record in the original table.

For larger NPO's, HomeGift will not typically be provided access to these databases. In some embodiments, the HomeGift system can develop a subset of each participating NPO's database based on their members' decision to utilize HomeGift.

In some embodiments, the HomeGift technology can employ software components sold by Microsoft® Corp. of Redmond, Wash. In some embodiments, ERWIN can be used as a database-modeling tool. In some embodiments, the hardware infrastructure for HomeGift can be, for example, Wintel-based equipment.

In some embodiments, a user can enter data, such as an inquiry, on the HomeGift website or through a private NPO's website. For example, users may enter inquiries requesting information, requesting a contract, inquiries concerning a transaction, an agent, a participant, an NPO, or providing feedback. This data can be viewed via the HomeGift RPS. In some embodiments, staff persons are assigned to inquiries. In some embodiments, the following information can be associated with inquiries Date/Time (entered on external site), Source (e.g., HomeGift public website, WGBH, CAI, etc.), Type/ID, e.g., agent, contact, NPO, feedback or participant, and ID from original system, Name of Person Submitting the Inquiry, Status, e.g., new, assigned, closed, and/or Staff Assigned To. In some embodiments, Real Estate Administrators have the ability to view, add and update data for the participants and properties that they are assigned. RE Admins can view some data regarding the NPO(s) that they are assigned. RE Admins have view, add and update access to real estate agent data.

In some embodiments, NPO Admins have the ability to view their own NPO record. NPO Admins can update contact information associated with their NPO record, e.g., contact name, email, address and/or telephone. NPO Admins have view access to transactions that are associated with their NPO.

In some embodiments, participants have view-only access to the status of their donation. In some embodiments, agents have access to view and update specific pieces of the transactions that are assigned to them.

In some embodiments, a HomeGift database can store information relating to recent modifications, for example, who entered the change, what fields were modified, a date stamp, etc. For example, information regarding modification to the following fields can be maintained: AgentEdit, AgentLicenseEdit, AgentNeighborhoodEdit, ChainEdit, InquiryEdit, NPOContactEdit, NPOEdit, PropertyTransactionAgentEdit, PropertyTransactionAgentReferralEdit (including the user and change date for each agent referred), PropertyTransactionDetailsBuySide, PropertyTransactionDetailsSellSide, PropertyTransactionEdit, PropertyTransactionFinancialsEdit, PropertyTransactionStaffEdit, PropertyTransactionWorkflowStatusEdit, REAgencyEdit, and/or ReferralFeeProgramEdit. In some embodiments, identifying information such as a user's first and last name, the date and time of the change, and a hyperlink to previous data values can be included to track modifications. In some embodiments, the hyperlinked page containing previous data values does not contain hypertext links to data further back in time.

In some embodiments, the HomeGift technology can include additional features associated with real estate agents, in particular, how real estate agents are represented in a database associated with the HomeGift technology. The following fields are exemplary features that can be included in the HomeGift system based on system requirements and user preferences: price range of houses sold in a given time period, zip codes and/or towns in the agent's coverage area, the number of buyers and/or sellers that the agent has represented, whether the agent is a certified buyer's representative, etc. The Agent feature can allow a user to inactivate an agent on the Agent Edit screen. An inactive agent no longer appears in the search results for Agents unless the RPS user specifically checks the “Include Inactive Agents” checkbox. When an agent is made inactive, the user is given a message that they are about to make an agent inactive and queried whether they want to continue. There is no restriction on when an agent can be made inactive. However, once an agent is inactive they are no longer assigned or referred to a transaction.

The Agency feature can allow a user to deactivate an agency on either the Agency Edit screen or on the Agency List screen. In some embodiments, a delete link on the Agency list links to a “Deactivate the Agency” button. In some embodiments, there is a checkbox on the Agency Edit screen that can be checked to deactivate an agency. When an agency is made inactive, the user is given a message that they are about to make an agency and all of its associated agents inactive and queried whether they want to continue. Once an agency has been made inactive, all of the agents that belong to that agency will also be made inactive, e.g., unavailable for association with future transactions. An RPS user is required to edit each agent, assign the agent to a new agency and uncheck the inactive box to make the individual agent active again.

In some embodiments, the Chain feature can allow a user to deactivate a chain on either the Chain Edit screen or the Chain List screen. In some embodiments, a delete link on the Chain list links to a “Deactivate the Chain” button, and permits each agent in the Chain to be tagged. In some embodiments, there is a checkbox on the Chain Edit screen that can be checked to deactivate a chain. When a chain is made inactive, the user is given a message that they are about to make a chain and all of its associated agencies and agents inactive and queried whether they want to continue. Once the chain has been made inactive, all agencies and agents in the Chain are made inactive.

In some embodiments, the HomeGift system enables a user to transfer agents, chains, and agencies. The Chain feature can allow a user to select an agency or agent to transfer to another Chain. This forces all agencies and agents of the Transfer From choice to be assigned to the Transfer To choice and the Transfer From choice is made inactive. This can be accessible from a link on the Chain List. The Agency feature can allow a user to select an agency or agent to transfer to another agency. This forces all agents of the Transfer From agency to be assigned to the Transfer To agency and the Transfer From choice is made inactive. This can be accessible from a link on the Agent or Agency List.

In some embodiments, if a user makes a change to a page and tries to navigate off the page by, for example, clicking on another menu item, a different transaction tab, or closing the browser without saving, the user is alerted to the fact that the user has unsaved changes. The user is given an opportunity to cancel the navigation in order to save the page. This occurs if the user has made changes to the page.

In some embodiments, results are shown immediately when a user changes a value, e.g., estimated sale price, percentage donation to the NPO. For example, when a user enters a value into the Estimate Commission Percent or the Estimated Referral Fee Percent, the Estimate Commission Amount, Estimated Referral Fee, Estimated Participant Rebate, Estimate NPO Amount and Estimated HG Program Costs can be automatically calculated, for example when the user moves to a different tab. In some embodiments, when a user enters a value into the Actual Closing Price, Actual Commission Percent, Actual Commission Amount or Actual Referral Fee Percent, the values in the Actual Referral Fee, Actual HG Program Costs, Actual Participant Rebate and Actual NPO Amount fields can be automatically calculated, for example when the user moves to a different tab.

In some embodiments, if the state in which a participant is buying, e.g., in which the property is situated, is modified, the rebate requirements of the state are rechecked. The user can be alerted if the state does not allow rebates. In some embodiments, such a change automatically forces data changes in the system. In some embodiments, if a state is not a rebate state, then a user can only select the royalty-only model for that state. If the state is a rebate state, then a user can select the royalty, sharing, or donation models. If the state is being changed from a non-rebate state to a rebate state, then typically no changes are made. If the state is being changed from a rebate state to a non-rebate state, which can be stored in the lkpState table, then the user is alerted that they are changing to a non-rebate state and the royalty-only model is the only model allowed for this state. If the user accepts the change, then the referral fee model associated with the transaction is modified to royalty-only.

In some embodiments, various fields on HomeGift Web page(s) are optional. An example occurs in the Agency website form as entered by a real estate agent or agency where optional fields such as whether the agent is a Realtor®, the agent's current number of listings, a fax number, and/or comments can be included.

In some embodiments, the HomeGift technology features a corresponding page for each of page that displays the current and previous values of the page. In some embodiments, the corresponding pages include the date of all changes, for example, as a hyperlink to a page that shows changes either directly before the current page or a page showing previous values.

HomeGift is used throughout the specification to represent a company that administers the technology, techniques, and services described herein. HomeGift can of course be replaced with any company (e.g., a generic XYZ company) that implements and administers any of the technology, techniques, and services described herein.

The processes and technology described herein can be implemented in digital electronic circuitry, or in computer hardware, firmware, software, or in combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and the computer program can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the above described processes can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described processes can be implemented in a distributed computing the system that includes a backend component, e.g., as a data server, and/or a middleware component, e.g., an application server, and/or a front-end component, e.g., a client computer having a graphical user interface and/or a Web browser through which a user can interact with an example implementation, or any combination of such backend, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing the system can include clients and servers. A client and server are generally remote from each other and typically interact through a communication network. The relationship of client and server arises by virtue of computer programs running on the respective computers and having a client-server relationship to each other.

The technology has been described in terms of particular embodiments. The alternatives described herein are examples for illustration only and not to limit the alternatives in any way. The steps of the HomeGift technology can be performed in a different order and still achieve desirable results. Other embodiments are within the scope of the following claims.

What is claimed is:

1. A method for non-profit organization find raising via referral fees, the method comprising:
receiving information associated with a participant interested in participating in a real estate transaction in which finds can be provided to a non-profit organization (NPO);
generating an agreement to be signed by an agent associated with the transaction;
receiving an electronic document of the agreement signed by the agent;
automatically determining the transaction with which the signed agreement is associated; and
storing the received electronic document and associating the stored electronic document with the participant.

2. The method of claim 1, wherein the electronic document comprises a facsimile.

3. The method of claim 1, wherein the electronic document comprises an email.

4. The method of claim 1, wherein the electronic document comprises an electronic signature.

5. The method of claim 1, wherein the agreement is associated with a bar code, and wherein automatically determining comprises:
detecting the bar code included in the received electronic document; and
determining the transaction with which the bar code is associated.

6. The method of claim 1, further comprising:
defining a transaction identifier associated with the transaction; and
associating the participant information and the received electronic document with the transaction identifier.

7. The method of claim 1, further comprising generating an email to the associated participant in response to the received electronic document.

8. The method of claim 7, further comprising associating the email with a transaction identifier.

9. The method of claim 1, further comprising identifying an agent associated with the transaction.

10. The method of claim 9, wherein identifying comprises interviewing the participant to determine an agent to use for the transaction.

11. The method of claim 10, wherein interviewing comprises:
calling the participant; and
asking the participant a predefined question associated with determining the agent.

12. The method of claim 1, further comprising transmitting an alert to the participant in response to a predefined event.

13. The method of claim 12, wherein the alert comprises an email, a text message, an instant message, a pre-recorded voice message, a computer generated voice message, or any combination thereof.

14. The method of claim 1, further comprising defining a reminder to contact the participant prior to an expiration date of the agreement.

15. The method of claim 1, further comprising indicating a status of the transaction.

16. The method of claim 15, further comprising updating the status of the transaction in response to a predefined event.

17. The method of claim 1, wherein the electronic document is a first electronic document, the method further comprising receiving a second electronic document including a date of a closing of the transaction and a final sales price.

18. The method of claim 17, further comprising calculating, based on the second electronic document, an amount of finds to provide to the participant, the NPO or both.

19. The method of claim 17, further comprising generating, in response to the second electronic document, a notice to the participant, the agent, the NPO, or any combination thereof, the notice including at least a portion of the information included in the second electronic document.

20. A system for non-profit organization fund raising via real estate referral fees, the system comprising:
a computing device configured to receive information associated with a participant interested in participating in a real estate transaction in which funds can be provided to a non-profit organization (NPO), to generate an agreement to be signed by an agent associated with the transaction, to receive an electronic document of the agreement signed by the agent, and to automatically determine the transaction with which the signed agreement is associated; and
a storage device configured to store the received electronic document and to associate the stored electronic document with the participant.

21. The system of claim 20, wherein the computing device comprises a server.

22. The system of claim 20, wherein the storage device comprises a database.

23. A computer program product, tangibly embodied in an information carrier, for non-profit organization fund raising via real estate referral fees, the computer program product including instructions being operable to cause data processing apparatus to:
receive information associated with a participant interested in participating in a real estate transaction in which funds can be provided to a non-profit organization (NPO);
generate an agreement to be signed by an agent associated with the transaction;
receive an electronic document of the agreement signed by the agent;
automatically determine the transaction with which the signed agreement is associated; and
store the received electronic document and associate the stored electronic document with the participant.
